(19) United States
(12) Patent Application Publication
(10) Pub. No.: US 2024/0064733 A1
(43) Pub. Date: Feb. 22, 2024

(54) RESOURCE CONFIGURATION FOR WIRELESS COMMUNICATION

(71) Applicant: Lenovo (Singapore) Pte. Ltd., New Tech Park (SG)

(72) Inventors: Majid Ghanbarinejad, Chicago, IL (US); Hyejung Jung, Northbrook, IL (US); Vijay Nangia, Woodridge, IL (US)

(21) Appl. No.: 18/260,593

(22) PCT Filed: Jan. 10, 2022
(86) PCT No.: PCT/IB2022/050156

§ 371 Date: Jul. 6, 2023

Related U.S. Application Data
(60) Provisional application No. 63/135,489, filed on Jan. 8, 2021.

(51) Int. Cl. H04W 72/1268; H04W 72/1273; H04W 72/11

(52) U.S. Cl. CPC H04W 72/1268; H04W 72/1273; H04W 72/11

(57) ABSTRACT

Apparatuses, methods, and systems are disclosed for resource configuration for wireless communication. One method includes receiving scheduling information for a physical channel on a first set of resources of a first entity. The method includes receiving information associated with a second set of resources of a second entity. The second set of resources overlap with the first set of resources in a time domain. The method includes determining an availability of a resource in the first set of resources based in part on the information associated with the second set of resources. The method includes, in response to determining that the resource is not available, transmitting an indication indicating that the resource is not valid. The method includes, in response to determining that the resource is available, performing a communication associated with the physical channel on the resource.

### CROSS-REFERENCE TO RELATED APPLICATIONS

This application claims priority to U.S. Patent Application Ser. No. 63/135,489 entitled “APPARATUSES, METHODS, AND SYSTEMS FOR ENHANCED DUPLEXING IN INTEGRATED ACCESS AND BACKHAUL” and filed on Jan. 8, 2021 for Majid Ghanbarinejad, which is incorporated herein by reference in its entirety.

### FIELD

The subject matter disclosed herein relates generally to wireless communications and more particularly relates to resource configuration for wireless communication.

### BACKGROUND

In certain wireless communications networks, resources may be assigned for communication. In such networks, resource assignment may be inefficient.

### BRIEF SUMMARY

Methods for resource configuration for wireless communication are disclosed.

Apparatuses and systems also perform the functions of the methods. One embodiment of a method includes receiving, at a wireless node, scheduling information for a physical channel on a first set of resources of a first entity. In some embodiments, the method includes receiving information associated with a second set of resources of a second entity. The second set of resources overlap with the first set of resources in a time domain. In certain embodiments, the method includes determining an availability of a resource in the first set of resources based in part on the information associated with the second set of resources. In various embodiments, the method includes, in response to determining that the resource is not available, transmitting an indication indicating that the resource is not valid. In some embodiments, the method includes, in response to determining that the resource is available, performing a communication associated with the physical channel on the resource.

One apparatus for resource configuration for wireless communication includes a wireless node. In some embodiments, the apparatus includes a receiver that: receives scheduling information for a physical channel on a first set of resources of a first entity; and receives information associated with a second set of resources of a second entity. The second set of resources overlap with the first set of resources in a time domain. In various embodiments, the apparatus includes a processor that determines an availability of a resource in the first set of resources based in part on the information associated with the second set of resources. In certain embodiments, the apparatus includes a transmitter that, in response to determining that the resource is not available, transmits an indication indicating that the resource is not valid. The processor, in response to determining that the resource is available, performs a communication associated with the physical channel on the resource.

Another embodiment of a method for resource configuration for wireless communication includes receiving, at a wireless node, first information indicating that a resource is available for a downlink transmission to a first node. In some embodiments, the method includes receiving second information indicating that the resource is available for an uplink transmission to a second node. In certain embodiments, the method includes determining whether the resource is to be used for a simultaneous operation. The simultaneous operation includes the downlink transmission and the uplink transmission. In various embodiments, the method includes, in response to determining that the resource is not to be used for the simultaneous operation, transmitting a control message to the second node. The control message indicates that the resource is not available for the uplink transmission.

Another apparatus for resource configuration for wireless communication includes a wireless node. In some embodiments, the apparatus includes a receiver that: receives first information indicating that a resource is available for a downlink transmission to a first node; and receives second information indicating that the resource is available for an uplink transmission to a second node. In various embodiments, the apparatus includes a processor that determines whether the resource is to be used for a simultaneous operation. The simultaneous operation includes the downlink transmission and the uplink transmission. In certain embodiments, the apparatus includes a transmitter that, in response to determining that the resource is not to be used for the simultaneous operation, transmits a control message to the second node. The control message indicates that the resource is not available for the uplink transmission.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for resource configuration for wireless communication;

FIG. 2 is a schematic block diagram illustrating one embodiment of an apparatus that may be used for resource configuration for wireless communication;

FIG. 3 is a schematic block diagram illustrating one embodiment of an apparatus that may be used for resource configuration for wireless communication;

FIG. 4 is a schematic block diagram illustrating one embodiment of an IAB system in standalone mode;

FIG. 5 is a schematic block diagram illustrating another embodiment of a system;

FIG. 6 is a schematic block diagram illustrating one embodiment of an IAB system with single-panel and multi-panel IAB nodes;

FIG. 7 is a schematic block diagram illustrating one embodiment of types of simultaneous transmission and/or reception operations;

FIG. 8 is a schematic block diagram illustrating one embodiment of a system with an IAB node connected to a parent node and a child node;

FIG. 9 is a flow chart diagram illustrating one embodiment of a method for resource configuration for wireless communication; and

FIG. 10 is a flow chart diagram illustrating another embodiment of a method for resource configuration for wireless communication.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

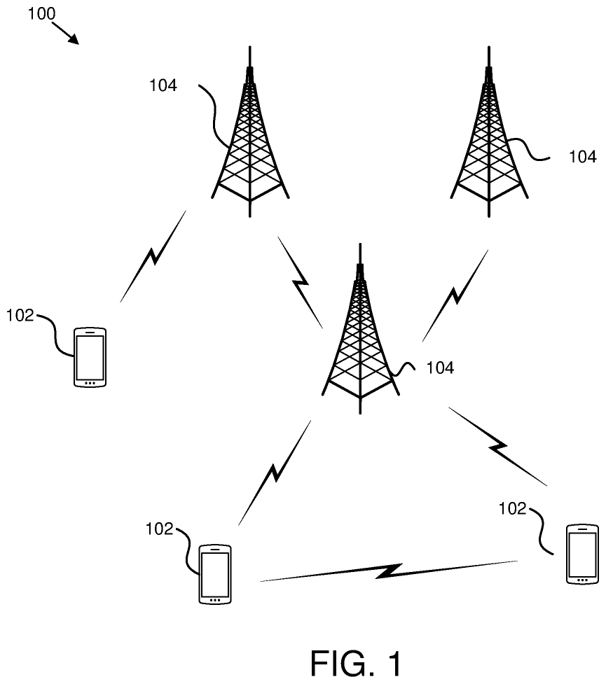

FIG. 1 depicts an embodiment of a wireless communication system 100 for resource configuration for wireless communication. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a location server, a core network (“CN”), a radio network entity, a Node-B, an evolved node-B (“eNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in third generation partnership project (“3GPP”), wherein the network unit 104 transmits using an OFDM modulation scheme on the downlink (“DL”) and the remote units 102 transmit on the uplink (“UL”) using a single-carrier frequency division multiple access (“SC-FDMA”) scheme or an orthogonal frequency division multiplexing (“OFDM”) scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a network unit 104 may receive, at a wireless node, scheduling information for a physical channel on a first set of resources of a first entity. In some embodiments, the network unit 104 may receive information associated with a second set of resources of a second entity. The second set of resources overlap with the first set of resources in a time domain. In certain embodiments, the network unit 104 may determine an availability of a resource in the first set of resources based in part on the information associated with the second set of resources. In various embodiments, the network unit 104 may, in response to determining that the resource is not available, transmit an indication indicating that the resource is not valid. In some embodiments, the network unit 104 may, in response to determining that the resource is available, perform a communication associated with the physical channel on the resource. Accordingly, the network unit 104 may be used for resource configuration for wireless communication.

In certain embodiments, a network unit 104 may receive, at a wireless node, first information indicating that a resource is available for a downlink transmission to a first node. In some embodiments, the network unit 104 may receive second information indicating that the resource is available for an uplink transmission to a second node. In certain embodiments, the network unit 104 may determine whether the resource is to be used for a simultaneous operation. The simultaneous operation includes the downlink transmission and the uplink transmission. In various embodiments, the network unit 104 may, in response to determining that the resource is not to be used for the simultaneous operation, transmit a control message to the second node. The control message indicates that the resource is not available for the uplink transmission. Accordingly, the network unit 104 may be used for resource configuration for wireless communication.

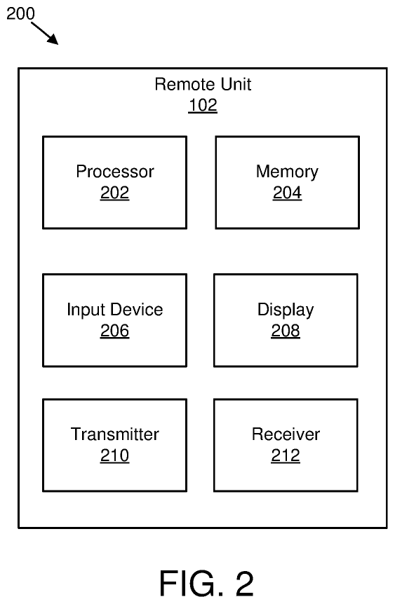

FIG. 2 depicts one embodiment of an apparatus 200 that may be used for resource configuration for wireless communication. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

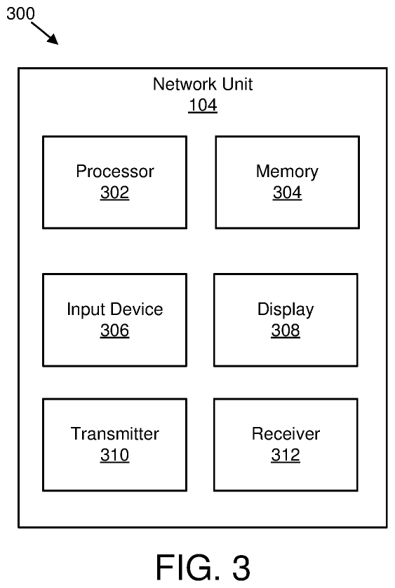

FIG. 3 depicts one embodiment of an apparatus 300 that may be used for resource configuration for wireless communication. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In certain embodiments, the receiver 312: receives scheduling information for a physical channel on a first set of resources of a first entity; and receives information associated with a second set of resources of a second entity. The second set of resources overlap with the first set of resources in a time domain. In various embodiments, the processor 302 determines an availability of a resource in the first set of resources based in part on the information associated with the second set of resources. In certain embodiments, the transmitter 310, in response to determining that the resource is not available, transmits an indication indicating that the resource is not valid. The processor 302, in response to determining that the resource is available, performs a communication associated with the physical channel on the resource.

In some embodiments, the receiver 312: receives first information indicating that a resource is available for a downlink transmission to a first node; and receives second information indicating that the resource is available for an uplink transmission to a second node. In various embodiments, the processor 302 determines whether the resource is to be used for a simultaneous operation. The simultaneous operation includes the downlink transmission and the uplink transmission. In certain embodiments, the transmitter 310, in response to determining that the resource is not to be used for the simultaneous operation, transmits a control message to the second node. The control message indicates that the resource is not available for the uplink transmission.

In certain embodiments, integrated access and backhaul (“IAB”) may be used for new radio access technology (“NR”) (e.g., Release 16 (“Rel-16”)). IAB technology may aim at increase deployment flexibility and reduce fifth generation (“5G”) rollout costs. IAB may enable service providers to reduce cell planning and spectrum planning while using the wireless backhaul technology.

Although IAB is not limited to a specific multiplexing and duplexing scheme, the focus may be on time-division multiplexing (“TDM”) between upstream communications (e.g., with a parent IAB node or IAB donor) and downstream communications (e.g., with a child IAB node or a user equipment (“UE”)).

In some embodiments, IAB enhancements may facilitate resource multiplexing between upstream and downstream communications. In various embodiments, semi-static configurations for enabling simultaneous operations in upstream and downstream links in enhanced IAB nodes may be used. For example, response to changes in a system such as a topology, an interference, and/or traffic may be slow. In certain embodiments, an IAB system with enhanced IAB nodes that are connected to a legacy IAB donor may not enjoy a significant performance advantage. In some embodiments, certain upstream and/or downstream links may be configured semi-statically while other upstream and/or downstream links may be controlled by local dynamic signaling and/or an opportunistic use of resources that are not configured by an IAB donor.

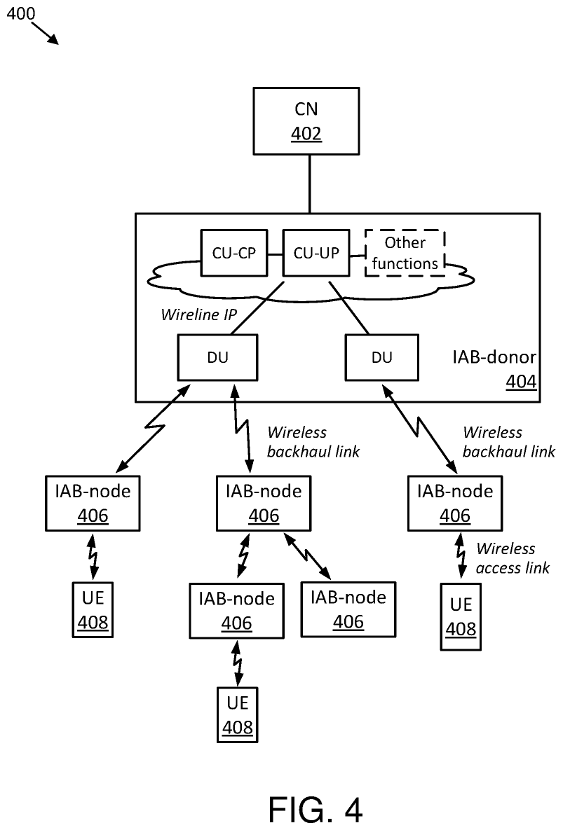

FIG. 4 is a schematic block diagram illustrating one embodiment of an IAB system 400 in standalone mode. The IAB system 400 includes a core network (“CN”) 402, an IAB-donor 404, IAB-nodes 406, and UEs 408. The CN 402 is connected to the IAB donor 404 of the IAB system 400 through a backhaul link, which is typically wired. The IAB donor 404 includes a central unit (“CU”) that communicates with all the distributed units (“DUs”) in the system through an F1* interface. The IAB donor 404 is a single logical node that may include a set of is functions such as gNB-DU, gNB-CU-CP, gNB-CU-UP, and so forth. In certain deployments, the IAB donor 404 may be split according to these functions, which may all be either collocated or non-collocated. Moreover, each IAB node may be functionally split into at least a DU and a mobile terminal (“MT”). An MT of an IAB node may be connected to a DU of a parent node, which may be another IAB node or an IAB donor. A Uu link between an MT of an IAB node (called an IAB-MT) and a DU of a parent node (called an IAB-DU) is called a wireless backhaul link. In a wireless backhaul link, in terms of functionalities, the MT is similar to a UE and the DU of the parent node is similar to a base station in a conventional cellular wireless access link. Therefore, a link from an MT to a serving cell that is a DU of a parent link is called an uplink, and a link in the reverse direction is called a downlink. As used herein, embodiments may refer to an uplink or a downlink between IAB nodes, an upstream link or a downstream link of an IAB node, a link between a node and its parent node, a link between a node and its child node, and so forth without a direct reference to an IAB-MT, IAB-DU, serving cell, and so forth.

Each IAB donor or IAB node may serve UEs through access links. IAB systems may be designed to enable multi-hop communications (e.g., a UE may be connected to a core network through an access link and multiple backhaul links between IAB nodes and an IAB donor). As used herein, unless stated otherwise, an IAB node may refer to an IAB node or an IAB donor.

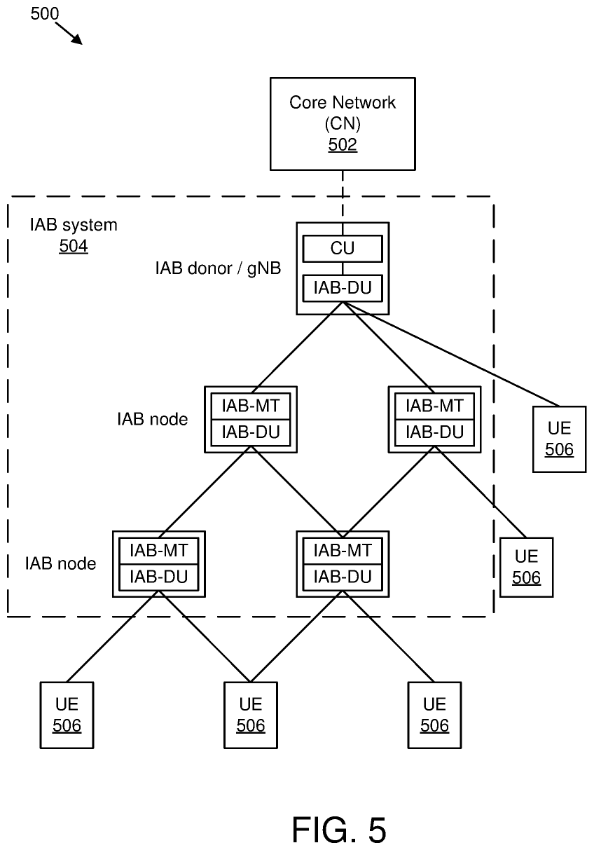

FIG. 5 is a schematic block diagram illustrating another embodiment of a system 500. Specifically, FIG. 5 illustrates functional splits of an IAB donor and IAB nodes. In this figure, an IAB node or a UE can be served by more than one serving cell as they support dual connectivity (“DC”). The system 500 includes a CN 502, an IAB system 504, and UEs 506. The CU/DU split is in an IAB donor in the IAB system 504, and the DU/MT split is in IAB nodes in the IAB system 504.

It should be noted that a node and/or link closer to the IAB donor and/or CN 502 is called an upstream node and/or link. For example, a parent node of a subject node is an upstream node of the subject node and the link to the parent node is an upstream link with respect to the subject node. Similarly, a node and/or link farther from the IAB donor and/or core network is called a downstream node and/or link. For example, a child node of a subject node is a downstream node of the subject node and the link to the child node is a downstream link with respect to the subject node.

Table 1 summarize the terminology used herein for the sake of brevity versus a description that may appear in a specification.

TABLE 1

| Phrase | Description |
|---|---|
| Wireless backhaul link | A connection between an MT of an IAB |
| | node and a DU of a serving cell |
| Wireless access link | A connection between a UE and (a DU of) a serving cell |
| IAB-node/IAB node | RAN node that supports NR access links to UEs and NR |
| | backhaul links to parent nodes and child nodes |
| IAB-MT | IAB-node function that terminates the Uu interface |
| | to the parent node |
| IAB-DU | gNB-DU functionality supported by the IAB-node to |
| | terminate the NR access interface to UEs and next-hop IAB- |
| | nodes, and to terminate the F1 protocol to the gNB-CU |
| | functionality on the IAB-donor |
| IAB-donor/IAB donor | gNB that provides network access to UEs via |
| | a network of backhaul and access links |
| Parent [IAB] node | An IAB node or IAB donor that comprises a serving cell of |
| | the subject node. In some examples, IAB-MT's next hop |
| | neighbour node; the parent node may be an |
| | IAB-DU of an IAB-node or an IAB-donor. |
| Child [IAB] node | An IAB node that identifies the subject node as a serving |
| | cell. In some examples, IAB-DU's next hop neighbour node; |
| | the child node is also an IAB-node. In some embodiments, a |
| | UE or an enhanced UE or an IAB-enhanced UE may perform |
| | similarly to a child IAB node. |
| Sibling [IAB] node | An IAB node that has a common parent with the subject |
| | node |
| Uplink (of a wireless backhaul | A link from an MT to a DU of a parent node |
| link) | |
| Downlink (of a wireless | A link from a DU to an MT of a child node |
| backhaul link) | |
| Upstream node/link/etc. | A node/link/etc. (topologically) closer to the IAB donor/ |
| | core network. Direction toward a parent node in an IAB |
| | topology. |
| Downstream node/link/etc. | A node/link/etc. (topologically) farther from the IAB donor/ |
| | core network. Direction toward a child node or UE in an IAB |
| | topology. |

In certain embodiments, an “operation” or a “communication” may refer to a transmission or a reception in an uplink (or upstream) or a downlink (or downstream). Furthermore, the terms “simultaneous operation” or “simultaneous communications” may refer to multiplexing and/or duplexing transmissions and/or receptions by a node through one or more antennas and/or panels. Simultaneous operation, if not described explicitly, may be understood from the context.

Dynamic time division duplexing (“TDD”) may be used in NR through radio resource control (“RRC”) configurations and lower layer control signaling. Further, NR systems may facilitate more flexible slot formats for TDD operation that may be modified dynamically for adaptation to varying traffic. RRC may configure slots for TDD operation by the following information elements (“IEs”): 1) TDD-UL-DL-ConfigCommon: this IE determines a cell-specific uplink and/or downlink TDD configuration—the IE contains a periodicity value between 0.5 ms to 10 ms and a reference subcarrier spacing (“SCS”)—a slot configuration pattern (through one or two pattern fields) are then defined within the periodicity—the periodicity may contain multiple slots—the most general pattern for each periodicity is a number of downlink slots and symbols at the beginning and a number of uplink symbols and slots at the end—all the remaining slots and/or symbols in between are flexible and can be overridden by the following UE-specific configuration; and 2) TDD-UL-DL-ConfigDedicated: this IE determines a UE-specific uplink and/or downlink TDD configuration—the IE configures a number of slot configurations—each slots configuration contains an index based on the periodicity defined by the cell-specific configuration, and a number of downlink and uplink symbols in the slot, which can override flexible symbols configured by the cell-specific configuration.

Furthermore, resources that are still flexible (e.g., not configured downlink or uplink) by the cell-specific or UE-specific configuration may be dynamically indicated downlink or uplink by a DCI format 2_0 for a UE or a group of UEs. The DCI may contain slot format indicators (“SFIs”), each an index to a table of slot formats configured by the RRC. The configuration from the RRC refers to each slot format by an 8-bit number.

In some embodiments, 56 of 256 possible values (e.g., indexed 0-55) may be used to define slot formats of various combinations. The general format for each of the slot formats may be downlink (“DL”), flexible (“F”), uplink (“UL”) (“DL-F-UL”), where a slot format may contain one, two, or all the three types of the symbols with various numbers in the specified order. In various embodiments, 41 more values (e.g., indexed 56-96) may be used for UL-F-DL formats for IAB that provide further flexibility for an IAB node that may want to start a slot with uplink symbols followed by downlink symbols.

In various embodiments, resources that are not configured or indicated downlink or uplink by any of the above signaling may be assumed reserved, which may enable flexibility for cell management, coexistence, and so forth.

In certain embodiments, there may be resource configuration in NR IAB (e.g., Rel-16). It should be noted that more slot formats may be introduced in NR IAB (e.g., Rel-16) to facilitate higher flexibility.

Furthermore, in some embodiments, resources may be configured as hard (“H”), soft (“S”), or not available (“NA”). Hard resources may be assumed available for scheduling by an IAB node and NA resources may not be assumed available, while soft resources may be indicated available or not available dynamically. A dynamic availability indication (“AI”) for soft resources may be performed by DCI format 2_5 from a parent IAB node and/or donor, and may have similarities in formats and definitions with SFI (e.g., DCI format 2_0).

In various embodiments, resources may be shared between backhaul and access links, which may be configured semi-statically by a CU (e.g., IAB donor at layer-3) or dynamically by DU (e.g., parent IAB node at layer-1). Multiplexing between backhaul link and access link resources may be TDM, frequency division multiplexing (“FDM”), or may allow time-frequency resource sharing. Furthermore, resources may be allocated exactly (e.g., per node or per link) or in the form of a resource pool.

In certain embodiments, there may be time-domain allocation parameters. Specifically, time-domain allocation parameters k0, k1, k2 are used in various embodiments herein.

For physical downlink shared channel (“PDSCH”) time-domain allocation: the RRC parameter k0 in the RRC information element PDSCH-TimeDomainResourceAllocation indicates the offset between the slot that contains a downlink control information (“DCI”) that schedules a PDSCH and the slot that contains the PDSCH. The parameter k0 may not have an equivalent in LTE. Essentially, the offset is always 0 in LTE.

Moreover, for PDSCH hybrid automatic repeat request (“HARQ”) feedback timing: the layer 1 (“L1”) parameter k1 is provided by the ‘PDSCH-to-HARQ_feedback timing indicator’ field in the DCI formats 1_0 and 1_1 (e.g., for scheduling a PDSCH). The parameter k1 may be equivalent to K in LTE TDD.

Furthermore, for physical uplink shared channel (“PUSCH”) time-domain allocation: the RRC parameter k2 in the RRC information element PUSCH-TimeDomainResourceAllocation indicates an offset between a slot that contains a DCI that schedules a PUSCH and the slot that contains the PUSCH. The parameter k2 may be equivalent to the parameter k in LTE TDD.

The DCI formats may be as shown in Table 2.

TABLE 2

| DCI format | Usage |
|---|---|
| 0_0 | Scheduling of PUSCH in one cell |
| 0_1 | Scheduling of one or multiple PUSCH in one |
| | cell, or indicating downlink feedback |
| | information for configured grant PUSCH (CG- |
| | DFI) |
| 0_2 | Scheduling of PUSCH in one cell |
| 1_0 | Scheduling of PDSCH in one cell |
| 1_1 | Scheduling of PDSCH in one cell, and/or |
| | triggering one shot HARQ-ACK codebook |
| | feedback |
| 1_2 | Scheduling of PDSCH in one cell |
| 2_0 | Notifying a group of UEs of the slot format, |
| | available RB sets, COT duration and search |
| | space set group switching |
| 2_1 | Notifying a group of UEs of the PRB(s) and |
| | OFDM symbol(s) where UE may assume no |
| | transmission is intended for the UE |
| 2_2 | Transmission of TPC commands for PUCCH and |
| | PUSCH |
| 2_3 | Transmission of a group of TPC commands for |
| | SRS transmissions by one or more UEs |
| 2_4 | Notifying a group of UEs of the PRB(s) and |
| | OFDM symbol(s) where UE cancels the |
| | corresponding UL transmission from the UE |
| 2_5 | Notifying the availability of soft resources |
| 2_6 | Notifying the power saving information outside |
| | DRX Active Time for one or more UEs |
| 3_0 | Scheduling of NR sidelink in one cell |
| 3_1 | Scheduling of LTE sidelink in one cell |

It should be noted that, as used herein, a DCI message scheduling a PUSCH may refer to a DCI format 0_0, 0_1, or 0_2; a DCI message scheduling a PDSCH may refer to a DCI format 1_0, 1_1, or 1_2; an SFI message may refer to a DCI format 2_0; and an AI message may refer to a DCI format 2_5.

Table 3 illustrates various timing alignment embodiments in IAB SI.

TABLE 3

| | | |
|---|---|---|
| Case #1 | DL transmission timing alignment across IAB-nodes and IAB- | Supported for |
| | donors | both access |
| | If DL TX and UL RX are not well aligned at the parent | and backhaul |
| | node, additional information about the alignment is | link |
| | needed for the child node to properly set its DL TX | transmission |
| | timing for OTA based timing & synchronization | |
| Case #2 | DL and UL transmission timing is aligned within an IAB-node | Not supported |
| Case #3 | DL and UL reception timing is aligned within an IAB-node | Not supported |
| Case #4 | within an IAB-node, when transmitting using Case #2 while | Not supported |
| | when receiving using Case #3 | |
| Case #5 | Case #1 for access link timing and Case #4 for backhaul link | Not supported |
| | timing within an IAB-node in different time slots | |
| Case #6 | Case#1 DL transmission timing + Case #2 UL transmission | If supported, |
| | timing | under control |
| | The DL transmission timing for all IAB-nodes is aligned | of parent/ |
| | with the parent IAB-node or donor DL timing | network |
| | The UL transmission timing of an IAB-node can be | |
| | aligned with the IAB-node's DL transmission timing | |
| Case #7 | Case#1 DL transmission timing + Case #3 UL reception timing | Compatible |
| | The DL transmission timing for all IAB-nodes is aligned | with Rel-15 |
| | with the parent IAB-node or donor DL timing | UEs by |
| | The UL reception timing of an IAB-node can be aligned | introducing an |
| | with the IAB-node's DL reception timing | “effective” |
| | If DL TX and UL RX are not well aligned at the parent | negative TA |
| | node, additional information about the alignment is | |
| | needed for the child node to properly set its DL TX | |
| | timing for OTA based timing & synchronization | |

In various embodiments, Case-1 is approved for IAB Rel-16, which focused on TDM, cases 2, 3, 4, and 5 may not be supported, and Case-6 and Case-7 may be candidates for enhanced timing alignment to facilitate and improve performance of FDM and/or SDM between simultaneous upstream and downstream operations.

In certain embodiments, an IAB system may be connected to a core network through one or more IAB donors. Further, each IAB node may be connected to an IAB donor and/or other IAB nodes through wireless backhaul links. Each IAB donor and/or node may also serve UEs.

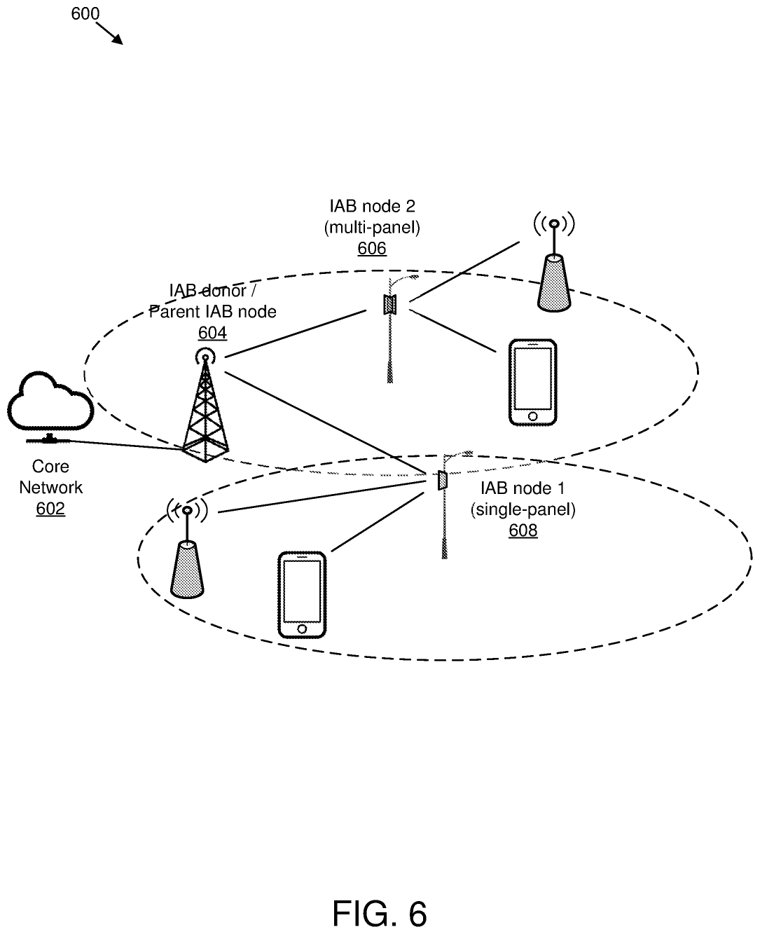

FIG. 6 is a schematic block diagram illustrating one embodiment of an IAB system 600 with single-panel and multi-panel IAB nodes. The IAB system 600 includes a core network 602, an IAB donor and/or parent IAB node 604, an IAB node 2 (e.g., multi-panel) 606, and an IAB node 1 (e.g., single-panel) 608.

There are various options with regards to the structure and multiplexing and/or duplexing capabilities of an IAB node. For example, each IAB node may have one or may antenna panels, each connected to the baseband unit through a radio frequency (“RF”) chain. The one or may antenna panels may be able to serve a wide spatial area of interest in a vicinity of the IAB node, or otherwise each antenna panel or each group of antenna panels may provide a partial coverage such as a “sector.” An IAB node with multiple antenna panels, each serving a separate spatial area or sector, may still be referred to as a single-panel IAB node as it behaves similarly to a single-panel IAB node for communications in each of the separate spatial areas or sectors.

In some embodiments, each antenna panel may be half-duplex (“HD”), meaning that it is able to either transmit or receive signals in a frequency band at a time, or full-duplex (“FD”), meaning that it is able to both transmit and receive signals in a frequency band simultaneously. Unlike full-duplex radio, half-duplex radio is widely implemented and used in practice and may be assumed to be a default mode of operation in wireless systems.

Table 4 lists different duplexing scenarios of interest if multiplexing is not constrained to time-division multiplexing (“TDM”). In table 4, single-panel and multi-panel IAB nodes are considered for different cases of simultaneous transmission and/or reception. Spatial-division multiplexing (“SDM”) may refer to either transmission or reception on downlink (or downstream) and uplink (or upstream) simultaneously; full duplex (“FD”) may refer to simultaneous transmission and reception by a same antenna panel in a frequency band; and multi-panel transmission and reception (“MPTR”) may refer to simultaneous transmission and/or reception by multiple antenna panels where each antenna panel either transmits or receives in a frequency band at a time.

TABLE 4

| | | Simulta- | | | |
|---|---|---|---|---|---|
| | Architecture/ | neous | | | |
| Case# | Capability | TX/RX Type | IAB-MT | IAB-DU | Scenario# |
| Case A/ | Single-panel | TX SDM | UL-TX | DL-TX | S3 |
| Case#1 | Multi-panel | TX | UL-TX | DL-TX | S7 |
| | | MPTR/SDM | | | |
| Case B/ | Single-panel | RX SDM | DL-RX | UL-RX | S1 |
| Case#2 | Multi-panel | RX | DL-RX | UL-RX | S5 |
| | | MPTR/SDM | | | |
| Case C/ | Single-panel | UL FD | UL-TX | UL-RX | S4 |
| Case#3 | Multi-panel | UL | UL-TX | UL-RX | S8 |
| | | MPTR/FD | | | |
| Case D/ | Single-panel | DL FD | DL-RX | DL-TX | S2 |
| Case#4 | Multi-panel | DL | DL-RX | DL-TX | S6 |
| | | MPTR/FD | | | |

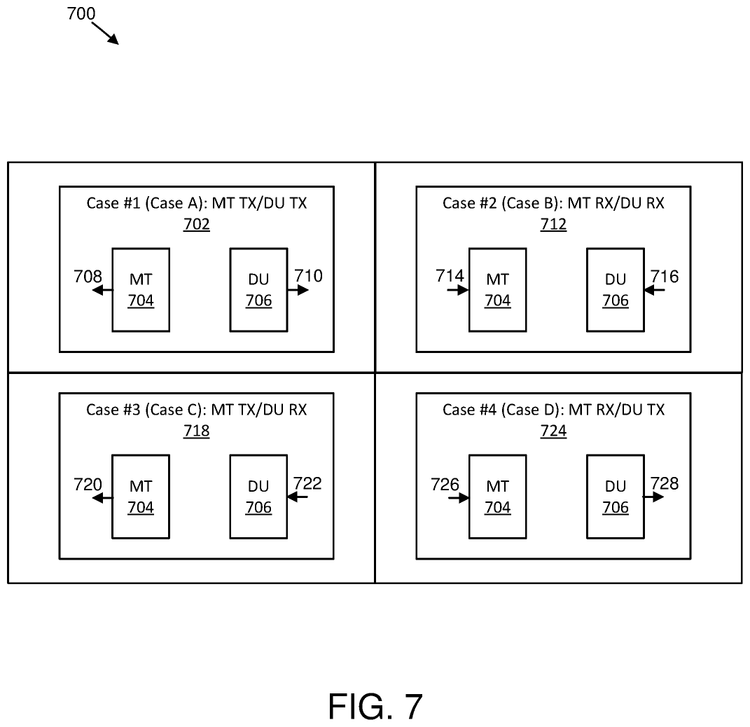

In table 4, based on a type of simultaneous operations and a number of panels in an IAB node, the scenarios are called S1, S2, . . . , S8, while the “Case” numbers (e.g., A/B/C/D or 1/2/3/4) may be in accordance with FIG. 7.

FIG. 7 is a schematic block diagram 700 illustrating one embodiment of types of simultaneous transmission and/or reception operations. The diagram 700 illustrates a first case 702 (e.g., Case #1, Case A, MT TX and DU TX) having an MT 704 and a DU 706, in which the MT 704 transmits 708 and the DU 706 transmits 710. Moreover, the diagram 700 illustrates a second case 712 (e.g., Case #2, Case B, MT RX and DU RX) having the MT 704 and the DU 706, in which the MT 704 receives 714 and the DU 706 receives 716. Further, the diagram 700 illustrates a third case 718 (e.g., Case #3, Case C, MT TX and DU RX) having the MT 704 and the DU 706, in which the MT 704 transmits 720 and the DU 706 receives 722. The diagram 700 illustrates a fourth case 724 (e.g., Case #4, Case D, MT RX and DU TX) having the MT 704 and the DU 706, in which the MT 704 receives 726 and the DU 706 transmits 728. As used herein, different cases may be referred to by the case #, case letter, or description as found in FIG. 7.

The following signaling mechanisms in NR may enable communicating DL and/or UL information of an orthogonal frequency division multiplexing (“OFDM”) symbol to a UE: 1) semi-static RRC signaling; 2) dynamic SFI shared by a group of UEs; and/or 3) dynamic signaling to schedule a channel for a UE.

In certain embodiments, there may be a combination of configurations found herein for four enhanced duplexing cases. For each case, several scenarios may be identified, and embodiments may be proposed for an IAB-MT and an IAB-DU in association with each scenario. The IAB-MT and the IAB-DU are part of an IAB node in some embodiments. If a reference is made to an IAB node, it may be made to the IAB node including the IAB-MT and/or the IAB-DU. If a reference is made to a parent node, it may be made to a parent node serving the IAB-MT. If a reference is made to a child node, it may be made to a child node (or UE or enhanced UE) served by the IAB-DU.

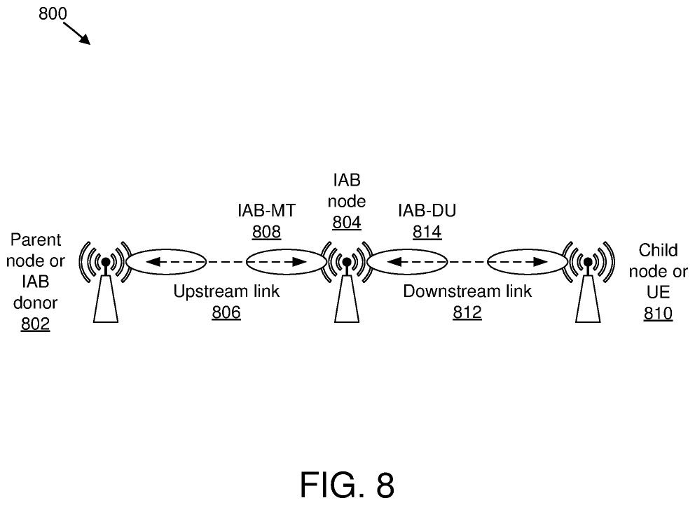

FIG. 8 is a schematic block diagram illustrating one embodiment of a system 800 with an IAB node connected to a parent node 802 and a child node 810. The parent node 802 or IAB donor communicates with an IAB node 804 via an upstream link 806 (e.g., via an IAB-MT 808 of the IAB node 804), and the IAB node 804 communicates with the child node 810 or UE via a downstream link 812 (e.g., via an IAB-DU 814).

In different embodiments, configurations or signaling for an IAB-MT or an IAB-DU are found. For an IAB-MT, the configuration or signaling may be received by the IAB node from an IAB-CU or a parent node serving the IAB node. For example, if an embodiment describes “an IAB-MT is configured by a resource configuration,” it means the IAB node including the IAB-MT has received the resource configuration for the IAB-MT. Similarly, for an IAB-DU, the configuration or signaling may be received by the IAB node from an IAB-CU or a parent node serving the IAB node. In some embodiments, configuration or signaling may be received by a child node served by the IAB-DU, in which case the IAB-DU may also be informed of the configuration or signaling to the child node. For example, if an embodiment describes “an IAB-DU is configured by a resource configuration,” it may mean a child node (or a UE or an enhanced UE) served by the IAB-DU has received the resource configuration, in which case the IAB node including the IAB-DU may also be informed of the resource configuration.

In different embodiments herein, a configuration or signaling may be received from an IAB-CU on an F1 interface. Moreover, a control signaling may be received from a parent node or a child node on a physical control channel or by a medium access control (“MAC”) message.

Further, in some embodiments, SDM may refer to a scenario where the same frequency resources are used for multiple operations that are multiplexed in a spatial domain (e.g., by multiple antenna panels and/or multiple beams). In various embodiments, FDM may refer to a scenario where different frequency resources are used for multiple operations that may or may not be multiplexed in a spatial domain. The focus of these embodiments may be on reusing time resources, although TDM is not precluded, possibly in combination of SDM and/or FDM. As such, a combination of SDM and FDM and possible combination with other multiplexing schemes such as code division multiplexing (“CDM”) are not precluded.

In certain embodiments, SDM may refer to multi-panel operation where multiple antennas, antenna panels, antenna ports, and so forth may be used for multiplexing communications.

In some embodiments, the IE names TDD-UL-DL-ConfigCommon and TDD-UL-DL-ConfigDedicated may be abbreviated as ConfigCommon and ConfigDedicated, respectively. In various embodiments, ConfigCommon and ConfigDedicated may refer to any common and dedicated configuration of resources, respectively. Moreover, existing RRC IE TDD-UL-DL-ConfigDedicated-IAB-MT-r16 may be referred to as ConfigDedicated. Furthermore, new RRC IEs may be used, which may be called TDD-UL-DL-ConfigDedicated2-r17 or TDD-UL-DL-ConfigDedicated2-IAB-MT-r17, for example. These IEs may be abbreviated as ConfigDeidcated2 without an emphasis on what the IEs may be called.

In various embodiments, a multiplexing scheme may be emphasized in a round bracket (e.g., (SDM), (FDM), (SDM/FDM), and so forth). This may emphasize that an embodiment, feature, condition, constraint, etc. may be applicable to a particular multiplexing scheme in some implementations. However, this does not preclude applicability of the embodiment, feature, condition, constraint, etc. to other multiplexing schemes. For example, an embodiment marked with (FDM) may be applicable to FDM as well as individually (SDM, TDM, CDM, etc.) or in combination with FDM (SDM/FDM, TDM/FDM, CDM/FDM, etc.).

In certain embodiments, reference is made to time-overlapping (“TOL”) resources such as TOL symbols, although other embodiments may use a different term for overlapping resources or simply refer to the “same” resources. This definition may be used to clarify that TOL resources may be defined or configured for different entities, such as different IAB nodes, an IAB-MT and IAB-DU of an IAB node, and so forth. Cases with different numerologies where a symbol in a first operation and/or configuration may not have the same length in time as a symbol in a second operation and/or configuration may be covered. Further a timing misalignment, whether deliberate due to employing different timing alignments or due to an error may be covered.

In various embodiments, it should be noted that TOL as a relationship between two resources is commutative—if a first resource and/or symbol A is time-overlapping with a second resource and/or symbol B, then B is also TOL with A. Descriptions of such embodiments may make reference to a symbol in a first operation and/or configuration and a TOL symbol in a second operation and/or configuration.

In certain embodiments, an “operation” may refer to a transmission (“TX”) of a signal or a reception (“RX”) of a signal. In such embodiments, a simultaneous operation may refer to simultaneous transmissions, simultaneous receptions, or simultaneous transmissions and receptions by two communication entities. In some embodiments, two entities may belong to a same node such as an IAB node. In various embodiments, two entities may be an IAB-MT and an IAB-DU of an IAB node.

Moreover, although embodiments are described for symbols, such as OFDM symbols, as a unit of time resources, embodiments may be extended to other units such as slots, mini-slots, subframes, a group of symbols such as all the DL, UL, or F symbols in a slot or a group of slots, and so forth. Furthermore, embodiments may be extended to a frequency domain (e.g., with a unit of resource element, resource block, sub-channel, etc.) or other domains.

In a first set of embodiments for Case A (e.g., Case #1), Table 5 summarizes different combinations for simultaneous IAB-MT TX (e.g., UL) and IAB-DU TX (e.g., DL).

TABLE 5

| | IAB-DU | | | | |
|---|---|---|---|---|---|
| | configured DL | | | | |
| | by | | IAB-DU | | |
| | ConfigCommon | IAB-DU | configured | IAB-DU | IAB-DU |
| | or | indicating | CORESET, | scheduling | configured |
| | ConfigDedicated | DL by SFI | DL-RS | PDSCH | SPS |
| IAB-MT | A-1-1 | A-1-2 | A-1-3 | A-1-4 | A-1-5 |
| configured UL | | | | | |
| by | | | | | |
| ConfigCommon | | | | | |
| or | | | | | |
| ConfigDedicated | | | | | |
| IAB-MT | A-2-1 | A-2-2 | A-2-3 | A-2-4 | A-2-5 |
| indicated UL by | | | | | |
| SFI | | | | | |
| IAB-MT | A-3-1 | A-3-2 | A-3-3 | A-3-4 | A-3-5 |
| configured | | | | | |
| PUCCH, UL-RS | | | | | |
| IAB-MT | A-4-1 | A-4-2 | A-4-3 | A-4-4 | A-4-5 |
| scheduled | | | | | |
| PUSCH | | | | | |
| IAB-MT | A-5-1 | A-5-2 | A-5-3 | A-5-4 | A-5-5 |
| configured CG- | | | | | |
| PUSCH | | | | | |

In the first set of embodiments, references are made to the following recurring phrases: 1) simultaneous TX capability: this may refer to an IAB node's capability to perform simultaneous transmissions, which may indicate that the IAB node is capable of SDM and/or FDM, the IAB node has multiple antenna panels (SDM), the IAB node is capable of simultaneous transmissions in DL and UL, the IAB node is capable of enhanced duplexing, or the like—in the case of configuration-based embodiments, information of the capability may be sent to an IAB-CU that configures the system—in the case of configurations based on control signaling, the information of the capability may be sent to another IAB node such as a parent node or a child node; 2) power imbalance constraint: this may refer to a constraint according to which the difference between a TX powers for an IAB-MT TX and an IAB-DU TX is not larger than a threshold—the threshold may be determined by an IAB node capability that specifies a maximum power imbalance on one panel (FDM) or among multiple panels (SDM)—in the case of configuration-based embodiments, a power imbalance constraint may be satisfied by semi-static configuration of TX powers—in the case of embodiments based on control signaling, a TX power for an IAB-MT TX may be determined by a parent node serving the IAB-MT—therefore, a power imbalance constraint may require an IAB node to adjust a TX power for an IAB-DU TX, if possible, or decline a transmission otherwise; 3) total power constraint: this may refer to a constraint according to which the total TX power for an IAB-MT TX and an IAB-DU TX does not exceed a threshold—the threshold may be determined by an IAB node capability that specifies a maximum total power for a panel (FDM) or for the IAB node (SDM), by a regulatory limit, or a like—in the case of configuration-based embodiments, a total power constraint may be satisfied by semi-static configuration of TX powers—in the case of embodiments based on control signaling, a TX power for an IAB-MT TX may be determined by a parent node serving the IAB-MT—therefore, a total power constraint may require an IAB node to adjust a TX power for an IAB-DU TX, if possible, or decline a transmission otherwise; 4) interference constraint: this may refer to a variety of interference constraints between antennas of an IAB node (self-interference), interference on other nodes or channels or cells, and so forth—in some embodiments, according to an interference constraint, the interference by an IAB-DU TX on a parent node should be below a threshold when the parent node performs beamforming for receiving a signal from the IAB-MT—in various embodiments, according to an interference constraint, the interference by the IAB-MT TX on a child node should be below a threshold when the child node performs beamforming for receiving a signal from the IAB-DU; 5) guard band constraint: this may refer to a constraint according to which the frequency resources (e.g., PRBs) allocated to the IAB-MT are separated from the frequency resources allocated to the IAB-DU by at least a threshold called a guard band—a value of the guard band may be determined by an IAB node capability for one panel (FDM) or among multiple panels (SDM)—in the case of configuration-based embodiments, a resource may be allocated by a configuration—in the case of embodiments based on control signaling, a resource may be allocated by control message such as an L1/L2 message; 6) spatial constraint (FDM): this may refer to a constraint according to which a beam (spatial filter) for transmitting a signal is constrained by a beam (spatial filter) for transmitting another signal—a common case for this constraint is when one or more antenna panels are controlled by a same circuitry for controlling beamforming—in this case, if the one or multiple panels are beamformed to transmit a first signal in a particular direction in the spatial domain, any second signal may be constrained to be transmitted with a same beamforming configuration if the same one or more panels are to be used—whether a spatial constraint applies to an IAB node or an antenna panel of an IAB node may be determined by a capability of the IAB node, which may be communicated to an IAB-CU (e.g., in the case of configuration-based embodiments) or another IAB node such as a parent node or a child node (e.g., in the case of embodiments based on control signaling); and 7) timing alignment constraint (FDM): this constraint may be applicable if the antenna panel is connected to a baseband processor with one discrete Fourier transform (“DFT”) and/or inverse DFT (“IDFT”) window. In this case, the timing for an IAB-MT TX and an IAB-DU TX may be aligned at least at a symbol level. The timing alignment may correspond to a Case-6 timing scheme as specified by a standard, configured by a network, signaled by a parent node, and so forth.

In an embodiment A-1-1, if an IAB-MT is configured UL on a symbol, an IAB-DU may be configured DL on a TOL symbol in accordance with an SDM and/or FDM scheme provided that one or more conditions hold (e.g., the IAB node has a simultaneous TX capability or a constraint based on a guard band or a timing alignment is satisfied).

In some embodiments, an IAB node is configured UL on a symbol by a first configuration, while a child node served by the IAB-DU is configured DL on a TOL symbol by a second configuration. Each of the first configuration and the second configuration may include a TDD-UL-DL-ConfigCommon and/or a TDD-UL-DL-ConfigDedicated as defined for a legacy system.

In various embodiments, a first configuration may include a TDD-UL-DL-ConfigCommon and/or a TDD-UL-DL-ConfigDedicated as defined for a legacy system while a second configuration may include a new IE such as a TDD-UL-DL-ConfigDedicated2-r17, abbreviated as ConfigDedicated2 herein. In certain embodiments, ConfigDedicated2 has a similar structure as that of ConfigDedicated.

In some embodiments, a second configuration may include a TDD-UL-DL-ConfigCommon and/or a TDD-UL-DL-ConfigDedicated as defined for a legacy system while a first configuration may include a new IE such as a TDD-UL-DL-ConfigDedicated2-r17, abbreviated as ConfigDedicated2 herein. In various embodiments, ConfigDedicated2 has a similar structure as that of ConfigDedicated.

In certain embodiments, a second configuration may take a lower priority than, or may be overridden by, a first configuration. In some embodiments, a first configuration may take a lower priority than, or may be overridden by, a second configuration. In various embodiments, a priority between a first configuration and a second configuration may be determined by a separate signaling or configuration or, alternatively, by a field in the first configuration or the second configuration.

In certain embodiments, resources configured by a configuration with a higher priority may be used unconditionally for scheduled communications, periodic, semi-persistent, or aperiodic communications, and so forth, while resources configured by a configuration with a lower priority may be used if one or more conditions are satisfied. Examples of conditions may include a power imbalance constraint, a total power constraint, an interference constraint, and/or a spatial constraint.

In some embodiments, a first resource configuration (e.g., including a ConfigCommon and a ConfigDedicated) for the IAB-MT may take a higher priority than a second resource configuration (e.g., including a ConfigCommon and a ConfigDedicated2) for a child node served by the IAB-DU. In such embodiments, a symbol configured UL by the first configuration may be used for a UL transmission unconditionally, while a TOL symbol configured DL by the second configuration may be used for a DL transmission if a condition based on a power imbalance, a total power, an interference, a spatial constraint, or a like is satisfied.

In various embodiments, a dynamic control signaling such as a DCI message or a MAC message to a child node served by the IAB-DU may be used to inform the child node of whether the TOL symbol will be used as DL.

Inversely, in certain embodiments, a first resource configuration (e.g., including a ConfigCommon and a ConfigDedicated2) for the IAB-MT may take a lower priority than a second resource configuration (e.g., including a ConfigCommon and a ConfigDedicated) for a child node served by the IAB-DU. In such embodiments, a symbol configured DL by the second configuration may be used for a DL transmission unconditionally, while a TOL symbol configured UL by the first configuration may be used for a UL transmission if a condition based on a power imbalance, a total power, an interference, a spatial constraint, or the like is satisfied.

In some embodiments, a dynamic control signaling such as a UCI message or a MAC message to a parent node may be used to inform the parent node of whether the TOL symbol will be used as UL, whether a UL transmission by the IAB-MT will be omitted or canceled or truncated, whether a condition such as a power or interference condition is not being satisfied, and so forth. In some examples, the dynamic control signaling may be carried on a PUCCH or PUSCH. Moreover, the dynamic control signaling may be a data-associated control message.

In various embodiments, if a TX timing alignment scheme such as a Case-6 timing alignment is to be applied (FDM), a resource configuration with a higher priority may determine a timing of an associated transmission, while a transmission associated with a lower-priority resource configuration may follow the determined timing.

For example, if a symbol configured UL for the IAB-MT has a higher priority than a TOL symbol configured DL for a child node served by the IAB-DU, then a UL transmission by the IAB-MT on the symbol may determine the timing (e.g., as indicated by a parent node serving the IAB-MT), while the IAB-DU aligns its DL transmission on the TOL symbol with the UL transmission according to a TX (Case-6) timing alignment scheme. It should be noted that this embodiment may not follow a Case-1 timing alignment.

Inversely, in certain embodiments, if a symbol configured UL for the IAB-MT has a lower priority than a TOL symbol configured DL for a child node served by the IAB-DU, then a DL transmission by the IAB-DU on the symbol may determine the timing (e.g., as indicated by a parent node according to a Case-1 timing alignment), while the IAB-MT aligns its UL transmission on the TOL symbol with the DL transmission according to a TX (Case-6) timing alignment scheme.

In some embodiments, the DL TX follows a Case-1 timing alignment while a TX timing alignment scheme such as a Case-6 TX timing alignment is to be applied (e.g., FDM). In such embodiments, simultaneous transmissions occur only if the TX (Case-6) timing alignment may be performed (e.g., if the timing of DL TX and UL TX can be aligned). Otherwise, one of the transmissions such as a transmission with a higher priority is performed while the other transmission is omitted, canceled, or not scheduled.

In an embodiment A-1-2, if an IAB-MT is configured UL on a symbol, an IAB-DU may indicate DL on a TOL symbol by an SFI to a child node in accordance with an SDM and/or FDM scheme provided that one or more conditions hold (e.g., the IAB node has a simultaneous TX capability or a constraint based a power imbalance, a total power, an interference, a guard band, a spatial constraint, and/or a timing alignment is satisfied).

In various embodiments, regarding power imbalance and total power constraints, a TX power for an IAB-MT TX may be determined by signaling from a parent node or by a configuration. A minimum DL TX power may also be determined based on a configuration, a minimum requirement for coverage, and so forth. Then, given a power imbalance threshold and/or a total power threshold, the IAB-DU may determine whether to indicate DL on the TOL symbol based on the IAB-MT TX power and the minimum DL TX power.

In certain embodiments, an IAB node is configured UL on a symbol by a resource configuration, which may include a TDD-UL-DL-ConfigCommon, a TDD-UL-DL-ConfigDedicated, and/or a TDD-UL-DL-ConfigDedicated2-r17.

In some embodiments, an SFI by an IAB-DU may take a lower priority than, or may be overridden by, a resource configuration for an IAB-MT. In various embodiments, a resource configuration for an IAB-MT may take a lower priority than, or may be overridden by, an SFI by an IAB-DU. In certain embodiments, a priority between a resource configuration and an SFI may be determined by a separate signaling or configuration or, alternatively, by a field in the resource configuration or the SFI.

In some embodiments, resources configured and/or indicated by a configuration or signaling with a higher priority may be used unconditionally for scheduled communications, periodic communications, semi-persistent communications, or aperiodic communications, and so forth; while resources configured and/or indicated by a configuration or signaling with a lower priority may be used if one or more of the aforementioned conditions (e.g., capability, power, interference, spatial, timing, etc.) are satisfied.

In various embodiments, a resource configuration (e.g., including a ConfigCommon and a ConfigDedicated) for an IAB-MT may take a higher priority than an SFI by an IAB-DU. In such embodiments, a symbol configured UL by the resource configuration may be used for a UL transmission unconditionally, while a TOL symbol indicated DL by the SFI may be used for a DL transmission if a condition based on a power imbalance, a total power, an interference, a spatial constraint, or the like is satisfied.

Inversely, in certain embodiments, an SFI by an IAB-DU may take a higher priority than a resource configuration (e.g., including a ConfigCommon and a ConfigDedicated) for an IAB-MT. In such embodiments, a symbol indicated DL by the SFI may be used for a DL transmission unconditionally, while a TOL symbol configured UL by the resource configuration may be used for an UL transmission if a condition based on a power imbalance, a total power, an interference, a spatial constraint, or the like is satisfied.

In some embodiments, a dynamic control signaling such as an uplink control information (“UCI”) message or a MAC message to a parent node may be used to inform a parent node of whether a symbol will be available, whether an UL transmission by an IAB-MT will be omitted or canceled, whether a condition such as a power or interference condition is not being satisfied, and so forth.

In various embodiments, if a TX timing alignment scheme, such as a Case-6 timing alignment, is to be applied (FDM), a resource configuration or signaling with a higher priority may determine a timing of an associated transmission, while a transmission associated with a lower-priority resource configuration or signaling may follow the determined timing.

For example, if a symbol configured UL for the IAB-MT has a higher priority than a TOL symbol indicated DL by the IAB-DU, then an UL transmission by the IAB-MT on the symbol may determine the timing (e.g., as indicated by a parent node serving the IAB-MT), while the IAB-DU aligns its DL transmission on the TOL symbol with the UL transmission according to a TX (Case-6) timing alignment scheme. It should be noted that this embodiment may not follow a Case-1 timing alignment.

Inversely, in certain embodiments, if a symbol configured UL for the IAB-MT has a lower priority than a TOL symbol indicated DL by the IAB-DU, then a DL transmission by the IAB-DU on the symbol may determine the timing (e.g., as indicated by a parent node according to a Case-1 timing alignment), while the IAB-MT aligns its UL transmission on the TOL symbol with the DL transmission according to a TX (Case-6) timing alignment scheme.

In some embodiments, a DL TX follows a Case-1 timing alignment while a TX timing alignment scheme such as a Case-6 TX timing alignment is to be applied (FDM). In such embodiments, simultaneous transmissions occur only if the TX (Case-6) timing alignment can be performed (e.g., if the timing of DL TX and UL TX can be aligned). Otherwise, one of the transmissions such as a transmission with a higher priority is performed while the other transmission is omitted, canceled, truncated, or not scheduled. Particularly, in various embodiments, a TOL symbol may not be indicated DL as it may otherwise not allow a Case-1 and Case-6 timing alignment simultaneously.

In embodiments A-3-2 and A-5-2: embodiment A-3-2 is similar to embodiment A-1-2 except that a resource configuration for an IAB-MT is replaced by a configuration for a PUCCH or an uplink reference signal (“UL-RS”) such as an SRS; and embodiment A-5-2 is similar to embodiment A-1-2 except that the resource configuration for the IAB-MT is replaced by a configured grant.

In embodiment A-2-1, if an IAB-DU is configured DL on a symbol, an IAB-MT may be indicated UL on a TOL symbol by an SFI from a parent node in accordance with an SDM and/or FDM scheme provided that one or more conditions hold (e.g., an IAB node has a simultaneous TX capability or a constraint based a power imbalance, a total power, an interference, a guard band, a spatial constraint, and/or a timing alignment being satisfied).

In various embodiments, regarding power imbalance and total power constraints, a TX power for an IAB-MT TX may be determined by signaling from a parent node or by a configuration. A minimum DL TX power may also be determined based on a configuration, a minimum requirement for coverage, and so forth. Then, given a power imbalance threshold and/or a total power threshold, a parent node serving the IAB-MT may determine whether to indicate UL on the TOL symbol based on the IAB-MT TX power and the minimum DL TX power. To realize such embodiments, the parent node may be informed of an IAB-MT's TX power constraint through a control signaling from the IAB-MT.

In certain embodiments, a child node served by an IAB node is configured DL on a symbol by a resource configuration which may include a TDD-UL-DL-ConfigCommon, a TDD-UL-DL-ConfigDedicated, and/or a TDD-UL-DL-ConfigDedicated2-r17.

In some embodiments, an SFI by a parent node may take a lower priority than, or may be overridden by, a resource configuration for a child node served by an IAB-DU. In various embodiments, a resource configuration for a child node served by the IAB-DU may take a lower priority than, or may be overridden by, an SFI from the parent node. In certain embodiments, a priority between a resource configuration and an SFI may be determined by a separate signaling or configuration or, alternatively, by a field in the resource configuration or the SFI.

In some embodiments, resources configured and/or indicated by a configuration or signaling with a higher priority may be used unconditionally for scheduled communications, periodic communications, semi-persistent communications, or aperiodic communications, and so forth, while resources configured and/or indicated by a configuration or signaling with a lower priority may be used if one or more of the aforementioned conditions (e.g., capability, power, interference, spatial, timing, etc.) are satisfied.

In various embodiments, a resource configuration (e.g., including a ConfigCommon and a ConfigDedicated) for a child node served by the IAB-DU may take a higher priority than an SFI by a parent node. In such embodiments, a symbol configured DL by the resource configuration may be used for a DL transmission unconditionally, while a TOL symbol indicated UL by the SFI may be used for a UL transmission if a condition based on a power imbalance, a total power, an interference, a spatial constraint, or the like is satisfied.

In certain embodiments, a dynamic control signaling such as an UCI message or a MAC message to a parent node may be used to inform the parent node of whether a symbol will be available, whether an UL transmission by the IAB-MT will be omitted or canceled, whether a condition such as a power or interference condition is not being satisfied, and so forth.

According to some embodiments, a symbol configured DL for a child node served by an IAB-DU may already be scheduled for a DL TX such as a PDSCH. In such embodiments, a layer 1 (“L1”) and/or layer 2 (“L2”) control signaling may be used to indicate to a parent node to reject an SFI. In one realization, a control message may reject the SFI message. In an alternative realization, a control message may include a bitmap or a similar structure as the SFI message indicating which resources may or may not be available as indicated by the SFI. In one example, a control message may include a recommended SFI. The recommended SFI may be based on the received SFI. A control message acknowledging that an SFI or a part of an SFI is accepted by the receiving node may be called an SFI-ACK message. Transmitting an SFI-ACK message may be optional (e.g., only if the associated SFI or part of the associated SFI is rejected) according to a specification, configuration, or control signaling.

Inversely, in various embodiments, an SFI by a parent node may take a higher priority than a resource configuration (e.g., including a ConfigCommon and a ConfigDedicated) for a child node served by the IAB-DU. In such embodiments, a symbol indicated UL by the SFI may be used for a UL transmission unconditionally, while a TOL symbol configured DL by the resource configuration may be used for a DL transmission if a condition based on a power imbalance, a total power, an interference, a spatial constraint, or the like being satisfied.

In certain embodiments, if a TX timing alignment scheme, such as a Case-6 timing alignment, is to be applied (FDM), a resource configuration or signaling with a higher priority may determine a timing of an associated transmission, while a transmission associated with a lower-priority resource configuration or signaling may follow the determined timing.

For example, if a symbol configured DL for a child node served by the IAB-DU has a higher priority than a TOL symbol indicated UL by the parent node, then a DL transmission by the IAB-DU on the symbol may determine the timing (e.g., as indicated by a parent node according to a Case-1 timing alignment), while an IAB-MT aligns its UL transmission on the TOL symbol with the DL transmission according to a TX (Case-6) timing alignment scheme.

Inversely, in some embodiments, if a symbol configured DL for a child node served by an IAB-DU has a lower priority than a TOL symbol indicated UL by the parent node, then an UL transmission by an IAB-MT on the symbol may determine the timing (e.g., as indicated by a parent node), while the IAB-DU aligns its DL transmission on the TOL symbol with the UL transmission according to a TX (Case-6) timing alignment scheme. Such embodiments may not follow a Case-1 timing alignment.

In various embodiments, a DL TX follows a Case-1 timing alignment while a TX timing alignment scheme, such as a Case-6 TX timing alignment, is to be applied (FDM). In such embodiments, simultaneous transmissions occur only if the TX (Case-6) timing alignment may be performed (e.g., if the timing of DL TX and UL TX can be aligned). Otherwise, one of the transmissions, such as a transmission with a higher priority, is performed while the other transmission is omitted, canceled, or not scheduled. Particularly, in certain embodiments, a TOL symbol may not be indicated UL as it may otherwise not allow Case-1 and Case-6 timing alignment simultaneously.

In embodiments A-2-3 and A-2-5, embodiment A-2-3 is similar to embodiment A-2-1 except that a resource configuration for an IAB-DU is replaced by a configuration for a physical downlink control channel (“PDCCH”) or a DL-RS such as a channel state information (“CSI”) reference signal (“RS”) (“CSI-RS”), and an SFI-ACK method as described for embodiment A-2-1 may be used in embodiment A-2-5 if a semi-persistent scheduling (“SPS”) configured for a child node served by an IAB-DU takes a higher priority than an SFI received by an IAB-MT and if a simultaneous transmission may not be accommodated due to a lack of capability or due to a constraint (e.g., power, interference, guard band, spatial, timing, etc.) not being satisfied. The priority may be determined by a specification, a configuration, or a control signaling.

In embodiment A-2-2: for embodiment A-2-2-a with upstream SFI received before sending downstream SFI, if an IAB-MT is indicated UL on a symbol by an SFI from a parent node, an IAB-DU may indicate DL on a TOL symbol by an SFI to a child node in accordance with an SDM and/or FDM scheme provided that one or more conditions hold (e.g., the IAB node has a simultaneous TX capability or a constraint based a power imbalance, a total power, an interference, a guard band, a spatial constraint, or a timing alignment being satisfied); and for embodiment A-2-2-b with downstream SFI sent before receiving upstream SFI, if an IAB-DU has indicated DL on a symbol by an SFI to a child node, an IAB-MT may be indicated UL on a TOL symbol by an SFI from a parent node in accordance with an SDM and/or FDM scheme provided that one or more conditions hold (e.g., the IAB node has a simultaneous TX capability or a constraint based a power imbalance, a total power, an interference, a guard band, a spatial constraint, or a timing alignment being satisfied).

The following may apply to embodiment A-2-2-a and/or A-2-2-b:

Regarding power imbalance and total power constraints, in some embodiments, a TX power for an IAB-MT TX may be determined by signaling from a parent node or by a configuration. A minimum DL TX power may also be determined based on a configuration, a minimum requirement for coverage, and so forth. Then, given a power imbalance threshold and/or a total power threshold, the IAB-DU may determine whether to indicate DL on the TOL symbol based on the IAB-MT TX power and the minimum DL TX power.

In various embodiments, an SFI by an IAB-DU may take a lower priority than, or may be overridden by, the SFI for an IAB-MT. In certain embodiments, an SFI for an IAB-MT may take a lower priority than, or may be overridden by, the SFI by an IAB-DU. In some embodiments, a priority between SFI messages may be determined by a separate signaling or configuration or, alternatively, by a field in the SFI messages.

In some embodiments, a priority between SFI messages may be determined based on a chronology: 1) in one embodiment, a first SFI transmitted or received earlier takes a higher priority and a second SFI transmitted or received later takes a lower priority—in one example, the transmitted or received is with respect to a given IAB-node; 2) in another embodiment, if a first SFI is received from a parent node, but a second SFI is transmitted to a child node prior to the end of a decoding time for decoding the first SFI or prior to an end of a time duration and/or offset from the first and/or last symbol of a control resource set (“CORESET”) and/or PDCCH carrying the first SFI, then the second SFI takes a higher priority; and/or 3) in yet another embodiment, a second SFI transmitted or received later takes a higher priority than (e.g., overrides) a first SFI transmitted or received earlier. In one example, the transmitted or received is with respect to a given IAB-node.

In various embodiments, resources indicated by a signaling with a higher priority may be used unconditionally for scheduled communications, periodic communications, semi-persistent communications, or aperiodic communications, and so forth, while resources indicated by a signaling with a lower priority may be used if one or more of the aforementioned conditions (e.g., capability, power, interference, spatial, timing, etc.) are satisfied.

In certain embodiments, a first SFI for an IAB-MT may take a higher priority than a second SFI by the IAB-DU. In such embodiments, a symbol indicated UL by the first SFI may be used for a UL transmission unconditionally, while a TOL symbol indicated DL by the second SFI may be used for a DL transmission if a condition based on a power imbalance, a total power, an interference, a spatial constraint, or the like is satisfied.

In various embodiments, a dynamic control signaling such as a DCI message or a MAC message to a child node may be used to inform the child node of whether to expect a DL transmission from the IAB-DU on the symbol. This signaling may help the child node to make decisions on its own resource management (e.g., if the child node is only capable of TDM).

Inversely, in certain embodiments, a first SFI by an IAB-DU may take a higher priority than a second SFI for an IAB-MT. In such embodiments, a symbol indicated DL by the first SFI may be used for a DL transmission unconditionally, while a TOL symbol indicated UL by the second SFI may be used for a UL transmission if a condition based on a power imbalance, a total power, an interference, a spatial constraint, or the like is satisfied.

In some embodiments, a dynamic control signaling such as an UCI message or a MAC message to a parent node may be used to inform the parent node of whether the symbol will be available, whether a UL transmission by an IAB-MT will be omitted or canceled, whether a condition such as a power or interference condition is not being satisfied, and so forth.

In various embodiments, a symbol indicated DL for a child node served by an IAB-DU may already be scheduled for a DL TX such as a PDSCH. In such embodiments, an L1 and/or L2 control signaling may be used to indicate to the parent node to reject the SFI. In one realization, a control message may reject the SFI message. In an alternative realization, a control message may include a bitmap or a similar structure as the SFI message indicating which resources may or may not be available as indicated by the SFI. A control message acknowledging that an SFI or a part of an SFI may be accepted by a receiving node and may be called an SFI-ACK message. Transmitting an SFI-ACK message may be optional (e.g., only if the associated SFI or part of the associated SFI is rejected) according to a specification, configuration, and/or control signaling.

In certain embodiments, if a TX timing alignment scheme, such as a Case-6 timing alignment, is to be applied (FDM), a resource configuration or signaling with a higher priority may determine a timing of an associated transmission, while a transmission associated with a lower-priority resource configuration or signaling may follow the determined timing.

For example, if a symbol indicated UL for the IAB-MT has a higher priority than a TOL symbol indicated DL by the IAB-DU, then an UL transmission by the IAB-MT on the symbol may determine the timing (e.g., as indicated by a parent node serving the IAB-MT), while the IAB-DU aligns its DL transmission on the TOL symbol with the UL transmission according to a TX (Case-6) timing alignment scheme. Such embodiments may not follow a Case-1 timing alignment.

Inversely, in some embodiments, if a symbol indicated UL for an IAB-MT has a lower priority than a TOL symbol indicated DL by an IAB-DU, then a DL transmission by the IAB-DU on the symbol may determine the timing (e.g., as indicated by a parent node according to a Case-1 timing alignment), while the IAB-MT aligns its UL transmission on the TOL symbol with the DL transmission according to a TX (Case-6) timing alignment scheme.

In various embodiments, a DL TX follows a Case-1 timing alignment while a TX timing alignment scheme such as a Case-6 TX timing alignment is to be applied (FDM). In such embodiments, simultaneous transmissions occur only if the TX (Case-6) timing alignment can be performed (e.g., if the timing of DL TX and UL TX can be aligned). Otherwise, one of the transmissions such as a transmission with a higher priority is performed while the other transmission is omitted, canceled, or not scheduled. Particularly, in certain embodiments, a TOL symbol may not be indicated DL as it may otherwise not allow a Case-1 and Case-6 timing alignment simultaneously.

In embodiments A-2-4 and A-4-2: embodiment A-2-4 may be similar to embodiment A-2-2, except that an SFI by an IAB-DU may be replaced by a DCI scheduling a PDSCH for a child node by the IAB-DU; and an SFI-ACK method as described for embodiment A-2-2 may be used in embodiment A-2-4 if a PDSCH scheduled by an IAB-DU may take a higher priority than an SFI received by an IAB-MT and if a simultaneous transmission may not be accommodated due to a lack of capability or due to a constraint (e.g., power, interference, guard band, spatial, timing, etc.) not being satisfied. The priority may be determined by a specification, a configuration, or a control signaling. In some embodiments, a priority may be determined according to a chronology: 1) in an embodiment, if an IAB node receives an SFI from a parent node, wherein the SFI conflicts with a PDSCH that the IAB node has scheduled prior to receiving the SFI, then the IAB node may send an SFI-ACK rejecting the SFI or a part of the SFI to the parent node—in some examples, the SFI-ACK may include a recommended SFI; 2) in another embodiment, if an IAB node receives an SFI from a parent node, and if the IAB nodes transmits a DCI scheduling a PDSCH on resources conflicting with the SFI, and if the DCI is transmitted prior to a decoding time associated with a decoding of the SFI or prior to an end of a time duration and/or offset from the first and/or last symbol of the CORESET and/or PDCCH carrying the SFI, then the IAB node may send an SFI-ACK rejecting the SFI or a part of the SFI to the parent node; and/or 3) in yet another embodiment, if an IAB node receives an SFI from a parent node, wherein the SFI conflicts with a PDSCH that the IAB node has scheduled prior to receiving the SFI, then the SFI may override the PDSCH schedule or the IAB node may omit or cancel transmitting a signal on all or a part of the PDSCH.

Moreover, embodiment A-4-2 is similar to embodiment A-2-2 except that an SFI for an IAB-MT is replaced by a DCI scheduling a PUSCH by a parent node for the IAB-MT.

In certain embodiments, an L1 and/or L2 control message may be employed in embodiment A-4-2 if a PUSCH schedule received by an IAB-MT takes a higher priority than an SFI sent by an IAB-DU and if a simultaneous transmission may not be accommodated due to a lack of capability or due to a constraint (e.g., power, interference, guard band, spatial, timing, etc.) not being satisfied. The priority may be determined by a specification, a configuration, or a control signaling. In some embodiments, priority may be determined according to a chronology: 1) in an embodiment, if an IAB node receives a DCI scheduling a PUSCH from a parent node, wherein the PUSCH conflicts with an SFI that the IAB node has transmitted prior to receiving the DCI, then the IAB node may transmit a control message rejecting the PUSCH schedule or a part of the PUSCH schedule to the parent node; 2) in another embodiment, if an IAB node receives a DCI scheduling a PUSCH from a parent node, and if the IAB node transmits an SFI for resources conflicting with the PUSCH, and if the SFI is transmitted prior to a decoding time associated with a decoding of the DCI, then the IAB node may send a control message rejecting the PUSCH schedule or a part of the PUSCH schedule to the parent node; and/or 3) in yet another embodiment, if an IAB node receives a DCI scheduling a PUSCH from a parent node, wherein the PUSCH schedule conflicts with an SFI that the IAB node has transmitted prior to receiving the DCI, then the PUSCH schedule may override the SFI or the IAB node may omit or cancel transmitting a signal on all or a part of the resources indicated DL by the SFI.

In an embodiment A-1-3, if an IAB-MT is configured UL on a symbol, an IAB-DU may be configured a PDCCH or a DL-RS on a TOL symbol in accordance with an SDM and/or FDM scheme provided that one or more conditions hold (e.g., the IAB node has a simultaneous TX capability or a constraint based on a guard band or a timing alignment being satisfied).

In some embodiments, an IAB node is configured UL on a symbol by a first configuration, while a child node served by an IAB-DU is configured a PDCCH or a DL-RS on a TOL symbol by a second configuration. The first configuration may include a TDD-UL-DL-ConfigCommon, a TDD-UL-DL-ConfigDedicated, and/or a TDD-UL-DL-ConfigDedicated2-r17. The second configuration may include a PDCCH-ConfigCommon, a PDCCH-ServingCellConfig, a PDCCH-Config, and so forth. An alternative to a PDCCH is a downlink reference signal (DL-RS) such as a CSI-RS, a primary synchronization signal (“PSS”), a secondary synchronization signal (“SSS”), or an SS/PBCH block. Then, the second configuration may include a CSI-ResourceConfig, a CSI-SSB-ResourceSet, and so forth.

In various embodiments, a second configuration may take a lower priority than, or may be overridden by, a first configuration. In certain embodiments, a first configuration may take a lower priority than, or may be overridden by, a second configuration. In some embodiments, a priority between a first configuration and a second configuration may be determined by a separate signaling or configuration or, alternatively, by a field in the first configuration or the second configuration.

In various embodiments, resources configured by a configuration with a higher priority may be used unconditionally, while resources configured by a configuration with a lower priority may be used if one or more conditions are satisfied. Examples of the conditions may be a power imbalance constraint, a total power constraint, an interference constraint, and/or a spatial constraint.

In certain embodiments, a first resource configuration (e.g., including a ConfigCommon and a ConfigDedicated) for an IAB-MT may take a higher priority than a second configuration for a PDCCH or DL-RS for a child node served by an IAB-DU. In such embodiments, a symbol configured UL by the first configuration may be used for an UL transmission unconditionally, while a TOL symbol configured DL by the second configuration may be used for a PDCCH and/or DL-RS transmission if a condition based on a power imbalance, a total power, an interference, a spatial constraint, or the like is satisfied.

In some embodiments, a dynamic control signaling such as a DCI message or a MAC message sent to a child node served by an IAB-DU may be used to inform the child node of whether to expect a PDCCH or DL-RS on a symbol. In one embodiment, an IAB-DU may determine whether to trigger an aperiodic CSI-RS (or other DL-RS) or activate and/or deactivate a semi-persistent CSI-RS (or other DL-RS) based on a condition.

Inversely, in various embodiments, a first resource configuration (e.g., including a ConfigCommon and a ConfigDedicated) for an IAB-MT may take a lower priority than a second configuration for a PDCCH or DL-RS for a child node served by an IAB-DU. In such embodiments, a symbol configured DL by the second configuration may be used for a PDCCH and/or DL-RS transmission unconditionally, while a TOL symbol configured UL by the first configuration may be used for a UL transmission if a condition based on a power imbalance, a total power, an interference, a spatial constraint, or the like is satisfied.

In certain embodiments, a dynamic control signaling such as a UCI message or a MAC message to a parent node may be used to inform the parent node of whether the symbol will be available, whether an UL transmission by an IAB-MT will be omitted or canceled, whether a condition such as a power or interference condition is not being satisfied, and so forth.

In some embodiments, if a TX timing alignment scheme such as a Case-6 timing alignment is to be applied (FDM), a configuration with a higher priority may determine a timing of an associated transmission, while a transmission associated with a lower-priority configuration may follow the determined timing. For example, if a symbol configured UL for an IAB-MT has a higher priority than a TOL symbol configured for a PDCCH and/or DL-RS for a child node served by the IAB-DU, then an UL transmission by the IAB-MT on the symbol may determine the timing (e.g., as indicated by a parent node serving the IAB-MT), while the IAB-DU aligns its PDCCH and/or DL-RS transmission on the TOL symbol with the UL transmission according to a TX (Case-6) timing alignment scheme. It should be noted that this embodiment may not follow a Case-1 timing alignment.

Inversely, in various embodiments, if a symbol configured UL for an IAB-MT has a lower priority than a TOL symbol configured for a PDCCH and/or DL-RS for a child node served by an IAB-DU, then the PDCCH and/or DL-RS transmission by the IAB-DU on the symbol may determine the timing (e.g., as indicated by a parent node according to a Case-1 timing alignment), while the IAB-MT aligns its UL transmission on the TOL symbol with the DL transmission according to a TX (Case-6) timing alignment scheme.

In certain embodiments, a PDCCH and/or DL-RS transmission follows a Case-1 timing alignment while a TX timing alignment scheme such as a Case-6 TX timing alignment is to be applied (FDM). In such embodiments, simultaneous transmissions occur only if a TX (Case-6) timing alignment can be performed (e.g., if the timing of DL TX and UL TX can be aligned). Otherwise, one of the transmissions such as a transmission with a higher priority is performed while the other transmission is omitted, canceled, or not scheduled.

In an embodiment A-3-1, if an IAB-DU is configured DL on a symbol, an IAB-MT may be configured with a physical uplink control channel (“PUCCH”) or a UL-RS on a TOL symbol in accordance with an SDM and/or FDM scheme provided that one or more conditions hold (e.g., the IAB node has a simultaneous TX capability or a constraint based on a guard band or a timing alignment being satisfied).

In some embodiments, an IAB node is configured DL on a symbol by a first configuration, while the IAB node is also configured with a PUCCH or a UL-RS on a TOL symbol by a second configuration. The first configuration may include a TDD-UL-DL-ConfigCommon, a TDD-UL-DL-ConfigDedicated, and/or a TDD-UL-DL-ConfigDedicated2-r17. The second configuration may include a PUCCH-ConfigCommon, a PUCCH-Config, and so forth. An alternative to a PUCCH is an uplink reference signal (“UL-RS”) such as an SRS. Then, the second configuration may include an SRS-Config, an SRS-ResourceSet, SRS-Resource, and so forth.

In various embodiments, a second configuration may take a lower priority than, or may be overridden by, a first configuration. In certain embodiments, a first configuration may take a lower priority than, or may be overridden by, a second configuration. In some embodiments, a priority between a first configuration and a second configuration may be determined by a separate signaling or configuration or, alternatively, by a field in the first configuration or the second configuration.

In certain embodiments, resources configured by a configuration with a higher priority may be used unconditionally, while resources configured by a configuration with a lower priority may be used if one or more conditions are satisfied. Examples of conditions may include a power imbalance constraint, a total power constraint, an interference constraint, and/or a spatial constraint.

In some embodiments, a first resource configuration for a PUCCH or UL-RS for an IAB-MT may take a higher priority than a second configuration (e.g., including a ConfigCommon and a ConfigDedicated) for a child node served by an IAB-DU. In such embodiments, a symbol configured UL by the first configuration may be used for the PUCCH and/or UL-RS transmission unconditionally, while a TOL symbol configured DL by the second configuration may be used for DL transmission if a condition based on a power imbalance, a total power, an interference, a spatial constraint, or the like is satisfied.

In various embodiments, a dynamic control signaling such as a DCI message or a MAC message sent to a child node served by an IAB-DU may be used to inform the child node of whether to expect a DL transmission from the IAB-DU on the symbol.

Inversely, in certain embodiments, a first resource configuration for a PUCCH or UL-RS for an IAB-MT may take a lower priority than a second configuration (e.g., including a ConfigCommon and a ConfigDedicated) for a child node served by an IAB-DU. In such embodiments, a symbol configured DL by the second configuration may be used for a DL transmission unconditionally, while a TOL symbol configured UL by the first configuration may be used for the PUCCH and/or UL-RS transmission if a condition based on a power imbalance, a total power, an interference, a spatial constraint, or the like is satisfied.

In some embodiments, a dynamic control signaling such as a UCI message or a MAC message sent to a parent node may be used to inform the parent node of whether the symbol will be available, whether the PUCCH and/or UL-RS transmission by an IAB-MT will be omitted or canceled, whether a condition such as a power or interference condition is not being satisfied, and so forth.

In various embodiments, if a TX timing alignment scheme such as a Case-6 timing alignment is to be applied (FDM), a configuration with a higher priority may determine a timing of an associated transmission, while a transmission associated with a lower-priority configuration may follow the determined timing. For example, if a symbol configured DL for a child node served by the IAB-DU has a higher priority than a TOL symbol configured for a PUCCH and/or UL-RS for the IAB-MT, then a DL transmission by the IAB-DU on the symbol may determine the timing (e.g., as indicated by a parent node according to a Case-1 timing alignment), while the IAB-MT aligns its PUCCH and/or UL-RS transmission on the TOL symbol with the DL transmission according to a TX (Case-6) timing alignment scheme.

Inversely, in certain embodiments, if a symbol configured DL for a child node served by an IAB-DU has a lower priority than a TOL symbol configured for a PUCCH and/or UL-RS for an IAB-MT, then the PUCCH and/or UL-RS transmission by the IAB-MT on the symbol may determine the timing (e.g., as indicated by a parent node serving the IAB-MT), while the IAB-DU aligns its DL transmission on the TOL symbol with the PUCCH and/or UL-RS transmission according to a TX (Case-6) timing alignment scheme. Such embodiments may not follow a Case-1 timing alignment.

In some embodiments, a DL TX follows a Case-1 timing alignment while a TX timing alignment scheme such as a Case-6 TX timing alignment is applied (FDM). In such embodiments, simultaneous transmissions occur only if the TX (Case-6) timing alignment can be performed (e.g., if the timing of DL TX and UL TX can be aligned). Otherwise, one of the transmissions such as a transmission with a higher priority is performed while the other transmission is omitted, canceled, or not scheduled.

In an embodiment A-3-3, if an IAB-MT is configured with a PUCCH and/or UL-RS on a symbol, an IAB-DU may be configured with a PDCCH and/or DL-RS on a TOL symbol in accordance with an SDM and/or FDM scheme provided that one or more conditions hold (e.g., the IAB node has a simultaneous TX capability or a constraint based on a guard band or a timing alignment being satisfied).

In various embodiments, an IAB node is configured with a PUCCH and/or UL-RS on a symbol by a first configuration, while a child node served by an IAB-DU is configured with a PDCCH and/or DL-RS on a TOL symbol by a second configuration. For a PUCCH, the first configuration may include a PUCCH-ConfigCommon, a PUCCH-Config, and so forth. For an UL-RS such as an SRS, the first configuration may include an SRS-Config, an SRS-ResourceSet, an SRS-Resource, and so forth. For a PDCCH, the second configuration may include a PDCCH-ConfigCommon, a PDCCH-ServingCellConfig, a PDCCH-Config, and so forth. For a DL-RS such as a CSI-RS or an SS/PBCH block, the second configuration may include a CSI-ResourceConfig, a CSI-SSB-ResourceSet, and so forth.

In certain embodiments, a second configuration may take a lower priority than, or may be overridden by, a first configuration. In some embodiments, a first configuration may take a lower priority than, or may be overridden by, a second configuration. In various embodiments, a priority between a first configuration and a second configuration may be determined by a separate signaling or configuration or, alternatively, by a field in the first configuration or the second configuration.

In some embodiments, resources configured by a configuration with a higher priority may be used unconditionally, while resources configured by a configuration with a lower priority may be used if one or more conditions are satisfied. Examples of the conditions may include a power imbalance constraint, a total power constraint, an interference constraint, and/or a spatial constraint.

In various embodiments, a first configuration for an IAB-MT may take a higher priority than a second configuration for a child node served by an IAB-DU. In such embodiments, a symbol configured UL by the first configuration may be used for an UL transmission unconditionally, while a TOL symbol configured DL by the second configuration may be used for a DL transmission if a condition based on a power imbalance, a total power, an interference, a spatial constraint, or the like is satisfied.

In certain embodiments, a dynamic control signaling such as a DCI message or a MAC message sent to a child node served by an IAB-DU may be used to inform the child node of whether the TOL symbol will be used as DL. In an embodiment, the IAB-DU may transmit a control message to the child node informing the child node of whether to expect a PDCCH and/or DL-RS transmission on the TOL symbol. In another embodiment, if a DL-RS transmission is omitted, the IAB-DU neglects a corresponding CSI report from the child node. In yet another embodiment, the IAB-DU may transmit a control message to the child node after the TOL symbol, wherein the control message informs the child node to neglect the TOL symbol or the TOL symbol was interrupted or preempted. This signaling may allow the child node to avoid attempting to decode a PDCCH that was not transmitted or make a decision, such as adjusting a spatial filter associated with a CSI-RS resource indicator (“CRI”), based on a measurement on a DL-RS that was not transmitted.

Inversely, in some embodiments, a first configuration for the IAB-MT may take a lower priority than a second configuration for a child node served by the IAB-DU. In such embodiments, a symbol configured DL by the second configuration may be used for a DL transmission unconditionally, while a TOL symbol configured UL by the first configuration may be used for an UL transmission if a condition based on a power imbalance, a total power, an interference, a spatial constraint, or the like is satisfied.

In various embodiments, a dynamic control signaling such as a UCI message or a MAC message sent to a parent node may be used to inform the parent node of whether the TOL symbol will be used as UL, whether a PUCCH and/or UL-RS transmission by an IAB-MT will be omitted, canceled, or truncated, whether a condition such as a power or interference condition is not being satisfied, and so forth.

In certain embodiments, an IAB node is not expected to be configured with a PUCCH and/or a UL-RS on a symbol and a PDCCH and/or DL-RS on a TOL symbol. In some embodiments, an IAB node is expected to be configured with a PUCCH and/or UL-RS on a symbol and a PDCCH and/or DL-RS on a TOL symbol only if it is capable of performing enhanced duplexing and the IAB node indicates to the IAB-CU (or any other entity configuring the IAB node) that it is capable of SDM or multi-panel communication.

In some embodiments, if a TX timing alignment scheme such as a Case-6 timing alignment is to be applied (FDM), a configuration with a higher priority may determine a timing of an associated transmission, while a transmission associated with a lower-priority configuration may follow the determined timing. For example, if a symbol configured UL for the IAB-MT has a higher priority than a TOL symbol configured DL for a child node served by the IAB-DU, then a PUCCH and/or UL-RS transmission by the IAB-MT on the symbol may determine the timing, (e.g., as indicated by a parent node serving the IAB-MT), while the IAB-DU aligns its PDCCH and/or DL-RS transmission on the TOL symbol with the PUCCH and/or UL-RS transmission according to a TX (Case-6) timing alignment scheme. Such embodiments may not follow a Case-1 timing alignment.

Inversely, in various embodiments, if a symbol configured UL for an IAB-MT has a lower priority than a TOL symbol configured DL for a child node served by an IAB-DU, then a PDCCH and/or DL-RS transmission by the IAB-DU on the symbol may determine the timing (e.g., as indicated by a parent node according to a Case-1 timing alignment), while the IAB-MT aligns its PUCCH and/or UL-RS transmission on the TOL symbol with the PDCCH and/or DL-RS transmission according to a TX (Case-6) timing alignment scheme.

In certain embodiments, a PDCCH and/or DL-RS follows a Case-1 timing alignment while a TX timing alignment scheme such as a Case-6 TX timing alignment is to be applied (FDM). In such embodiments, simultaneous transmissions occur only if the TX (Case-6) timing alignment can be performed (e.g., if the timing of PDCCH and/or DL-RS transmission and PUCCH and/or UL-RS transmission can be aligned). Otherwise, one of the transmissions such as a transmission with a higher priority is performed while the other transmission is omitted, canceled, or not scheduled.

In an embodiment A-1-4, if an IAB-MT is configured UL on a symbol, an IAB-DU may schedule a PDSCH on a TOL symbol for a child node in accordance with an SDM and/or FDM scheme provided that one or more conditions hold (e.g., the IAB node has a simultaneous TX capability or a constraint based a power imbalance, a total power, an interference, a guard band, a spatial constraint, and/or a timing alignment being satisfied).

In some embodiments, regarding power imbalance and total power constraints, a TX power for an IAB-MT TX may be determined by signaling from a parent node or by a configuration. A minimum DL TX power may also be determined based on a configuration, a minimum requirement for coverage, and so forth. Then, given a power imbalance threshold and/or a total power threshold, the IAB-DU may determine whether to schedule a PDSCH on the TOL symbol based on the IAB-MT TX power and the minimum DL TX power.

In various embodiments, an IAB node is configured UL on a symbol by a resource configuration, which may include a TDD-UL-DL-ConfigCommon, a TDD-UL-DL-ConfigDedicated, and/or a TDD-UL-DL-ConfigDedicated2-r17.

In certain embodiments, DCI scheduling a PDSCH may take a lower priority than, or may be overridden by, a resource configuration for an IAB-MT. In some embodiments, a resource configuration for an IAB-MT may take a lower priority than, or may be overridden by, DCI scheduling a PDSCH. In various embodiments, a priority between a resource configuration and DCI scheduling a PDSCH may be determined by a separate signaling or configuration or, alternatively, by a field in the resource configuration or the DCI.

In some embodiments, resources configured and/or scheduled by a configuration or signaling with a higher priority may be used unconditionally, while resources configured and/or scheduled by a configuration or signaling with a lower priority may be used if one or more of the aforementioned conditions (e.g., capability, power, interference, spatial, timing, etc.) are satisfied.

In various embodiments, a resource configuration (e.g., including a ConfigCommon and a ConfigDedicated) for an IAB-MT may take a higher priority than a DCI scheduling a PDSCH. In such embodiments, a symbol configured UL by the resource configuration may be used for a UL transmission unconditionally, while a TOL symbol scheduled DL may be used for a DL transmission if a condition based on a power imbalance, a total power, an interference, a spatial constraint, or the like is satisfied.

Inversely, in certain embodiments, a DCI scheduling a PDSCH may take a higher priority than a resource configuration (e.g., including a ConfigCommon and a ConfigDedicated) for an IAB-MT. In such embodiments, a symbol scheduled DL may be used for a DL transmission unconditionally, while a TOL symbol configured UL by the resource configuration may be used for a UL transmission if a condition based on a power imbalance, a total power, an interference, a spatial constraint, or the like is satisfied.

In some embodiments, a dynamic control signaling such as a UCI message or a MAC message sent to a parent node may be used to inform the parent node of whether the symbol will be available, whether an UL transmission by an IAB-MT will be omitted or canceled, whether a condition such as a power or interference condition is not being satisfied, and so forth.

In various embodiments, if a TX timing alignment scheme such as a Case-6 timing alignment is to be applied (FDM), a resource configuration or signaling with a higher priority may determine a timing of an associated transmission, while a transmission associated with a lower-priority resource configuration or signaling may follow the determined timing. For example, if a symbol configured UL for the IAB-MT has a higher priority than a TOL symbol scheduled DL by the IAB-DU, then an UL transmission by the IAB-MT on the symbol may determine the timing (e.g., as indicated by a parent node serving the IAB-MT), while the IAB-DU aligns its DL transmission on the TOL symbol with the UL transmission according to a TX (Case-6) timing alignment scheme. Such embodiments may not follow a Case-1 timing alignment.

Inversely, in certain embodiments, if a symbol configured UL for an IAB-MT has a lower priority than a TOL symbol scheduled DL by an IAB-DU, then a DL transmission by the IAB-DU on the symbol may determine the timing (e.g., as indicated by a parent node according to a Case-1 timing alignment), while the IAB-MT aligns its UL transmission on the TOL symbol with the DL transmission according to a TX (Case-6) timing alignment scheme.

In some embodiments, a DL TX follows a Case-1 timing alignment while a TX timing alignment scheme such as a Case-6 TX timing alignment is to be applied (FDM). In such embodiments, simultaneous transmissions occur only if the TX (Case-6) timing alignment can be performed (e.g., if the timing of DL TX and UL TX can be aligned). Otherwise, one of the transmissions such as a transmission with a higher priority is performed while the other transmission is omitted, canceled, or not scheduled. Particularly, in various embodiments, the TOL symbol may not be scheduled DL as it may otherwise not allow a Case-1 and Case-6 timing alignment simultaneously.

In an embodiment A-4-1, if an IAB-DU is configured DL on a symbol, an IAB-MT may be scheduled a PUSCH on a TOL symbol by a parent node in accordance with an SDM and/or FDM scheme provided that one or more conditions hold (e.g., the IAB node has a simultaneous TX capability or a constraint based on a power imbalance, a total power, an interference, a guard band, a spatial constraint, or a timing alignment being satisfied).

In various embodiments, regarding power imbalance and total power constraints, a TX power for an IAB-MT TX may be determined by signaling from a parent node or by a configuration. A minimum DL TX power may also be determined based on a configuration, a minimum requirement for coverage, and so forth. Then, given a power imbalance threshold and/or a total power threshold, a parent node serving the IAB-MT may determine whether to schedule a PUSCH on the TOL symbol based on the IAB-MT TX power and the minimum DL TX power. To realize such embodiments, the parent node may be informed of an IAB-MT's TX power constraint through a control signaling from the IAB-MT.

In certain embodiments, a child node served by an IAB node may be configured DL on a symbol by a resource configuration, which may include a TDD-UL-DL-ConfigCommon, a TDD-UL-DL-ConfigDedicated, and/or a TDD-UL-DL-ConfigDedicated2-r17.

In some embodiments, DCI scheduling a PUSCH for an IAB-MT may take a lower priority than, or may be overridden by, a resource configuration for a child node served by an IAB-DU. In various embodiments, a resource configuration for a child node served by an IAB-DU may take a lower priority than, or may be overridden by, DCI scheduling a PUSCH for the IAB-MT. In certain embodiments, a priority between a resource configuration and DCI scheduling a PUSCH may be determined by a separate signaling or configuration or, alternatively, by a field in the resource configuration or the DCI.

In certain embodiments, resources configured and/or scheduled by a configuration or signaling with a higher priority may be used unconditionally, while resources configured and/or scheduled by a configuration or signaling with a lower priority may be used if one or more of the aforementioned conditions (e.g., capability, power, interference, spatial, timing, etc.) are satisfied.

In some embodiments, a resource configuration (e.g., including a ConfigCommon and a ConfigDedicated) for a child node served by an IAB-DU may take a higher priority than a DCI scheduling a PUSCH. In such embodiments, a symbol configured DL by the resource configuration may be used for a DL transmission unconditionally, while a TOL symbol scheduled UL may be used for an UL transmission if a condition based on a power imbalance, a total power, an interference, a spatial constraint, or the like is satisfied.

In various embodiments, a dynamic control signaling such as an UCI message or a MAC message sent to a parent node may be used to inform the parent node of whether the symbol will be available, whether an UL transmission by an IAB-MT will be omitted or canceled, whether a condition such as a power or interference condition is not being satisfied, and so forth.

Inversely, in certain embodiments, a DCI scheduling a PUSCH may take a higher priority than a resource configuration (e.g., including a ConfigCommon and a ConfigDedicated) for a child node served by an IAB-DU. In such embodiments, a symbol scheduled UL may be used for an UL transmission unconditionally, while a TOL symbol configured DL by the resource configuration may be used for a DL transmission if a condition based on a power imbalance, a total power, an interference, a spatial constraint, or the like is satisfied.

In some embodiments, a dynamic control signaling such as a DCI message or a MAC message sent to a child node may be used to inform the child node of whether the TOL symbol will be available. This signaling may help the child node to make decisions regarding its own resource management (e.g., if the child node is only capable of TDM).

In various embodiments, if a TX timing alignment scheme such as a Case-6 timing alignment is to be applied (FDM), a resource configuration or signaling with a higher priority may determine a timing of an associated transmission, while a transmission associated with a lower-priority resource configuration or signaling may follow the determined timing. For example, if a symbol configured DL for a child node served by an IAB-DU has a higher priority than a TOL symbol scheduled UL by the parent node, then a DL transmission by the IAB-DU on the symbol may determine the timing (e.g., as indicated by a parent node according to a Case-1 timing alignment), while an IAB-MT aligns its UL transmission on the TOL symbol with the DL transmission according to a TX (Case-6) timing alignment scheme.

Inversely, in certain embodiments, if a symbol configured DL for a child node served by an IAB-DU has a lower priority than a TOL symbol scheduled UL by a parent node, then an UL transmission by an IAB-MT on the symbol may determine the timing (e.g., as indicated by a parent node), while the IAB-DU aligns its DL transmission on the TOL symbol with the UL transmission according to a TX (Case-6) timing alignment scheme. Such embodiments may not follow a Case-1 timing alignment.

In some embodiments, a DL TX follows a Case-1 timing alignment while a TX timing alignment scheme such as a Case-6 TX timing alignment is to be applied (FDM). In such embodiments, simultaneous transmissions occur only if the TX (Case-6) timing alignment can be performed (e.g., if the timing of DL TX and UL TX can be aligned). Otherwise, one of the transmissions such as a transmission with a higher priority is performed while the other transmission is omitted, canceled, or not scheduled. Particularly, in such embodiments, the TOL symbol may not be scheduled UL as it may otherwise not allow a Case-1 and Case-6 timing alignment simultaneously.

In embodiments A-3-4 and A-4-3: an embodiment A-3-4 is similar to embodiment A-1-4 except that a resource configuration for an IAB-MT is replaced by a configuration for a PUCCH or a UL-RS such as an SRS; and an embodiment A-4-3 is similar to embodiment A-4-1 except that a resource configuration for an IAB-DU is replaced by a configuration for a PDCCH or a DL-RS such as a CSI-RS.

In an embodiment A-4-4, there may be an embodiments A-4-4a and/or an embodiment A-4-4-b. In embodiment A-4-4-a there may be PUSCH scheduled prior to PDSCH: if an IAB-MT is scheduled with a PUSCH on a symbol by a parent node, an IAB-DU may schedule a PDSCH for a child node or a UE on a TOL symbol in accordance with an SDM and/or FDM scheme provided that one or more conditions hold (e.g., the IAB node has a simultaneous TX capability or a constraint based on a power imbalance, a total power, an interference, a guard band, a spatial constraint, and/or a timing alignment is satisfied). Furthermore, to realize the simultaneous transmissions, a value of K2 may need to be larger than or equal to K0 plus a time required to process a DCI from the parent node that schedules the PUSCH or indicates a parameter such as a TCI state for the PUSCH or PUSCH preparation time or generally a time-offset. The time required to process the DCI may be determined by an IAB node capability or by the standard.

In embodiment A-4-4-b: PDSCH may be scheduled prior to PUSCH: if an IAB-DU schedules a PDSCH on a symbol for a child node or a UE, a parent node may schedule a PUSCH for an IAB-MT on a TOL symbol in accordance with an SDM and/or FDM scheme provided that one or more conditions hold (e.g., the IAB node has a simultaneous TX capability or a constraint based on a power imbalance, a total power, an interference, a guard band, a spatial constraint, and/or a timing alignment being satisfied). Furthermore, to realize simultaneous transmissions, the value of K0 may need to be larger than or equal to K2 plus a time required to process a DCI from the parent node that schedules the PDSCH or indicates a parameter such as a TCI state for the PDSCH or a time duration and/or offset. The time required to process the DCI may be determined by an IAB node capability or by a standard.

In embodiments A-4-5 and A-5-4, embodiment A-4-5 is similar to embodiment A-4-4-b except that an SPS is configured by an IAB-CU rather than a DCI scheduling a PDSCH—therefore, a condition between K0 and K2 is not applicable—in some embodiments, an L1/L2 control signaling may be used to inform a parent node whether a PUSCH may be scheduled on a symbol based on a determination by the IAB node of whether a DL TX is intended on a TOL symbol that is configured an SPS, and an embodiment A-5-4 is similar to Embodiment A-4-4-a is except that a UL TX is scheduled by a configured grant rather than a DCI scheduling a PUSCH—therefore, a condition between K0 and K2 is not applicable.

In various embodiments, an IAB node may schedule a PDSCH on a symbol based on a determination by the IAB node on whether a UL TX is intended on a TOL symbol that is on a configured grant (“CG”).

In embodiments A-1-5, A-5-1, A-3-5, A-5-3, and A-5-5, embodiments A-1-5, A-5-1, A-3-5, A-5-3, and A-5-5 may include elements from embodiments A-1-1 and A-3-3 as the resources available for both upstream and downstream links configured by an IAB-CU.

More details may be provided for configurations in which an IAB-MT is configured with a CG-PUSCH to a parent node, where in the CG-PUSCH may be of Type 1 (e.g., without activation by L1 and/or L2 control signaling) and Type 2 (e.g., for which L1 and/or L2 control signaling is used for activating and deactivating a CG-PUSCH).

Furthermore, elements of the embodiments described for scenarios A-2-5, A-5-2, A-4-5, and A-5-4 may be used where applicable to any of these five scenarios.

In a second set of embodiments for Case B (Case #2), Table 6 summarizes different combinations for simultaneous IAB-MT RX (DL) and IAB-DU RX (UL).

TABLE 6

| | IAB-DU | | | | |
|---|---|---|---|---|---|
| | configured UL | | | | |
| | by | | IAB-DU | | |
| | ConfigCommon | IAB-DU | configured | IAB-DU | IAB-DU |
| | or | indicated | PUCCH, | scheduling | configured |
| | ConfigDedicated | UL by SFI | UL-RS | PUSCH | CG-PUSCH |
| IAB-MT | B-1-1 | B-1-2 | B-1-3 | B-1-4 | B-1-5 |
| configured DL | | | | | |
| by | | | | | |
| ConfigCommon | | | | | |
| or | | | | | |
| ConfigDedicated | | | | | |
| IAB-MT | B-2-1 | B-2-2 | B-2-3 | B-2-4 | B-2-5 |
| indicated DL by | | | | | |
| SFI | | | | | |
| IAB-MT | B-3-1 | B-3-2 | B-3-3 | B-3-4 | B-3-5 |
| configured | | | | | |
| CORESET, DL- | | | | | |
| RS | | | | | |
| IAB-MT | B-4-1 | B-4-2 | B-4-3 | B-4-4 | B-4-5 |
| scheduled | | | | | |
| PDSCH | | | | | |
| IAB-MT | B-5-1 | B-5-2 | B-5-3 | B-5-4 | B-5-5 |
| configured SPS | | | | | |

In the second set of embodiments, references are made to the following recurring phrases: 1) simultaneous RX capability: this may refer to an IAB node's capability to perform simultaneous receptions, which may indicate that the IAB node is capable of SDM and/or FDM, the IAB node has multiple antenna panels (SDM), the IAB node is capable of simultaneous receptions in DL and UL, the IAB node is capable of enhanced duplexing, or the like—for configuration-based methods, information of the capability may be sent to an IAB-CU that configures the system—for methods based on control signaling, the information of the capability may be sent to another IAB node such as a parent node or a child node; 2) power imbalance constraint: this may refer to a constraint according to which the difference between RX powers for an IAB-MT RX and an IAB-DU RX is not larger than a threshold—the threshold may be determined by an IAB node capability that specifies a maximum power imbalance on one panel (FDM) or among multiple panels (SDM)—for configuration-based methods, a power imbalance constraint may be satisfied by semi-static configuration of TX powers—for methods based on control signaling, a TX power for a child node TX may be determined by an IAB-DU serving the child node—therefore, a power imbalance constraint may require a parent node to adjust a TX power for a parent node TX, if possible, or decline a transmission otherwise—alternatively, an IAB-DU may need to signal a child node to adjust its TX power to satisfy a power imbalance constraint while the RX power from a parent node serving an IAB-MT is determined or known by the IAB node; 3) interference constraint: this may refer to a variety of interference constraints between antennas of an IAB node (self-interference), interference on other nodes or channels or cells, and so forth—in some embodiments, according to an interference constraint, the interference by a child node on an IAB-MT RX may be below a threshold if the IAB-MT performs beamforming for receiving a signal from a parent node—in some embodiments, according to an interference constraint, the interference by a parent node on an IAB-DU RX should be below a threshold when the IAB-DU performs beamforming for receiving a signal from a child node; 4) guard band constraint: this may refer to a constraint according to which frequency resources (e.g., PRBs) allocated to the IAB-MT is separated from the frequency resources allocated to the IAB-DU by at least a threshold called a guard band—a value of the guard band may be determined by an IAB node capability for one panel (FDM) or among multiple panels (SDM)—for configuration-based methods, a resource may be allocated by a configuration—for methods based on control signaling, a resource may be allocated by control message such as an L1 and/or L2 message; 5) spatial constraint (FDM): this may refer to a constraint according to which a beam (spatial filter) for receiving a signal is constrained by a beam (spatial filter) for receiving another signal—a common case for this constraint is if one or more antenna panels are controlled by a same circuitry for controlling beamforming—if the one or more panels are beamformed to receive a first signal in a particular direction in the spatial domain, any second signal may be constrained to be received with a same beamforming configuration if the same one or multiple panels is to be used—whether a spatial constraint applies to an IAB node or an antenna panel of an IAB node may be determined by a capability of the IAB node, which may be communicated to an IAB-CU (e.g., for configuration-based methods) or another IAB node such as a parent node or a child node (e.g., for methods based on control signaling); and 6) timing alignment constraint (FDM): this constraint may be applicable if the antenna panel is connected to a baseband processor with one DFT and/or IDFT window—if the timing for an IAB-MT RX and an IAB-DU RX should be aligned at least at a symbol level—the timing alignment may correspond to a Case-7 timing scheme as specified by a standard, configured by a network, signaled by a parent node, and so forth.

In embodiment B-1-1, if an IAB-MT is configured DL on a symbol, an IAB-DU may be configured UL on a TOL symbol in accordance with an SDM and/or FDM scheme provided that one or more conditions hold (e.g., the IAB node has a simultaneous TX capability or a constraint based on a guard band or a timing alignment being satisfied).

In certain embodiments, an IAB node is configured DL on a symbol by a first configuration, while a child node served by the IAB-DU is configured UL on a TOL symbol by a second configuration. Each of the first configuration and the second configuration may include a TDD-UL-DL-ConfigCommon and/or a TDD-UL-DL-ConfigDedicated as defined for a legacy system.

In some embodiments, a first configuration may include a TDD-UL-DL-ConfigCommon and/or a TDD-UL-DL-ConfigDedicated as defined for a legacy system while a second configuration may include a new IE such as TDD-UL-DL-ConfigDedicated2-r17, abbreviated as ConfigDedicated2 herein. In various embodiments, ConfigDedicated2 has a similar structure as that of ConfigDedicated.

In various embodiments, a second configuration may take a lower priority than, or may be overridden by, a first configuration. In certain embodiments, a first configuration may take a lower priority than, or may be overridden by, a second configuration. In some embodiments, a priority between a first configuration and a second configuration may be determined by a separate signaling or configuration or, alternatively, by a field in the first configuration or the second configuration.

In various embodiments, resources configured by a configuration with a higher priority may be used unconditionally for scheduled communications, periodic, semi-persistent, or aperiodic communications, and so forth, while resources configured by a configuration with a lower priority may be used if one or more conditions are satisfied. Examples of conditions may include a power imbalance constraint, a total power constraint, an interference constraint, and/or a spatial constraint.

In certain embodiments, a first resource configuration (e.g., including a ConfigCommon and a ConfigDedicated) for an IAB-MT may take a higher priority than a second resource configuration (e.g., including a ConfigCommon and a ConfigDedicated2) for a child node served by an IAB-DU. A symbol configured DL by the first configuration may be used for a DL transmission unconditionally, while a TOL symbol configured UL by the second configuration may be used for a UL transmission if a condition based on a power imbalance, an interference, a spatial constraint, or the like is satisfied.

In some embodiments, a dynamic control signaling such as a DCI message or a MAC message sent to a child node served by the IAB-DU may be used to inform the child node of whether a TOL symbol will be used as UL.

Inversely, in various embodiments, a first resource configuration (e.g., including a ConfigCommon and a ConfigDedicated2) for an IAB-MT may take a lower priority than a second resource configuration (e.g., including a ConfigCommon and a ConfigDedicated) for a child node served by an IAB-DU. In such embodiments, a symbol configured UL by the second configuration may be used for an UL transmission unconditionally, while a TOL symbol configured DL by the first configuration may be used for a DL transmission if a condition based on a power imbalance, a total power, an interference, a spatial constraint, or the like is satisfied.

In certain embodiments, a dynamic control signaling such as a UCI message or a MAC message sent to a parent node may be used to inform the parent node of whether the TOL symbol will be used as DL, whether a DL transmission from the parent node will be omitted or canceled, whether a condition such as a power or interference condition is not being satisfied, and so forth.

In some embodiments, if an RX timing alignment scheme such as a Case-7 timing alignment is to be applied (FDM), a resource configuration with a higher priority may determine a timing of an associated reception, while a reception associated with a lower-priority resource configuration may follow the determined timing. For example, if a symbol configured DL for an IAB-MT has a higher priority than a TOL symbol configured UL for a child node served by an IAB-DU, then a DL reception by the IAB-MT on the symbol may determine the timing (e.g., as determined by a parent node serving the IAB-MT according to a Case-1 timing alignment and the propagation delay of the upstream link), while the IAB-DU aligns its DL reception on the TOL symbol with the DL reception according to an RX (Case-7) timing alignment scheme. In such embodiments, the IAB-DU may indicate a timing alignment to the child node according to the timing alignment scheme.

Inversely, in various embodiments, if a symbol configured DL for an IAB-MT has a lower priority than a TOL symbol configured UL for a child node served by an IAB-DU, then an UL reception from the child node on the symbol may determine the timing, while the IAB-MT aligns its DL reception on the TOL symbol with the UL reception according to an RX (Case-7) timing alignment scheme. Such embodiments may not follow a Case-1 timing alignment.

In certain embodiments, a DL TX by a parent node is determined by a Case-1 timing alignment, while an RX timing alignment scheme such as a Case-7 RX timing alignment is to be applied (FDM). In such embodiments, simultaneous receptions occur only if the RX (Case-7) timing alignment can be performed (e.g., if the timing of DL RX and UL RX can be aligned). Otherwise, one of the receptions such as a reception with a higher priority is performed while the other reception is omitted, canceled, or not scheduled.

In embodiment B-1-2, if an IAB-MT is configured DL on a symbol, an IAB-DU may indicate UL on a TOL symbol by an SFI to a child node in accordance with an SDM and/or FDM scheme provided that one or more conditions hold (e.g., the IAB node has a simultaneous RX capability or a constraint based on a power imbalance, an interference, a guard band, a spatial constraint, or a timing alignment being satisfied).

Regarding a power imbalance constraint, in some embodiments, an RX power for an IAB-MT RX may be determined by a DL TX power of a parent node and a pathloss of the upstream link. A minimum DL TX power of the parent node may be determined based on a configuration, a minimum requirement for coverage, and so forth. An RX power for an IAB-DU RX may be determined by a UL TX power of a child node and a pathloss of the downstream link. The UL TX power of the child node may be indicated by the serving IAB node, configured by the network, and so forth. Then, given a power imbalance threshold, the IAB-DU may determine whether to indicate UL on the TOL symbol based on the IAB-MT RX power and an expected IAB-DU RX power.

In various embodiments, an IAB node is configured DL on a symbol by a resource configuration, which may include a TDD-UL-DL-ConfigCommon, a TDD-UL-DL-ConfigDedicated, and/or a TDD-UL-DL-ConfigDedicated2-r17.

In certain embodiments, a SFI by an IAB-DU may take a lower priority than, or may be overridden by, a resource configuration for an IAB-MT. In some embodiments, resource configuration for an IAB-MT may take a lower priority than, or may be overridden by, a SFI by an IAB-DU. In various embodiments, a priority between a resource configuration and a SFI may be determined by a separate signaling or configuration or, alternatively, by a field in the resource configuration or the SFI.

In various embodiments, resources configured and/or indicated by a configuration or signaling with a higher priority may be used unconditionally for scheduled communications, periodic, semi-persistent, or aperiodic communications, and so forth, while resources configured and/or indicated by a configuration or signaling with a lower priority may be used if one or more of the aforementioned conditions (e.g., capability, power, interference, spatial, timing, etc.) are satisfied.

In certain embodiments, a resource configuration (e.g., including a ConfigCommon and a ConfigDedicated) for an IAB-MT may take a higher priority than an SFI by an IAB-DU. In such embodiments, a symbol configured DL by the resource configuration may be used for a DL reception unconditionally, while a TOL symbol indicated UL by the SFI may be used for a UL reception if a condition based on a power imbalance, a total power, an interference, a spatial constraint, or the like is satisfied.

Inversely, in some embodiments, an SFI by an IAB-DU may take a higher priority than a resource configuration (e.g., including a ConfigCommon and a ConfigDedicated) for an IAB-MT. In such embodiments, a symbol indicated UL by the SFI may be used for a UL reception unconditionally, while a TOL symbol configured DL by the resource configuration may be used for a DL reception if a condition based on a power imbalance, an interference, a spatial constraint, or the like is satisfied.

In various embodiments, a dynamic control signaling such as a UCI message or a MAC message sent to a parent node may be used to inform the parent node of whether the symbol will be available, whether a DL reception by the IAB-MT will be omitted or canceled, whether a condition such as a power or interference condition is not being satisfied, and so forth. In an embodiment, an IAB node may send an L1 and/or L2 control message containing a bitmap that indicates which resources are available. The interpretation of the L1 and/or L2 control message including a granularity of the resources in time and frequency domains may be determined by a specification or a configuration.

In certain embodiments, if an RX timing alignment scheme such as a Case-7 timing alignment is to be applied (FDM), a resource configuration or signaling with a higher priority may determine a timing of an associated reception, while a reception associated with a lower-priority resource configuration or signaling may follow the determined timing. For example, if a symbol configured DL for an IAB-MT has a higher priority than a TOL symbol indicated UL by the IAB-DU, then a DL reception by the IAB-MT on the symbol may determine the timing (e.g., as determined by a parent node serving the IAB-MT according to a Case-1 timing alignment and the propagation delay of the upstream link), while the IAB-DU aligns its UL reception on the TOL symbol with the DL reception according to an RX (Case-7) timing alignment scheme. In such embodiments, the IAB-DU may indicate a timing alignment to the child node according to the timing alignment scheme.

Inversely, in some embodiments, if a symbol configured DL for the IAB-MT has a lower priority than a TOL symbol indicated UL by an IAB-DU, then a UL reception by the IAB-DU on the symbol may determine the timing, while the IAB-MT aligns its DL reception on the TOL symbol with the UL reception according to an RX (Case-7) timing alignment scheme. Such embodiments may not follow a Case-1 timing alignment.

In various embodiments, a DL TX by a parent node follows a Case-1 timing alignment while an RX timing alignment scheme such as a Case-7 RX timing alignment is to be applied (FDM). In such embodiments, simultaneous receptions occur only if the RX (Case-7) timing alignment can be performed (e.g., if the timing of DL RX and UL RX can be aligned). Otherwise, one of the receptions such as a reception with a higher priority is performed while the other reception is omitted, canceled, or not scheduled. Particularly, in certain embodiments, the TOL symbol may not be indicated UL as it may otherwise not allow a Case-1 and Case-7 timing alignment simultaneously.

In embodiments B-3-2 and B-5-2, embodiment B-3-2 is similar to embodiment B-1-2, except that the resource configuration for the IAB-MT is replaced by a configuration for a PDCCH or a DL-RS such as a CSI-RS, and embodiments B-5-2 are similar to embodiment B-1-2, except that the resource configuration for the IAB-MT is replaced by a configured SPS.

In embodiment B-2-1, if an IAB-DU is configured UL on a symbol, an IAB-MT may be indicated DL on a TOL symbol by an SFI from a parent node in accordance with an SDM and/or FDM scheme provided that one or more conditions hold (e.g., the IAB node has a simultaneous RX capability or a constraint based on a power imbalance, an interference, a guard band, a spatial constraint, or a timing alignment being satisfied).

Regarding a power imbalance constraint, in certain embodiments, an RX power for an IAB-MT RX may be determined by a DL TX power of a parent node and a pathloss of the upstream link. A minimum DL TX power of the parent node may be determined based on a configuration, a minimum requirement for coverage, and so forth. An RX power for an IAB-DU RX may be determined by a UL TX power of child node and a pathloss of the downstream link. The UL TX power of the child node may be indicated by the serving IAB node, configured by the network, and so forth. Then, given a power imbalance threshold, a parent node serving the IAB-MT may determine whether to indicate DL on the TOL symbol based on the IAB-MT RX power and an expected IAB-DU RX power. To realize this method, the parent node may be informed of an IAB-MT's RX power constraint through a control signaling from the IAB-MT.

In some embodiments, a child node served by an IAB node is configured UL on a symbol by a resource configuration, which may include a TDD-UL-DL-ConfigCommon, a TDD-UL-DL-ConfigDedicated, and/or a TDD-UL-DL-ConfigDedicated2-r17.

In various embodiments, an SFI by the parent node may take a lower priority than, or may be overridden by, a resource configuration for a child node served by the IAB-DU. In certain embodiments, a resource configuration for a child node served by an IAB-DU may take a lower priority than, or may be overridden by, an SFI from a parent node. In some embodiments, a priority between a resource configuration and an SFI may be determined by a separate signaling or configuration or, alternatively, by a field in the resource configuration or the SFI.

In certain embodiments, resources configured and/or indicated by a configuration or signaling with a higher priority may be used unconditionally for scheduled communications, periodic, semi-persistent, or aperiodic communications, and so forth, while resources configured and/or indicated by a configuration or signaling with a lower priority may be used if one or more of the aforementioned conditions (e.g., capability, power, interference, spatial, timing, etc.) are satisfied.

In some embodiments, a resource configuration (e.g., including a ConfigCommon and a ConfigDedicated) for a child node served by an IAB-DU may take a higher priority than an SFI by a parent node. In such embodiments, a symbol configured UL by the resource configuration may be used for an UL transmission by the child node unconditionally, while a TOL symbol indicated DL by the SFI may be used for a DL transmission by the parent node if a condition based on a power imbalance, an interference, a spatial constraint, or the like is satisfied.

In various embodiments, a dynamic control signaling such as a UCI message or a MAC message sent to a parent node may be used to inform the parent node of whether a symbol will be available, whether a DL reception by an IAB-MT will be omitted or canceled, whether a condition such as a power or interference condition is not being satisfied, and so forth. In an embodiment, an IAB-MT may send an L1 and/or L2 control message in response to an SFI from a parent node, wherein the control message indicates whether the SFI message or a part of the SFI message is not accepted by an IAB node. According to such embodiments, a symbol configured UL for a child node served by an IAB-DU may already be scheduled for an UL RX such as a PUSCH. In such embodiments, an L1/L2 control message may be used to indicate to the parent node to reject the SFI. In one realization, a control message may reject the SFI message. In an alternative realization, a control message may include a bitmap or a similar structure as the SFI message indicating which resources may or may not be available as indicated by the SFI. In one example, a control message may include a recommended SFI. The recommended SFI may be based on the received SFI. A control message acknowledging that an SFI or a part of an SFI is accepted by the receiving node may be called an SFI-ACK message. Transmitting an SFI-ACK message may be optional (e.g., only if the associated SFI or a part of the associated SFI is rejected) according to a specification, a configuration, or control signaling.

Inversely, in certain embodiments, an SFI by a parent node may take a higher priority than a resource configuration (e.g., including a ConfigCommon and a ConfigDedicated) for a child node served by an IAB-DU. In such embodiments, a symbol indicated DL by the SFI may be used for a DL transmission by the parent node unconditionally, while a TOL symbol configured UL by the resource configuration may be used for an UL transmission by the child node if a condition based on a power imbalance, an interference, a spatial constraint, or the like is satisfied.

In some embodiments, if an RX timing alignment scheme such as a Case-7 timing alignment is to be applied (FDM), a resource configuration or signaling with a higher priority may determine a timing of an associated reception, while a reception associated with a lower-priority resource configuration or signaling may follow the determined timing. For example, if a symbol configured UL for a child node served by an IAB-DU has a higher priority than a TOL symbol indicated DL by the parent node, then a UL reception by the IAB-DU on the symbol may determine the timing, while the IAB-MT aligns its DL reception on the TOL symbol with the UL reception according to an RX (Case-7) timing alignment scheme. Such embodiments may not follow a Case-1 timing alignment, as the DL transmission by the parent node is determined by the DL reception timing at the IAB node and a propagation delay of the upstream link.

Inversely, in various embodiments, if a symbol configured UL for a child node is served by an IAB-DU has a lower priority than a TOL symbol indicated DL by a parent node, then a DL reception by an IAB-MT on the symbol may determine the timing (e.g., as determined by a parent node serving the IAB-MT according to a Case-1 timing alignment and the propagation delay of the upstream link), while the IAB-DU aligns its UL reception on the TOL symbol with the DL reception according to an RX (Case-7) timing alignment scheme. In such embodiments, the IAB-DU may indicate a timing alignment to the child node according to the timing alignment scheme.

In certain embodiments, a DL TX by a parent node follows a Case-1 timing alignment while an RX timing alignment scheme such as a Case-7 RX timing alignment is to be applied (FDM). In such embodiments, simultaneous receptions occur only if the RX (Case-7) timing alignment can be performed (e.g., if the timing of DL RX and UL RX can be aligned). Otherwise, one of the receptions such as a reception with a higher priority is performed while the other reception is omitted, canceled, or not scheduled.

In embodiments B-2-3 and B-2-5, embodiment B-2-3 is similar to embodiment B-2-1 except that the resource configuration for the IAB-DU is replaced by a configuration for a PUCCH or a UL-RS such as an SRS, and an SFI-ACK method as described for embodiment B-2-1 may be used in embodiment B-2-5 if a CG configured for a child node served by an IAB-DU takes a higher priority than an SFI received by an IAB-MT and if a simultaneous reception may not be accommodated due to a lack of capability or due to a constraint (e.g., power, interference, guard band, spatial, timing, etc.) not being satisfied. The priority may be determined by a specification, a configuration, or a control signaling.

An embodiment B-2-2 may include an embodiment B-2-2-a and an embodiment B-2-2-b.

In embodiment B-2-2-a, an upstream SFI may be received before sending downstream SFI. If an IAB-MT is indicated DL on a symbol by an SFI from a parent node, an IAB-DU may indicate UL on a TOL symbol by an SFI to a child node in accordance with an SDM and/or FDM scheme provided that one or more conditions hold (e.g., the IAB node has a simultaneous RX capability or a constraint based on a power imbalance, an interference, a guard band, a spatial constraint, or a timing alignment being satisfied).

In embodiment B-2-2-b, a downstream SFI may be sent before receiving upstream SFI. If an IAB-DU has indicated UL on a symbol by an SFI to a child node, an IAB-MT may be indicated DL on a TOL symbol by an SFI from a parent node in accordance with an SDM and/or FDM scheme provided that one or more conditions hold (e.g., the IAB node has a simultaneous RX capability or a constraint based on a power imbalance, an interference, a guard band, a spatial constraint, or a timing alignment being satisfied).

The following may apply to either Embodiments B-2-2-a and B-2-2-b.

Regarding a power imbalance, in certain embodiments, an RX power for an IAB-MT RX may be determined by a DL TX power of a parent node and a pathloss of the upstream link. A minimum DL TX power of the parent node may be determined based on a configuration, a minimum requirement for coverage, and so forth. An RX power for an IAB-DU RX may be determined by an UL TX power of child node and a pathloss of the downstream link. The UL TX power of the child node may be indicated by the serving IAB node, configured by the network, and so forth. Then, given a power imbalance threshold, the IAB-DU may determine whether to indicate UL on the TOL symbol based on the IAB-MT RX power and an expected IAB-DU RX power.

In some embodiments, an SFI by an IAB-DU may take a lower priority than, or may be overridden by, the SFI for an IAB-MT. In various embodiments, an SFI for an IAB-MT may take a lower priority than, or may be overridden by, the SFI by an IAB-DU. In certain embodiments, a priority between SFI messages may be determined by a separate signaling or configuration or, alternatively, by a field in the SFI messages.

In some embodiments, a priority between SFI messages may be determined based on a chronology: 1) in an embodiment, a first SFI transmitted or received earlier takes a higher priority and a second SFI transmitted or received later takes a lower priority; 2) in another embodiment, if a first SFI is received from a parent node, but a second SFI is transmitted to a child node prior to the end of a decoding time for decoding the first SFI, then the second SFI takes a higher priority; 3) in yet another embodiment, a second SFI transmitted or received later takes a higher priority than (e.g., overrides) a first SFI transmitted or received earlier.

In various embodiments, resources indicated by a signaling with a higher priority may be used unconditionally for scheduled communications, periodic, semi-persistent, or aperiodic communications, and so forth, while resources indicated by a signaling with a lower priority may be used if one or more of the aforementioned conditions (e.g., capability, power, interference, spatial, timing, etc.) are satisfied.

In certain embodiments, a first SFI for an IAB-MT may take a higher priority than a second SFI by an IAB-DU. In such embodiments, a symbol indicated DL by the first SFI may be used for a DL reception unconditionally, while a TOL symbol indicated UL by the second SFI may be used for a UL reception if a condition based on a power imbalance, an interference, a spatial constraint, or the like being satisfied.

In some embodiments, dynamic control signaling such as a DCI message or a MAC message sent to a child node may be used to inform the child node of whether to expect an UL transmission sent to an IAB-DU on the symbol. This signaling may help the child node to make decisions on its own resource management (e.g., if the child node is only capable of TDM).

Inversely, in various embodiments, a first SFI by an IAB-DU may take a higher priority than a second SFI for an IAB-MT. In such embodiments, a symbol indicated UL by the first SFI may be used for an UL reception unconditionally, while a TOL symbol indicated DL by the second SFI may be used for a DL reception if a condition based on a power imbalance, an interference, a spatial constraint, or the like being satisfied.

In certain embodiments, a dynamic control signaling such as an UCI message or a MAC message sent to a parent node may be used to inform the parent node of whether the symbol will be available, whether an UL transmission by the IAB-MT will be omitted or canceled, whether a condition such as a power or interference condition is not being satisfied, and so forth. According to such embodiments, a symbol indicated UL for a child node served by an IAB-DU may already be scheduled for a UL TX such as a PUSCH. In such embodiments, an L1 and/or L2 control signaling may be used to indicate to the parent node to reject the SFI. In one realization, a control message may reject the SFI message. In an alternative realization, a control message may include a bitmap or a similar structure as the SFI message indicating which resources may or may not be available as indicated by the SFI. A control message acknowledging that an SFI or a part of an SFI is accepted by the receiving node may be called an SFI-ACK message. Transmitting an SFI-ACK message may be optional (e.g., only if the associated SFI or part of the associated SFI is rejected) according to a specification, configuration, or control signaling.

In some embodiments, if an RX timing alignment scheme such as a Case-7 timing alignment is to be applied (FDM), a resource configuration or signaling with a higher priority may determine a timing of an associated reception, while a reception associated with a lower-priority resource configuration or signaling may follow the determined timing. For example, if a symbol indicated DL for an IAB-MT has a higher priority than a TOL symbol indicated UL by an IAB-DU, then a DL reception by the IAB-MT on the symbol may determine the timing (e.g., as determined by a parent node serving the IAB-MT according to a Case-1 timing alignment and the propagation delay of the upstream link), while the IAB-DU aligns its UL reception on the TOL symbol with the DL reception according to an RX (Case-7) timing alignment scheme. In such embodiments, the IAB-DU may indicate a timing alignment to the child node according to the timing alignment scheme.

Inversely, in various embodiments, if a symbol indicated DL for an IAB-MT has a lower priority than a TOL symbol indicated UL by an IAB-DU, then a UL reception by the IAB-DU on the symbol may determine the timing, while the IAB-MT aligns its DL reception on the TOL symbol with the UL reception according to an RX (Case-7) timing alignment scheme. Such embodiments may not follow a Case-1 timing alignment.

In certain embodiments, a DL TX by a parent node follows a Case-1 timing alignment while an RX timing alignment scheme such as a Case-7 RX timing alignment is to be applied (FDM). In such embodiments, simultaneous receptions occur only if the RX (Case-7) timing alignment can be performed (e.g., if the timing of DL RX and UL RX can be aligned). Otherwise, one of the receptions such as a reception with a higher priority is performed while the other reception is omitted, canceled, or not scheduled. Particularly, in some embodiments, a TOL symbol may not be indicated UL as it may otherwise not allow a Case-1 and Case-7 timing alignment simultaneously.

In embodiments B-2-4 and B-4-2, embodiment B-2-4 is similar to embodiment B-2-2 except that an SFI by an IAB-DU is replaced by a DCI scheduling a PUSCH for a child node by the IAB-DU, and an SFI-ACK method as described for embodiment B-2-2 may be used in embodiment B-2-4 if a PUSCH scheduled by an IAB-DU takes a higher priority than an SFI received by an IAB-MT and if a simultaneous reception may not be accommodated due to a lack of capability or due to a constraint (e.g., power, interference, guard band, spatial, timing, etc.) not being satisfied. The priority may be determined by a specification, a configuration, or a control signaling. In some embodiments, the priority may be determined according to a chronology: 1) in an embodiment, if an IAB node receives an SFI from a parent node, wherein the SFI conflicts with a PUSCH that the IAB node has scheduled prior to receiving the SFI, then the IAB node may send an SFI-ACK rejecting the SFI or a part of the SFI to the parent node; 2) in another embodiment, if an IAB node receives an SFI from a parent node, and if the IAB nodes transmits a DCI scheduling a PUSCH on resources conflicting with the SFI, and if the DCI is transmitted prior to a decoding time associated with a decoding of the SFI, then the IAB node may send an SFI-ACK rejecting the SFI or a part of the SFI to the parent node; and/or 3) in yet another embodiment, if an IAB node receives an SFI from a parent node, wherein the SFI conflicts with a PUSCH that the IAB node has scheduled prior to receiving the SFI, then the SFI may override the PUSCH schedule or the IAB node may omit or cancel transmitting a signal on all or a part of the PUSCH.

Similarly, embodiment B-4-2 is similar to embodiment B-2-2 except that an SFI for an IAB-MT is replaced by a DCI scheduling a PDSCH by a parent node for the IAB-MT.

In some embodiments, an L1 and/or L2 control message may be employed in embodiment B-4-2 if a PDSCH schedule received by an IAB-MT takes a higher priority than an SFI sent by an IAB-DU and if a simultaneous reception may not be accommodated due to a lack of capability or due to a constraint (e.g., power, interference, guard band, spatial, timing, etc.) not being satisfied. The priority may be determined by a specification, a configuration, or a control signaling. Alternatively, the priority may be determined according to a chronology: 1) in an embodiment, if an IAB node receives a DCI scheduling a PDSCH from a parent node, wherein the PDSCH conflicts with an SFI that the IAB node has transmitted prior to receiving the DCI, then the IAB node may transmit a control message rejecting the PDSCH schedule or a part of the PDSCH schedule to the parent node; 2) in another embodiment, if an IAB node receives a DCI scheduling a PDSCH from a parent node, and if the IAB node transmits an SFI for resources conflicting with the PDSCH, and if the SFI is transmitted prior to a decoding time associated with a decoding of the DCI, then the IAB node may send a control message rejecting the PDSCH schedule or a part of the PDSCH schedule to the parent node; and/or 3) in yet another embodiment, if an IAB node receives a DCI scheduling a PDSCH from a parent node, wherein the PDSCH schedule conflicts with an SFI that the IAB node has transmitted prior to receiving the DCI, then the PDSCH schedule may override the SFI or the IAB node may omit or cancel transmitting a signal on all or a part of the resources indicated UL by the SFI.

In embodiment B-1-3, if an IAB-MT is configured DL on a symbol, an IAB-DU may be configured a PUCCH or a UL-RS on a TOL symbol in accordance with an SDM and/or FDM scheme provided that one or more conditions hold (e.g., the IAB node has a simultaneous RX capability or a constraint based on a guard band or a timing alignment being satisfied).

In various embodiments, an IAB node is configured DL on a symbol by a first configuration, while a child node served by an IAB-DU is configured a PUCCH or a UL-RS on a TOL symbol by a second configuration. The first configuration may include a TDD-UL-DL-ConfigCommon, a TDD-UL-DL-ConfigDedicated, and/or a TDD-UL-DL-ConfigDedicated2-r17. The second configuration may include a PUCCH-ConfigCommon, a PUCCH-Config, and so forth. An alternative to a PUCCH is an uplink reference signal (“UL-RS”) such as an SRS. Then, the second configuration may include an SRS-Config, an SRS-ResourceSet, SRS-Resource, and so forth.

In certain embodiments, a second configuration may take a lower priority than, or may be overridden by, a first configuration. In some embodiments, a first configuration may take a lower priority than, or may be overridden by, a second configuration. In various embodiments, a priority between a first configuration and a second configuration may be determined by a separate signaling or configuration or, alternatively, by a field in the first configuration or the second configuration.

In some embodiments, resources configured by a configuration with a higher priority may be used unconditionally, while resources configured by a configuration with a lower priority may be used if one or more conditions are satisfied. Examples of the conditions may include a power imbalance constraint, an interference constraint, and/or a spatial constraint.

In various embodiments, a first resource configuration (e.g., including a ConfigCommon and a ConfigDedicated) for the IAB-MT may take a higher priority than a second configuration for a PUCCH or UL-RS for a child node served by an IAB-DU. In such embodiments, a symbol configured DL by the first configuration may be used for a DL transmission by the parent node unconditionally, while a TOL symbol configured UL by the second configuration may be used for a PUCCH and/or UL-RS transmission by the child node if a condition based on a power imbalance, an interference, a spatial constraint, or the like is satisfied.

In certain embodiments, dynamic control signaling such as a DCI message or a MAC message sent to a child node served by the IAB-DU may be used to inform the child node of whether to transmit a PUCCH signal or UL-RS on the symbol. In an embodiment, the IAB-DU may determine whether to trigger an aperiodic SRS (or other UL-RS) or activate and/or deactivate a semi-persistent SRS (or other UL-RS) based on the condition.

Inversely, in some embodiments, a first resource configuration (e.g., including a ConfigCommon and a ConfigDedicated) for an IAB-MT may take a lower priority than a second configuration for a PUCCH or UL-RS for a child node served by an IAB-DU. In such embodiments, a symbol configured UL by the second configuration may be used for a PUCCH and/or UL-RS transmission by the child node unconditionally, while a TOL symbol configured DL by the first configuration may be used for a DL transmission by the parent node if a condition based on a power imbalance, an interference, a spatial constraint, or the like is satisfied.

In various embodiments, a dynamic control signaling such as an UCI message or a MAC message sent to a parent node may be used to inform the parent node of whether the symbol will be available, whether a DL reception by the IAB-MT will be omitted or canceled, whether a condition such as a power or interference condition is not being satisfied, and so forth.

In certain embodiments, if an RX timing alignment scheme such as a Case-7 timing alignment is to be applied (FDM), a configuration with a higher priority may determine a timing of an associated reception, while a reception associated with a lower-priority configuration may follow the determined timing. For example, if a symbol configured DL for the IAB-MT has a higher priority than a TOL symbol configured for a PUCCH and/or UL-RS for a child node served by the IAB-DU, then a DL reception by the IAB-MT on the symbol may determine the timing (e.g., as determined by a parent node serving the IAB-MT according to a Case-1 timing alignment and the propagation delay of the upstream link), while the IAB-DU aligns its PUCCH and/or UL-RS reception on the TOL symbol with the DL reception according to an RX (Case-7) timing alignment scheme. In such embodiments, the IAB-DU may indicate a timing alignment to the child node according to the timing alignment scheme.

Inversely, in various embodiments, if a symbol configured DL for the IAB-MT has a lower priority than a TOL symbol configured for a PUCCH and/or UL-RS for a child node served by the IAB-DU, then the PUCCH and/or UL-RS reception by the IAB-DU on the symbol may determine the timing, while the IAB-MT aligns its DL reception on the TOL symbol with the UL reception according to an RX (Case-7) timing alignment scheme. Such embodiments may not follow a Case-1 timing alignment.

In certain embodiments, a DL TX by a parent node follows a Case-1 timing alignment while an RX timing alignment scheme such as a Case-7 RX timing alignment is to be applied (FDM). In such embodiments, simultaneous receptions occur only if the RX (Case-7) timing alignment can be performed (e.g., if the timing of DL RX and UL RX can be aligned). Otherwise, one of the receptions such as a reception with a higher priority is performed while the other reception is omitted, canceled, or not scheduled.

In embodiment B-3-1, if an IAB-DU is configured UL on a symbol, an IAB-MT may be configured a PDCCH or a DL-RS on a TOL symbol in accordance with an SDM and/or FDM scheme provided that one or more conditions hold (e.g., the IAB node has a simultaneous RX capability or a constraint based on a guard band or a timing alignment being satisfied).

In some embodiments, an IAB node is configured UL on a symbol by a first configuration, while the IAB node is also configured a PDCCH or a DL-RS on a TOL symbol by a second configuration. The first configuration may include a TDD-UL-DL-ConfigCommon, a TDD-UL-DL-ConfigDedicated, and/or a TDD-UL-DL-ConfigDedicated2-r17. The second configuration may include a PDCCH-ConfigCommon, a PDCCH-ServingCellConfig, a PDCCH-Config, and so forth. An alternative to a PDCCH is a downlink reference signal (DL-RS) such as a CSI-RS, a PSS, an SSS, or an SS/PBCH block. Then, the second configuration may include a CSI-ResourceConfig, a CSI-SSB-ResourceSet, and so forth.

In various embodiments, a second configuration may take a lower priority than, or may be overridden by, a first configuration. In certain embodiments, a first configuration may take a lower priority than, or may be overridden by, a second configuration. In some embodiments, a priority between a first configuration and a second configuration may be determined by a separate signaling or configuration or, alternatively, by a field in the first configuration or the second configuration.

In various embodiments, resources configured by a configuration with a higher priority may be used unconditionally, while resources configured by a configuration with a lower priority may be used if one or more conditions are satisfied. Examples of conditions may include a power imbalance constraint, an interference constraint, and/or a spatial constraint.

In certain embodiments, a first resource configuration for a PDCCH or DL-RS for an IAB-MT may take a higher priority than a second configuration (e.g., including a ConfigCommon and a ConfigDedicated) for a child node served by an IAB-DU. In such embodiments, a symbol configured DL by the first configuration may be used for the PDCCH and/or DL-RS transmission by the parent node unconditionally, while a TOL symbol configured UL by the second configuration may be used for UL transmission by the child node if a condition based on a power imbalance, an interference, a spatial constraint, or the like is satisfied.

In some embodiments, a dynamic control signaling such as a DCI message or a MAC message sent to a child node served by an IAB-DU may be used to inform the child node of whether to expect being scheduled with an UL transmission to the IAB-DU on a symbol. This signaling may help the child node to make decisions on its own resource management (e.g., if the child node is only capable of TDM).

Inversely, in various embodiments, a first resource configuration for a PDCCH or DL-RS for an IAB-MT may take a lower priority than a second configuration (e.g., including a ConfigCommon and a ConfigDedicated) for a child node served by an IAB-DU. In such embodiments, a symbol configured UL by the second configuration may be used for an UL transmission by the child node unconditionally, while a TOL symbol configured DL by the first configuration may be used for the PDCCH and/or DL-RS transmission by the parent node if a condition based on a power imbalance, an interference, a spatial constraint, or the like is satisfied.

In certain embodiments, a dynamic control signaling such as an UCI message or a MAC message sent to a parent node may be used to inform the parent node of whether the symbol will be available, whether the PDCCH and/or DL-RS reception by the IAB-MT will be omitted or canceled, whether a condition such as a power or interference condition is not being satisfied, and so forth.

In some embodiments, if an RX timing alignment scheme such as a Case-7 timing alignment is to be applied (FDM), a configuration with a higher priority may determine a timing of an associated reception, while a reception associated with a lower-priority configuration may follow the determined timing. For example, if a symbol configured UL for a child node served by an IAB-DU has a higher priority than a TOL symbol configured for a PDCCH and/or DL-RS for an IAB-MT, then an UL reception by the IAB-DU on the symbol may determine the timing, while the IAB-MT aligns its PDCCH and/or DL-RS reception on the TOL symbol with the UL reception according to an RX (Case-7) timing alignment scheme. Such embodiments may not follow a Case-1 timing alignment, as the DL transmission by the parent node is determined by the DL reception timing at the IAB node and a propagation delay of the upstream link.

Inversely, in various embodiments, if a symbol configured UL for a child node served by an IAB-DU has a lower priority than a TOL symbol configured for a PDCCH and/or DL-RS for an IAB-MT, then the PDCCH and/or DL-RS reception by the IAB-MT on the symbol may determine the timing (e.g., as determined by a parent node serving the IAB-MT according to a Case-1 timing alignment and the propagation delay of the upstream link), while the IAB-DU aligns its UL reception on the TOL symbol with the PDCCH and/or DL-RS reception according to an RX (Case-7) timing alignment scheme. In such embodiments, the IAB-DU may indicate a timing alignment to the child node according to the timing alignment scheme.

In certain embodiments, a DL TX by a parent node follows a Case-1 timing alignment even if an RX timing alignment scheme such as an RX (Case-7) timing alignment is to be applied (FDM). In such embodiments, simultaneous receptions occur only if the RX (Case-7) timing alignment can be performed (e.g., if the timing of DL RX and UL RX can be aligned). Otherwise, one of the receptions such as a reception with a higher priority is performed while the other reception is omitted, canceled, or not scheduled.

In an embodiment B-3-3, if an IAB-MT is configured a PDCCH and/or DL-RS on a symbol, an IAB-DU may be configured a PUCCH and/or UL-RS on a TOL symbol in accordance with an SDM and/or FDM scheme provided that one or more conditions hold (e.g., the IAB node has a simultaneous RX capability or a constraint based on a guard band or a timing alignment being satisfied).

In some embodiments, an IAB node is configured with a PDCCH and/or DL-RS on a symbol by a first configuration, while a child node served by the IAB-DU is configured PUCCH and/or UL-RS on a TOL symbol by a second configuration. In the case of a PDCCH, the first configuration may include a PDCCH-ConfigCommon, a PDCCH-ServingCellConfig, a PDCCH-Config, and so forth. For a DL-RS such as a CSI-RS or an SS/PBCH block, the first configuration may include a CSI-ResourceConfig, a CSI-SSB-ResourceSet, and so forth. For a PUCCH, the second configuration may include a PUCCH-ConfigCommon, a PUCCH-Config, and so forth. For an UL-RS such as an SRS, the second configuration may include an SRS-Config, an SRS-ResourceSet, SRS-Resource, and so forth.

In various embodiments, a second configuration may take a lower priority than, or may be overridden by, a first configuration. In certain embodiments, a first configuration may take a lower priority than, or may be overridden by, a second configuration. In some embodiments, a priority between a first configuration and a second configuration may be determined by a separate signaling or configuration or, alternatively, by a field in the first configuration or the second configuration.

In certain embodiments, resources configured by a configuration with a higher priority may be used unconditionally, while resources configured by a configuration with a lower priority may be used if one or more conditions are satisfied. Examples of the conditions may include a power imbalance constraint, a total power constraint, an interference constraint, and/or a spatial constraint.

In some embodiments, a first configuration for the IAB-MT may take a higher priority than a second configuration for a child node served by the IAB-DU. In such embodiments, a symbol configured DL by the first configuration may be used for a DL transmission by a parent node unconditionally, while a TOL symbol configured UL by the second configuration may be used for a UL transmission by a child node if a condition based on a power imbalance, an interference, a spatial constraint, or the like is satisfied.

In various embodiments, a dynamic control signaling such as a DCI message or a MAC message sent to a child node served by an IAB-DU may be used to inform the child node of whether the TOL symbol will be used as UL. In an embodiment, the IAB-DU may transmit a control message to the child node informing the child node of whether to transmit a PUCCH and/or UL-RS on the TOL symbol.

Inversely, in certain embodiments, a first configuration for the IAB-MT may take a lower priority than a second configuration for a child node served by an IAB-DU. In such embodiments, a symbol configured UL by the second configuration may be used for a UL transmission by a child node unconditionally, while a TOL symbol configured DL by the first configuration may be used for a DL transmission by a parent node if a condition based on a power imbalance, an interference, a spatial constraint, or the like is satisfied.

In some embodiments, dynamic control signaling such as a UCI message or a MAC message sent to a parent node may be used to inform the parent node of whether the TOL symbol will be used as DL, whether a PDCCH and/or DL-RS will be neglected by the IAB-MT, whether a condition such as a power or interference condition is not being satisfied, and so forth. In an embodiment, the IAB-MT refrains from taking an action in response to a PDCCH or refrains from transmitting a report, such as a CSI report, associated with the DL-RS. In such an embodiment, the parent node may interpret a lack of corresponding action or report as the IAB nodes' lack of capability for simultaneous operation temporarily or permanently.

In various embodiments, an IAB node is not expected to be configured with a PDCCH and/or DL-RS on a symbol and a PUCCH and/or UL-RS on a TOL symbol. In certain embodiments, an IAB node is expected to be configured with a PDCCH and/or DL-RS on a symbol and a PUCCH and/or UL-RS on a TOL symbol only if it is capable of performing enhanced duplexing and the IAB node indicates to the IAB-CU (or any other entity configuring the IAB node) that it is capable of SDM or multi-panel communication.

In some embodiments, if an RX timing alignment scheme such as a Case-7 timing alignment is to be applied (FDM), a resource configuration with a higher priority may determine a timing of an associated reception, while a reception associated with a lower-priority resource configuration may follow the determined timing. For example, if a symbol configured DL for the IAB-MT has a higher priority than a TOL symbol configured UL for a child node served by the IAB-DU, then a PDCCH and/or DL-RS reception by the IAB-MT on the symbol may determine the timing (e.g., as determined by a parent node serving the IAB-MT according to a Case-1 timing alignment and the propagation delay of the upstream link), while the IAB-DU aligns its PUCCH and/or UL-RS reception on the TOL symbol with the DL reception according to an RX (Case-7) timing alignment scheme. In such embodiments, the IAB-DU may indicate a timing alignment to the child node according to the timing alignment scheme.

Inversely, in various embodiments, if a symbol configured DL for an IAB-MT has a lower priority than a TOL symbol configured UL for a child node served by an IAB-DU, then a PUCCH and/or UL-RS reception from the child node on the symbol may determine the timing, while the IAB-MT aligns its PDCCH and/or DL-RS reception on the TOL symbol with the PUCCH and/or UL-RS reception according to an RX (Case-7) timing alignment scheme. Such embodiments may not follow a Case-1 timing alignment.

In certain embodiments, a DL TX by a parent node may be determined by a Case-1 timing alignment, while an RX timing alignment scheme such as a Case-7 RX timing alignment is to be applied (FDM). In such embodiments, simultaneous receptions occur only if the RX (Case-7) timing alignment can be performed (e.g., if the timing of a PDCCH and/or DL-RS reception and a PUCCH and/or UL-RS reception can be aligned). Otherwise, one of the receptions such as a reception with a higher priority is performed while the other reception is omitted, canceled, or not scheduled.

In an embodiment B-1-4, if an IAB-MT is configured DL on a symbol, an IAB-DU may schedule a PUSCH on a TOL symbol for a child node in accordance with an SDM and/or FDM scheme provided that one or more conditions hold (e.g., the IAB node has a simultaneous RX capability or a constraint based on a power imbalance, an interference, a guard band, a spatial constraint, and/or a timing alignment being satisfied).

Regarding a power imbalance constraint, in some embodiments, an RX power for an IAB-MT RX may be determined by a DL TX power of a parent node and a pathloss of the upstream link. A minimum DL TX power of the parent node may be determined based on a configuration, a minimum requirement for coverage, and so forth. An RX power for an IAB-DU RX may be determined by a UL TX power of child node and a pathloss of the downstream link. The UL TX power of the child node may be indicated by the serving IAB node, configured by the network, and so forth. Then, given a power imbalance threshold, the IAB-DU may determine whether to schedule a PUSCH on the TOL symbol based on the IAB-MT RX power and an expected RX power.

In various embodiments, an IAB node is configured DL on a symbol by a resource configuration, which may include a TDD-UL-DL-ConfigCommon, a TDD-UL-DL-ConfigDedicated, and/or a TDD-UL-DL-ConfigDedicated2-r17.

In certain embodiments, DCI scheduling a PUSCH may take a lower priority than, or may be overridden by, a resource configuration for an IAB-MT. In some embodiments, a resource configuration for an IAB-MT may take a lower priority than, or may be overridden by, DCI scheduling a PUSCH. In various embodiments, a priority between a resource configuration and DCI scheduling a PUSCH may be determined by a separate signaling or configuration or, alternatively, by a field in the resource configuration or the DCI.

In some embodiments, resources configured and/or scheduled by a configuration or signaling with a higher priority may be used unconditionally, while resources configured and/or scheduled by a configuration or signaling with a lower priority may be used if one or more of the aforementioned conditions (e.g., capability, power, interference, spatial, timing, etc.) are satisfied.

In various embodiments, a resource configuration (e.g., including a ConfigCommon and a ConfigDedicated) for an IAB-MT may take a higher priority than a DCI scheduling a PUSCH. In such embodiments, a symbol configured DL by the resource configuration may be used for a DL transmission by the parent node unconditionally, while a TOL symbol scheduled UL may be used for a UL transmission by the child node if a condition based on a power imbalance, an interference, a spatial constraint, or the like is satisfied.

Inversely, in certain embodiments, DCI scheduling a PUSCH may take a higher priority than a resource configuration (e.g., including a ConfigCommon and a ConfigDedicated) for an IAB-MT. In such embodiments, a symbol scheduled UL may be used for an UL transmission by a child node unconditionally, while a TOL symbol configured DL by the resource configuration may be used for a DL transmission by the parent node if a condition based on a power imbalance, an interference, a spatial constraint, or the like is satisfied.

In some embodiments, a dynamic control signaling such as a UCI message or a MAC message sent to a parent node may be used to inform the parent node of whether the symbol will be available, whether a DL reception by the IAB-MT will be omitted or canceled, whether a condition such as a power or interference condition is not being satisfied, and so forth. In an embodiment, the IAB node may send an L1 and/or L2 control message containing a bitmap that indicates which resources are available. The interpretation of the L1 and/or L2 control message including a granularity of the resources in time and frequency domains may be determined by a specification or a configuration.

In various embodiments, if an RX timing alignment scheme such as a Case-7 timing alignment is to be applied (FDM), a resource configuration or signaling with a higher priority may determine a timing of an associated reception, while a reception associated with a lower-priority resource configuration or signaling may follow the determined timing. For example, if a symbol configured DL for the IAB-MT has a higher priority than a TOL symbol scheduled UL by the IAB-DU, then a DL reception by the IAB-MT on the symbol may determine the timing (e.g., as determined by a parent node serving the IAB-MT according to a Case-1 timing alignment and the propagation delay of the upstream link), while the IAB-DU aligns its UL reception on the TOL symbol with the DL reception according to an RX (Case-7) timing alignment scheme.

Inversely, in certain embodiments, if a symbol configured DL for an IAB-MT has a lower priority than a TOL symbol scheduled UL by the IAB-DU, then an UL reception by the IAB-DU on the symbol may determine the timing, while the IAB-MT aligns its DL reception on the TOL symbol with the UL reception according to an RX (Case-7) timing alignment scheme. Such embodiments may not follow a Case-1 timing alignment.

In some embodiments, a DL TX by a parent node follows a Case-1 timing alignment while an RX timing alignment scheme such as a Case-7 RX timing alignment is to be applied (FDM). In such embodiments, simultaneous receptions occur only if the RX (Case-7) timing alignment can be performed (e.g., if the timing of DL RX and UL RX can be aligned). Otherwise, one of the receptions such as a reception with a higher priority is performed while the other reception is omitted, canceled, or not scheduled. Particularly, in various embodiments, a TOL symbol may not be scheduled UL as it may otherwise not allow a Case-1 and Case-7 timing alignment simultaneously.

In an embodiment B-4-1, if an IAB-DU is configured UL on a symbol, an IAB-MT may be scheduled a PDSCH on a TOL symbol by a parent node in accordance with an SDM and/or FDM scheme provided that one or more conditions hold (e.g., the IAB node has a simultaneous RX capability or a constraint based on a power imbalance, an interference, a guard band, a spatial constraint, or a timing alignment being satisfied).

Regarding a power imbalance constraint, in various embodiments, an RX power for an IAB-MT RX may be determined by a DL TX power of a parent node and a pathloss of the upstream link. A minimum DL TX power of the parent node may be determined based on a configuration, a minimum requirement for coverage, and so forth. An RX power for an IAB-DU RX may be determined by an UL TX power of a child node and a pathloss of the downstream link. The UL TX power of the child node may be indicated by the serving IAB node, configured by the network, and so forth. Then, given a power imbalance threshold, a parent node serving the IAB-MT may determine whether to schedule a PDSCH on the TOL symbol based on the IAB-MT RX power and an expected IAB-DU RX power. To realize this method, the parent node may be informed of an IAB-MT's RX power constraint through a control signaling from the IAB-MT.

In certain embodiments, a child node served by the IAB node is configured UL on a symbol by a resource configuration which may include a TDD-UL-DL-ConfigCommon, a TDD-UL-DL-ConfigDedicated, and/or a TDD-UL-DL-ConfigDedicated2-r17.

In some embodiments, DCI scheduling a PDSCH for an IAB-MT may take a lower priority than, or may be overridden by, a resource configuration for a child node served by an IAB-DU. In various embodiments, a resource configuration for a child node served by an IAB-DU may take a lower priority than, or may be overridden by, DCI scheduling a PDSCH for an IAB-MT. In certain embodiments, a priority between a resource configuration and DCI scheduling a PDSCH may be determined by a separate signaling or configuration or, alternatively, by a field in the resource configuration or the DCI.

In certain embodiments, resources configured and/or scheduled by a configuration or signaling with a higher priority may be used unconditionally, while resources configured and/or scheduled by a configuration or signaling with a lower priority may be used if one or more of the aforementioned conditions (e.g., capability, power, interference, spatial, timing, etc.) are satisfied.

In some embodiments, a resource configuration (e.g., including a ConfigCommon and a ConfigDedicated) for a child node served by an IAB-DU may take a higher priority than DCI scheduling a PDSCH. In such embodiments, a symbol configured UL by the resource configuration may be used for an UL transmission by the child node unconditionally, while a TOL symbol scheduled DL may be used for a DL transmission by the parent node if a condition based on a power imbalance, an interference, a spatial constraint, or the like is satisfied.

In various embodiments, a dynamic control signaling such as a UCI message or a MAC message to a parent node may be used to inform the parent node of whether the symbol will be available, whether a DL reception by an IAB-MT will be omitted or canceled, whether a condition such as a power or interference condition is not being satisfied, and so forth. In an embodiment, the IAB-MT may send an L1 and/or L2 control message in response to a DCI message scheduling a PDSCH by the parent node, wherein the control message indicates whether the PDSCH schedule is not accepted by the IAB node. In such embodiments, a symbol configured UL for a child node served by the IAB-DU may already be scheduled for a UL RX such as a PUSCH. In such embodiments, an L1 and/or L2 control message may be used to indicate to the parent node to reject the PDSCH schedule. In one realization, a control message may reject the PDSCH schedule. In an alternative realization, a control message may include a bitmap indicating which resources may or may not be available for a PDSCH. A control message acknowledging that a PDSCH schedule or a part of a PDSCH schedule is accepted by the receiving node may be called a schedule-ACK message. Transmitting a schedule-ACK message may be optional (e.g., only if the associated PDSCH schedule or a part of the associated PDSCH schedule is rejected) according to a specification, configuration, and/or control signaling.

Inversely, in certain embodiments, DCI scheduling a PDSCH may take a higher priority than a resource configuration (e.g., including a ConfigCommon and a ConfigDedicated) for a child node served by an IAB-DU. In such embodiments, a symbol scheduled DL may be used for a DL transmission by the parent node unconditionally, while a TOL symbol configured UL by the resource configuration may be used for a UL transmission by the child node if a condition based on a power imbalance, an interference, a spatial constraint, or the like is satisfied.

In some embodiments, a dynamic control signaling such as a DCI message or a MAC message sent to a child node may be used to inform the child node of whether to expect being scheduled with an UL transmission to an IAB-DU on a symbol. This signaling may help the child node to make decisions on its own resource management (e.g., if the child node is only capable of TDM).

In various embodiments, if an RX timing alignment scheme such as a Case-7 timing alignment is to be applied (FDM), a resource configuration or signaling with a higher priority may determine a timing of an associated reception, while a reception associated with a lower-priority resource configuration or signaling may follow the determined timing. For example, if a symbol configured UL for a child node served by the IAB-DU has a higher priority than a TOL symbol scheduled DL by the parent node, then an UL reception by the IAB-DU on the symbol may determine the timing, while the IAB-MT aligns its DL reception on the TOL symbol with the UL reception according to an RX (Case-7) timing alignment scheme. Such embodiments may not follow a Case-1 timing alignment, as the DL transmission by the parent node is determined by the DL reception timing at the IAB node and a propagation delay of the upstream link.

Inversely, in certain embodiments, if a symbol configured UL for a child node served by the IAB-DU has a lower priority than a TOL symbol scheduled DL by the parent node, then a DL reception by the IAB-MT on the symbol may determine the timing (e.g., as determined by a parent node serving the IAB-MT according to a Case-1 timing alignment and the propagation delay of the upstream link), while the IAB-DU aligns its UL reception on the TOL symbol with the DL reception according to an RX (Case-7) timing alignment scheme. In such embodiments, the IAB-DU may indicate a timing alignment to the child node according to the timing alignment scheme.

In some embodiments, a DL TX by a parent node follows a Case-1 timing alignment while an RX timing alignment scheme such as a Case-7 RX timing alignment is to be applied (FDM). In such embodiments, simultaneous receptions occur only if the RX (Case-7) timing alignment can be performed (e.g., if the timing of DL RX and UL RX can be aligned). Otherwise, one of the receptions such as a reception with a higher priority is performed while the other reception is omitted, canceled, or not scheduled.

In embodiments B-3-4 and B-4-3, embodiment B-3-4 may be similar to embodiment B-1-4 except that the resource configuration for the IAB-MT is replaced by a configuration for a PDCCH or a DL-RS such as a CSI-RS, and embodiment B-4-3 may be similar to embodiment B-4-1 except that the resource configuration for the IAB-DU is replaced by a configuration for a PUCCH or a UL-RS such as an SRS.

An embodiment B-4-4 may include an embodiment B-4-4-a and/or an embodiment B-4-4-b.

In the embodiment B-4-4-a: PDSCH may be scheduled prior to PUSCH in which if an IAB-MT is scheduled with a PDSCH on a symbol by a parent node, an IAB-DU may schedule a PUSCH for a child node or a UE on a TOL symbol in accordance with an SDM and/or FDM scheme provided that one or more conditions hold (e.g., the IAB node has a simultaneous RX capability or a constraint based on a power imbalance, an interference, a guard band, a spatial constraint, and/or a timing alignment being satisfied).

In various embodiments, to realize simultaneous receptions, a value of K0 may need to be larger than or equal to K2 plus a time required to process a DCI from a parent node that schedules a PDSCH or indicates a parameter such as a TCI state for the PDSCH or generally a time duration and/or offset. The time required to process the DCI may be determined by an IAB node capability or by the standard.

In the embodiment B-4-4-b: PUSCH may be scheduled prior to PDSCH in which if an IAB-DU schedules a PUSCH on a symbol for a child node or a UE, a parent node may schedule a PDSCH for an IAB-MT on a TOL symbol in accordance with an SDM and/or FDM scheme provided that one or more conditions hold (e.g., the IAB node has a simultaneous RX capability or a constraint based on a power imbalance, an interference, a guard band, a spatial constraint, and/or a timing alignment being satisfied).

In certain embodiments, to realize simultaneous transmissions, a value of K0 may need to be larger than or equal to K2 plus a time required to process a DCI from a parent node that schedules a PDSCH or indicates a parameter such as a TCI state for the PDSCH or generally a time duration and/or offset. The time required to process the DCI may be determined by an IAB node capability or by the standard.

In embodiments B-4-5 and B-5-4, the embodiment B-4-5 may be similar to Embodiment B-4-4-b, except that a CG is configured by an IAB-CU rather than a DCI scheduling a PUSCH. Therefore, a condition between K0 and K2 may not be applicable.

In some embodiments, an L1 and/or L2 control signaling may be used to inform a parent node whether a PDSCH may be scheduled on a symbol based on a determination by the IAB node of whether a UL RX is intended on a TOL symbol that is configured by a CG.

Embodiment B-5-4 may be similar to embodiment A-4-4-a, except that a DL RX is scheduled by a configured grant rather than a DCI scheduling a PDSCH. Therefore, a condition between K0 and K2 may not be applicable.

In various embodiments, an IAB node may schedule a PUSCH on a symbol based on a determination by the IAB node on whether a DL RX is expected on a TOL symbol that is configured by an SPS.

In embodiments B-1-5, B-5-1, B-3-5, B-5-3, and B-5-5, embodiments B-1-5, B-5-1, B-3-5, B-5-3, and B-5-5 may include elements from embodiments B-1-1 and B-3-3 as the resources available for both upstream and downstream links are configured by an IAB-CU. More details may be provided for scenarios where a child node served by an IAB-DU is configured with a CG-PUSCH, where in the CG-PUSCH may be of Type 1 (e.g., without activation by L1 and/or L2 control signaling) and Type 2 (e.g., for which L1 and/or L2 control signaling is used for activating and deactivating a CG-PUSCH). Furthermore, in certain embodiments, elements of the methods described for scenarios B-2-5, B-5-2, B-4-5, and B-5-4 may be used where applicable to any of these five scenarios.

In a third set of embodiments corresponding to Case C (Case #3), table 7 summarizes different combinations for simultaneous IAB-MT TX (UL) and IAB-DU RX (UL).

TABLE 7

| | IAB-DU | | | | |
|---|---|---|---|---|---|
| | configured UL | | | | |
| | by | | IAB-DU | | |
| | ConfigCommon | IAB-DU | configured | IAB-DU | IAB-DU |
| | or | indicated | PUCCH, | scheduling | configured |
| | ConfigDedicated | UL by SFI | UL-RS | PUSCH | CG-PUSCH |
| IAB-MT | C-1-1 | C-1-2 | C-1-3 | C-1-4 | C-1-5 |
| configured UL | | | | | |
| by | | | | | |
| ConfigCommon | | | | | |
| or | | | | | |
| ConfigDedicated | | | | | |
| IAB-MT | C-2-1 | C-2-2 | C-2-3 | C-2-4 | C-2-5 |
| indicated UL by | | | | | |
| SFI | | | | | |
| IAB-MT | C-3-1 | C-3-2 | C-3-3 | C-3-4 | C-3-5 |
| configured | | | | | |
| PUCCH, UL-RS | | | | | |
| IAB-MT | C-4-1 | C-4-2 | C-4-3 | C-4-4 | C-4-5 |
| scheduled | | | | | |
| PUSCH | | | | | |
| IAB-MT | C-5-1 | C-5-2 | C-5-3 | C-5-4 | C-5-5 |
| configured CG- | | | | | |
| PUSCH | | | | | |

In the third set of embodiments, references may be made to the following recurring phrases: 1) simultaneous TX and/or RX capability: this may refer to an IAB node's capability to perform simultaneous transmission and reception, which may indicate that the IAB node is capable of SDM and/or FDM, the IAB node has multiple antenna panels (SDM), the IAB node is capable of simultaneous transmission and reception in DL and UL, the IAB node is capable of enhanced duplexing, or the like—for configuration-based methods, information of the capability may be sent to an IAB-CU that configures the system—for methods based on control signaling, the information of the capability may be sent to another IAB node such as a parent node or a child node; 2) interference constraint: this may refer to a variety of interference constraints between antennas of an IAB node (self-interference), interference on other nodes or channels or cells, and so forth—in some embodiments, according to an interference constraint, the interference by a child node on a parent node RX may be below a threshold if the parent node performs beamforming for receiving a signal from an IAB-MT—in some embodiments, according to an interference constraint, the interference by an IAB-MT on an IAB-DU RX should be below a threshold if the IAB-DU performs beamforming for receiving a signal from a child node; and/or 3) guard band constraint: this may refer to a constraint according to which the frequency resources (e.g., PRBs) allocated to the IAB-MT is separated from the frequency resources allocated to the IAB-DU by at least a threshold called a guard band. A value of the guard band may be determined by an IAB node capability for one panel (FDM) or among multiple panels (SDM). For configuration-based methods, a resource may be allocated by a configuration. For methods based on control signaling, a resource may be allocated by control message such as an L1 and/or L2 message.

In certain embodiments, solutions for each of the scenarios listed in table 7 may be constructed by combining solutions proposed for Case A scenarios and solutions proposed for Case B scenarios. Since Case C includes an UL TX by an IAB-MT, similar to Case A, and a UL RX by an IAB-DU, similar to Case B, a solution for a Case C scenario may include elements of a solution proposed for an IAB-MT for a Case A scenario and elements of a solution proposed for an IAB-DU for a Case B scenario.

Particularly, in some embodiments, a solution as embodiment C-x-y may include elements for a solution proposed as embodiment A-x-y for an IAB-MT and elements for a solution proposed as embodiment B-x-y for an IAB-DU. For example, a solution as embodiment C-1-2 may include elements for a solution proposed as embodiment A-1-2 for an IAB-MT and elements for a solution proposed as embodiment B-1-2 for an IAB-DU. Other combinations are not precluded based on applicability.

In a fourth set of embodiments for Case D (Case #4), table 8 summarizes the different combinations for simultaneous IAB-MT RX (DL) and IAB-DU TX (DL).

TABLE 8

| | IAB-DU | | | | |
|---|---|---|---|---|---|
| | configured DL | | | | |
| | by | | IAB-DU | | |
| | ConfigCommon | IAB-DU | configured | IAB-DU | IAB-DU |
| | or | indicating | CORESET, | scheduling | configured |
| | ConfigDedicated | DL by SFI | DL-RS | PDSCH | SPS |
| IAB-MT | D-1-1 | D-1-2 | D-1-3 | D-1-4 | D-1-5 |
| configured DL | | | | | |
| by | | | | | |
| ConfigCommon | | | | | |
| or | | | | | |
| ConfigDedicated | | | | | |
| IAB-MT | D-2-1 | D-2-2 | D-2-3 | D-2-4 | D-2-5 |
| indicated DL by | | | | | |
| SFI | | | | | |
| IAB-MT | D-3-1 | D-3-2 | D-3-3 | D-3-4 | D-3-5 |
| configured | | | | | |
| CORESET, DL- | | | | | |
| RS | | | | | |
| IAB-MT | D-4-1 | D-4-2 | D-4-3 | D-4-4 | D-4-5 |
| scheduled | | | | | |
| PDSCH | | | | | |
| IAB-MT | D-5-1 | D-5-2 | D-5-3 | D-5-4 | D-5-5 |
| configured SPS | | | | | |

In the fourth set of embodiments, references are made to the following recurring phrases: 1) simultaneous TX and/or RX capability: this may refer to an IAB node's capability to perform simultaneous transmission and reception, which may indicate that the IAB node is capable of SDM and/or FDM, the IAB node has multiple antenna panels (SDM), the IAB node is capable of simultaneous transmission and reception in DL and UL, the IAB node is capable of enhanced duplexing, or the like—for configuration-based methods, information of the capability may be sent to an IAB-CU that configures the system—for methods based on control signaling, the information of the capability may be sent to another IAB node such as a parent node or a child node; 2) interference constraint: this may refer to a variety of interference constraints between antennas of an IAB node (self-interference), interference on other nodes or channels or cells, and so forth—in some embodiments, according to an interference constraint, the interference by a parent node on a child node RX should be below a threshold if the child node performs beamforming for receiving a signal from an IAB-DU—in some embodiments, according to an interference constraint, the interference by an IAB-DU on an IAB-MT RX should be below a threshold when the IAB-MT performs beamforming for receiving a signal from a parent node; 3) guard band constraint: this may refer to a constraint according to which the frequency resources (e.g., PRBs) allocated to the IAB-MT is separated from the frequency resources allocated to the IAB-DU by at least a threshold called a guard band. A value of the guard band may be determined by an IAB node capability for one panel (FDM) or among multiple panels (SDM). For configuration-based methods, a resource may be allocated by a configuration. For methods based on control signaling, a resource may be allocated by a control message such as an L1 and/or L2 message.

In certain embodiments, solutions for each of the scenarios listed in table 8 may be constructed by combining solutions proposed for Case A scenarios and solutions proposed for Case B scenarios. Since Case D include a DL RX by an IAB-MT, similar to Case B, and a DL TX by an IAB-DU, similar to Case A, a solution for a Case D scenario may include elements of a solution proposed for an IAB-MT for a Case B scenario and elements of a solution proposed for an IAB-DU for a Case A scenario.

In some embodiments, a solution as embodiment D-x-y may include elements for a solution proposed as embodiment B-x-y for an IAB-MT and elements for a solution proposed as embodiment A-x-y for an IAB-DU. For example, a solution as embodiment D-1-2 may include elements for a solution proposed as embodiment B-1-2 for an IAB-MT and elements for a solution proposed as embodiment A-1-2 for an IAB-DU. Other combinations are not precluded based on applicability.

In various embodiments, there may be an SFI-ACK. An SFI as specified in NR may indicate to a UE which symbols in a plurality of slots will be used for downlink or uplink. In certain embodiments, such as in NR Rel-15/16, DCI format 2_0 is used for notifying the slot format, COT duration, available RB set, and search space set group switching. The following information may be transmitted by means of the DCI format 2_0 with cyclic redundancy cycle (“CRC”) scrambled by SFI-RNTI: 1) if a higher layer parameter slotFormatCombToAddModList is configured: a slot format indicator 1, slot format indicator 2, . . . , slot format indicator N; 2) if the higher layer parameter availableRB-SetsToAddModList-r16 is configured: available RB set indicator 1, available RB set indicator 2, . . . , available RB set indicator N1; 3) if the higher layer parameter co-DurationsPerCellToAddModList-r16 is configured: COT duration indicator 1, COT duration indicator 2, . . . , COT duration indicator N2; 4) if the higher layer parameter searchSpaceSwitchTriggerToAddModList-r16 is configured: search space set group switching flag 1, search space set group switching flag 2, . . . , search space set group switching flag M. In such embodiments, the size of DCI format 2_0 is configurable by higher layers up to 128 bits. SlotFormatCombinationsPerCell and SlotFormatCombination IEs may determine how a UE interprets a received SFI.

In certain embodiments, an IAB node may receive an SFI from a parent node, wherein the SFI indicates to the IAB node what symbols in a plurality of slots will be used for downlink or uplink. Then, if the IAB node is capable of enhanced duplexing such as an SDM/multi-panel or FDM capability, the IAB node may perform a simultaneous operation accordingly. Embodiments A-2-x, B-2-x, C-2-x, D-2-x may include an element receiving an SFI from a parent node.

Similarly, in some embodiments, an IAB node may transmit an SFI to a child node. Then, if the IAB node is capable of enhanced duplexing such as an SDM and/or multi-panel or FDM capability, the SFI may determine a behavior for a simultaneous operation on the upstream link as in embodiments A-x-2, B-x-2, C-x-2, and D-x-2.

In various embodiments, an IAB node may be used to transmit an L1 and/or L2 control message to a parent node of the IAB node in response to receiving an SFI from the parent node, wherein the control message indicates to the parent node whether the slot formats indicated by the SFI are acceptable to the IAB node. The control message may be referred to as an SFI-ACK message.

In certain embodiments, an SFI-ACK may accept or reject an associated SFI received from a parent node. The SFI-ACK may include a first field indicating with which SFI it is associated. This field may contain a slot index in which the SFI was received, a last SFI received by the IAB node, an offset such as a number of slots indicating how many slots prior to an SFI to be received, or the like. The SFI-ACK may also include a second field indicating whether an SFI is accepted or rejected by the IAB node. In one realization, an IAB node may transmit an SFI-ACK to a parent node only if it intends to reject the associated SFI from the parent node. In this realization, the second field may be omitted.

In some embodiments, an SFI-ACK may accept or reject a part of an associated SFI received from a parent node. The SFI-ACK may include a first field indicating with which SFI it is associated. The SFI-ACK may also include a second field, such as a bitmap, wherein each bit and/or subfield indicates whether each of the slot formats associated with several slots is accepted or rejected by the IAB node.

In various embodiments, a second field such as a bitmap includes bits and/or subfields, wherein each bit and/or subfield may indicate whether each of the DL/F/UL directions indicated by the slot formats is accepted or rejected by the IAB node.

Embodiments herein may provide a tradeoff between resource efficiency for shared resources and an overhead of control resources. A configuration may determine an interpretation of an SFI-ACK, bit-widths of the fields, and so forth.

In certain embodiments, such as in NR Rel-16, an SFI may be used to indicate what resource block (“RB”) sets are available. A bitmap may be provided wherein each bit indicates whether a RB set is available.

In some embodiments, a field such as a bitmap in an SFI-ACK may indicate to a parent node which RB sets indicated available by an associated SFI is accepted or rejected by the IAB node. In such embodiments, each bit and/or subfield is associated with an RB set, or with an RB set indicated available by the associated SFI. In a realization, the bitmap is bit-wise associated with a bitmap in the associated SFI. In this realization, if the associated SFI indicates that an RB set is available, the associate bit in the bitmap in the SFI-ACK may indicate whether the RB set is accepted or rejected.

Embodiments herein may be used for realizing simultaneous operation such as FDM between upstream and downstream links. For example, if a symbol and/or an RB set is intended to be used in the downstream communication between the IAB node and a child node, and if the communication on the symbol and/or RB set is conflicting with a TOL symbol and/or RB set indicated available DL/UL and/or available, respectively, then the IAB node may transmit an SFI-ACK indicating to the parent node that the SFI for the TOL symbol and/or RB set is not accepted.

In various embodiments, an IAB node may transmit a control message such as an SFI-ACK to a parent node unsolicited (e.g., not in response to an SFI from the parent node). A configuration may determine the size of a field, bitmap, bit-widths, and other parameters needed to interpret the control message. An unsolicited SFI-ACK may be sent on an L1/L2 control channel with a similar functionality as a normal SFI-ACK. The purpose of an unsolicited SFI-ACK may be to preempt a resource that is needed by the IAB node in accordance with a configuration and a simultaneous operation capability of the IAB node.

In certain embodiments, if an IAB node receives an SFI from a parent node, the IAB node may not be able to transmit an associated SFI-ACK prior to the first slot whose format is indicated by the SFI.

In some embodiments, an IAB node may not reject a slot format indicated by an SFI, wherein the slot does not occur after the slot in which the IAB transmits an associated SFI-ACK. In various embodiments, a parent node may ignore a bit and/or subfield in the SFI-ACK, wherein the bit and/or subfield is associated with a slot that does not occur after the slot in which the IAB transmits the SFI-ACK. In various embodiments, a parent node may require a decoding time to decode an SFI-ACK.

In certain embodiments, an IAB node may not reject a slot format indicated by an SFI, wherein the slot does not occur after the slot in which the IAB transmits an associated SFI-ACK plus a decoding time. In some embodiments, a parent node may ignore a bit and/or subfield in an SFI-ACK, wherein the bit and/or subfield is associated with a slot that does not occur after the slot in which the IAB transmits the SFI-ACK plus a decoding time. The decoding time may be expressed in a number of symbols or a number of slots for a value of SCS and may be determined by a standard or by a capability of the parent node. The information may be communicated to the IAB node directly or through communications with an IAB-CU.

In some embodiments described herein, such as embodiments A/BC/D-3-x and A/B/C/D-x-3, transmission or reception of reference signals such as CSI-RS or SRS may be duplexed with other upstream or downstream communications. Methods may be based on a priority between a reference signal and another signal or channel in different simultaneous operation scenarios.

In various embodiments described herein, a priority between a reference signal and a multiplexed signal and/or channel may be determined by a standard, a configuration, a control signaling, and so forth. In certain embodiments, what an IAB node may do may be based on determined priorities if a simultaneous operation cannot be accommodated.

Some embodiments herein may be extended to cases where a priority of a reference signal transmission or reception may depend on a type of the reference signal: periodic, semi-persistent, or aperiodic. The priority may be determined based on a significance of the reference signal, its periodicity, whether a report is to be produced based on a measurement on the reference signal, a significance of the report, whether the reference signal can be deactivated or omitted, and so forth. A priority based on such criteria may be determined by the standard and/or by a configuration.

In various embodiments, a periodic reference signal may take a higher priority with respect to a multiplexed signal and/or channel, while an aperiodic reference signal may take a lower priority with respect to the multiplexed signal and/or channel.

In certain embodiments, a semi-persistent reference signal that may not be deactivated prior to a simultaneous operation may take a higher priority with respect to a multiplexed signal and/or channel, while a semi-persistent reference signal that may be deactivated prior to a simultaneous operation may take a lower priority with respect to the multiplexed signal and/or channel. An ability of an IAB node to deactivate a reference signal may depend on a signaling timing. For example, if the IAB node possesses sufficient time to deactivate a semi-persistent reference signal from the time that the IAB node is indicated to perform a simultaneous operation, then the IAB node may deactivate the reference signal, hence a lower priority for the reference signal.

In some embodiments, a reference signal that is associated with a CSI report, or may otherwise determine the content of a control signaling, may take a higher priority with respect to a multiplexed signal and/or channel, while the reference signal may take a lower priority otherwise.

In various embodiments, a significance of CSI report, or other control signaling depending on a measurement of the reference signal, may determine a priority of the reference signal. For example, if a reference signal is associated with a large CSI report (e.g., a Type II CSI report), the reference signal may take a higher priority with respect to a multiplexed signal and/or channel, while the reference signal may take a lower priority otherwise.

Certain embodiments herein are presented for CG PUSCH, which is a periodic or semi-persistent data communication configured by the RRC. Transmission without grant (“TWG”) Type 1 may not require an activation, while TWG Type 2 may be activated or deactivated by L1/L2 control signaling. Moreover there may be scenarios of simultaneous operation in which an IAB node may transmit a signal on a CG-PUSCH to a parent node include A-5-x and C-5-x, and scenarios of simultaneous operation in which the IAB node may receive a signal on a CG-PUSCH from a child node or a UE include B-x-5 and C-x-5.

In some embodiments, an IAB node may be configured and/or signaled to perform simultaneous operations where at least one of the upstream and downstream operations is a transmitting or receiving a signal on a CG-PUSCH. If the IAB node can accommodate the simultaneous operations based on its hardware capability and operation constraints (e.g., spatial, power, interference, timing, etc.), then the IAB node performs the simultaneous operations as intended. Otherwise, various embodiments may be used to determine a priority between the operations, omit one operation, signal the inability to an adjacent node, and so forth.

In certain embodiments, a CG-PUSCH Type 1 may take a higher priority with respect to a multiplexed signal and/or channel, while a CG-PUSCH Type 2 may take a lower priority with respect to the multiplexed signal and/or channel. In some embodiments, a CG-PUSCH Type 2 may take a higher priority with respect to a multiplexed signal and/or channel, while a CG-PUSCH Type 1 may take a lower priority with respect to the multiplexed signal and/or channel.

In various embodiments, a CG-PUSCH that may not be deactivated prior to the simultaneous operation may take a higher priority with respect to a multiplexed signal and/or channel, while a CG-PUSCH that may be deactivated prior to a simultaneous operation may take a lower priority with respect to the multiplexed signal and/or channel. An ability of an IAB node to deactivate a CG-PUSCH may depend on a signaling timing. For example, if the IAB node possesses sufficient time to deactivate a CG-PUSCH from the time that the IAB node is indicated to perform a simultaneous operation, then the IAB node may deactivate the CG-PUSCH, hence a lower priority for the CG-PUSCH.

In certain embodiments, a priority may be determined based on a quality-of-service (“QoS”) value for a transport block to be transmitted on a CG-PUSCH. For example, a QoS value associated with a low-latency transport block may take a higher priority, while another transport block may take a lower priority.

In some embodiments, a priority may be determined based on a HARQ retransmission value. For example, a transport block with RV=0 may take a higher value while another RV value may take a higher priority, or vice versa.

It should be noted that any of the embodiments described herein may be combined with other embodiments.

In various embodiments, enhanced duplexing may be indicated to an adjacent node such as a parent node or a child node.

In certain embodiments, it is expected that an IAB-CU configuring an IAB may be made aware of capabilities of IAB nodes in the system through RRC messages sent on an F1 interface. Those may include capabilities related to enhanced duplexing and simultaneous operations. Examples of such capabilities are a number of antenna panels, a number of antenna panels for upstream, a number of antenna panels for downstream, a beamforming capability, an FDM and/or SDM capability, a number of DFT and/or IDFT windows, and so forth. This information may be required or helpful for the IAB-CU to configure resources properly for the IAB nodes. The IAB-CU may further be informed of topological changes in the IAB system, mobility of IAB nodes, changes in a large-scale interference level, and so forth, based on which the IAB-CU may change resource configurations.

In some embodiments, an IAB-CU may inform IAB nodes of capabilities associated with other IAB nodes such as a parent node of child node. The communications may occur on an F1 interface and in the form of RRC configuration IEs.

In various embodiments, RRC signaling over an F1 interface may not be sufficient for short-scale changes in the capability of an IAB node to perform simultaneous operation, especially in a multi-hop IAB system where communicating RRC messages from an IAB node to the IAB-CU and then from the IAB-CU to another node may cause a significant delay. Therefore, direct control signaling between IAB nodes may be adopted to inform other nodes of an instantaneous ability of an IAB node to perform simultaneous operations.

In certain embodiments, an L 1/L2 control message from an IAB node to a parent node serving the IAB node or a child node served by the IAB node may inform the parent/child node of the IAB node's ability to perform a simultaneous operation. This “short-scale” capability indication may be determined by a hardware capability such as a number of antenna panels, a power constraint, an interference constraint, a beamforming/spatial constraint, a timing alignment constraint, or the like.

In some embodiments, a control message may carry one bit of information indicating whether the IAB node is capable of performing simultaneous operation at the present time.

In various embodiments, a control message may further indicate whether it can perform a simultaneous operation based on a beamforming and/or spatial constraint, a power constraint, an interference constraint, a timing constraint, and so forth. Particularly, an IAB node may be able to perform a simultaneous operation based on a spatial filter, a TX/RX power range, an interference threshold, or a timing alignment scheme at one time, but it may be unable to do so at another time.

In some embodiments, a control message may include information of a type of simultaneous operation an IAB node is capable of. For example, the IAB node may be able to perform half-duplex simultaneous TX or simultaneous RX, but it may be unable to perform a full-duplex operation based on a hardware capability or an operation constraint (spatial, power, interference, timing, etc.).

In various embodiments, a control message may be periodic. In certain embodiments, a control message may be transmitted upon demand (e.g., in response to a soliciting control signaling or only when the IAB node is temporarily deviating from a capability it has indicated earlier such as due to an operation constraint).

In certain embodiments there may be a simultaneous “best effort.” Despite an IAB node's capability to perform simultaneous operation, the capability may be disrupted temporarily due to a constraint during the operation. In this case, a best-effort approach may be taken by the IAB system or an IAB node to perform simultaneous operations only when they are possible. For example, an IAB node may be configured or indicated to use a time-frequency resource in a direction, for example for a DL or UL communication. Then, the IAB node may use the resource in the configured and/or indicated direction. Additionally, if the IAB node is capable of performing an upstream or downstream communication simultaneously based on its hardware capabilities and while considering operation constraints, the IAB node may choose to schedule a communication and/or indicate to an adjacent node to expect a communication on the resource or a TOL resource.

In some embodiments, an IAB node performing simultaneous operations based on a best-effort approach may still inform adjacent nodes, either a parent and/or child node or a node in a physical vicinity, of its intention to perform a communication other than one configured or indicated to the IAB nodes. Control signaling may inform adjacent nodes of upcoming communications and may allow them to take an action accordingly (e.g., to perform beamforming or mitigate interference).

In various embodiments, an IAB node may perform a simultaneous operation based on a best-effort approach only on certain symbols. The symbols may be configured or indicated to be usable for simultaneous operation based on a best-effort approach.

Specifically, in certain embodiments, only resources configured or indicated flexible (“F”) may be used for a simultaneous operation based on a best-effort approach.

In some embodiments, a new type of resource may be introduced to allow an IAB node to perform simultaneous operation, either based on a best-effort method or otherwise. This type of resource may be called DL+UL, which may or may not be interpreted as a F symbol.

In various embodiments, a DL+UL symbol may be realized by introducing a new value in addition to DL, UL, and F. This may require altering a structure of currently specified messages.

In certain embodiments, a DL+UL symbol may be realized by separate signaling. An example of the separate signaling is the TDD-UL-DL-ConfigDedicated2-r17 IE. A similar principle may be adopted to introduce control messages with structures similar to that of SFI.

In some embodiments, the terms antenna, panel, and antenna panel are used interchangeably. An antenna panel may be hardware that is used for transmitting and/or receiving radio signals at frequencies lower than 6 GHz (e.g., frequency range 1 (“FR1”)), or higher than 6 GHz (e.g., frequency range 2 (“FR2”) or millimeter wave (“mmWave”)). In certain embodiments, an antenna panel may include an array of antenna elements. Each antenna element may be connected to hardware, such as a phase shifter, that enables a control module to apply spatial parameters for transmission and/or reception of signals. The resulting radiation pattern may be called a beam, which may or may not be unimodal and may allow the device to amplify signals that are transmitted or received from spatial directions.

In various embodiments, an antenna panel may or may not be virtualized as an antenna port. An antenna panel may be connected to a baseband processing module through a radio frequency (“RF”) chain for each transmission (e.g., egress) and reception (e.g., ingress) direction. A capability of a device in terms of a number of antenna panels, their duplexing capabilities, their beamforming capabilities, and so forth, may or may not be transparent to other devices. In some embodiments, capability information may be communicated via signaling or capability information may be provided to devices without a need for signaling. If information is available to other devices the information may be used for signaling or local decision making.

In some embodiments, a UE antenna panel may be a physical or logical antenna array including a set of antenna elements or antenna ports that share a common or a significant portion of a radio frequency (“RF”) chain (e.g., in-phase and/or quadrature (“I/Q”) modulator, analog to digital (“A/D”) converter, local oscillator, phase shift network). The UE antenna panel or UE panel may be a logical entity with physical UE antennas mapped to the logical entity. The mapping of physical UE antennas to the logical entity may be up to UE implementation. Communicating (e.g., receiving or transmitting) on at least a subset of antenna elements or antenna ports active for radiating energy (e.g., active elements) of an antenna panel may require biasing or powering on of an RF chain which results in current drain or power consumption in a UE associated with the antenna panel (e.g., including power amplifier and/or low noise amplifier (“LNA”) power consumption associated with the antenna elements or antenna ports). The phrase “active for radiating energy,” as used herein, is not meant to be limited to a transmit function but also encompasses a receive function. Accordingly, an antenna element that is active for radiating energy may be coupled to a transmitter to transmit radio frequency energy or to a receiver to receive radio frequency energy, either simultaneously or sequentially, or may be coupled to a transceiver in general, for performing its intended functionality. Communicating on the active elements of an antenna panel enables generation of radiation patterns or beams.

In certain embodiments, depending on a UE's own implementation, a “UE panel” may have at least one of the following functionalities as an operational role of unit of antenna group to control its transmit (“TX”) beam independently, unit of antenna group to control its transmission power independently, and/pr unit of antenna group to control its transmission timing independently. The “UE panel” may be transparent to a gNB. For certain conditions, a gNB or network may assume that a mapping between a UE's physical antennas to the logical entity “UE panel” may not be changed. For example, a condition may include until the next update or report from UE or include a duration of time over which the gNB assumes there will be no change to mapping. A UE may report its UE capability with respect to the “UE panel” to the gNB or network. The UE capability may include at least the number of “UE panels.” In one embodiment, a UE may support UL transmission from one beam within a panel. With multiple panels, more than one beam (e.g., one beam per panel) may be used for UL transmission. In another embodiment, more than one beam per panel may be supported and/or used for UL transmission.

In some embodiments, an antenna port may be defined such that a channel over which a symbol on the antenna port is conveyed may be inferred from the channel over which another symbol on the same antenna port is conveyed.

In certain embodiments, two antenna ports are said to be quasi co-located (“QCL”) if large-scale properties of a channel over which a symbol on one antenna port is conveyed may be inferred from the channel over which a symbol on another antenna port is conveyed. Large-scale properties may include one or more of delay spread, Doppler spread, Doppler shift, average gain, average delay, and/or spatial receive (“RX”) parameters. Two antenna ports may be quasi co-located with respect to a subset of the large-scale properties and different subset of large-scale properties may be indicated by a QCL Type. For example, a qcl-Type may take one of the following values: 1) ‘QCL-TypeA’: {Doppler shift, Doppler spread, average delay, delay spread}; 2) ‘QCL-TypeB’: {Doppler shift, Doppler spread}; 3) ‘QCL-TypeC’: {Doppler shift, average delay}; and 4) ‘QCL-TypeD’: {Spatial Rx parameter}. Other QCL-Types may be defined based on combination of one or large-scale properties.

In various embodiments, spatial RX parameters may include one or more of: angle of arrival (“AoA”), dominant AoA, average AoA, angular spread, power angular spectrum (“PAS”) of AoA, average angle of departure (“AoD”), PAS of AoD, transmit and/or receive channel correlation, transmit and/or receive beamforming, and/or spatial channel correlation.

In certain embodiments, QCL-TypeA, QCL-TypeB, and QCL-TypeC may be applicable for all carrier frequencies, but QCL-TypeD may be applicable only in higher carrier frequencies (e.g., mmWave, FR2, and beyond), where the UE may not be able to perform omni-directional transmission (e.g., the UE would need to form beams for directional transmission). For a QCL-TypeD between two reference signals A and B, the reference signal A is considered to be spatially co-located with reference signal B and the UE may assume that the reference signals A and B can be received with the same spatial filter (e.g., with the same RX beamforming weights).

In some embodiments, an “antenna port” may be a logical port that may correspond to a beam (e.g., resulting from beamforming) or may correspond to a physical antenna on a device. In certain embodiments, a physical antenna may map directly to a single antenna port in which an antenna port corresponds to an actual physical antenna. In various embodiments, a set of physical antennas, a subset of physical antennas, an antenna set, an antenna array, or an antenna sub-array may be mapped to one or more antenna ports after applying complex weights and/or a cyclic delay to the signal on each physical antenna. The physical antenna set may have antennas from a single module or panel or from multiple modules or panels. The weights may be fixed as in an antenna virtualization scheme, such as cyclic delay diversity (“CDD”). A procedure used to derive antenna ports from physical antennas may be specific to a device implementation and transparent to other devices.

In certain embodiments, a transmission configuration indicator (“TCI”) state (“TCI-state”) associated with a target transmission may indicate parameters for configuring a quasi-co-location relationship between the target transmission (e.g., target RS of demodulation (“DM”) reference signal (“RS”) (“DM-RS”) ports of the target transmission during a transmission occasion) and a source reference signal (e.g., synchronization signal block (“SSB”), CSI-RS, and/or sounding reference signal (“SRS”)) with respect to quasi co-location type parameters indicated in a corresponding TCI state. The TCI describes which reference signals are used as a QCL source, and what QCL properties may be derived from each reference signal. A device may receive a configuration of a plurality of transmission configuration indicator states for a serving cell for transmissions on the serving cell. In some embodiments, a TCI state includes at least one source RS to provide a reference (e.g., UE assumption) for determining QCL and/or a spatial filter.

In some embodiments, spatial relation information associated with a target transmission may indicate a spatial setting between a target transmission and a reference RS (e.g., SSB, CSI-RS, and/or SRS). For example, a UE may transmit a target transmission with the same spatial domain filter used for receiving a reference RS (e.g., DL RS such as SSB and/or CSI-RS). In another example, a UE may transmit a target transmission with the same spatial domain transmission filter used for the transmission of a RS (e.g., UL RS such as SRS). A UE may receive a configuration of multiple spatial relation information configurations for a serving cell for transmissions on a serving cell.

In various embodiments described herein, although entities are referred to as IAB nodes, the same embodiments can be applied to IAB donors (e.g., which are the IAB entities connecting the core network to the IAB network) with minimum or zero modifications. Moreover, different steps described for different embodiments may be permuted. Further, each configuration may be provided by one or more configurations in practice. An earlier configuration may provide a subset of parameters while a later configuration may provide another subset of parameters. In certain embodiments, a later configuration may override values provided by an earlier configuration or a pre-configuration.

In some embodiments, a configuration may be provided by radio resource control (“RRC”) signaling, medium-access control (“MAC”) signaling, physical layer signaling such as a downlink control information (“DCI”) message, a combination thereof, or other methods. A configuration may include a pre-configuration or a semi-static configuration provided by a standard, by a vendor, and/or by a network and/or operator. Each parameter value received through configuration or indication may override previous values for a similar parameter.

In various embodiments, despite frequent references to IAB, embodiments herein may be applicable to wireless relay nodes and other types of wireless communication entities. Further, layer 1 (“L1”) and/or layer 2 (“L2”) control signaling may refer to control signaling in layer 1 (e.g., physical layer) or layer 2 (e.g., data link layer). Particularly, an L1 and/or L2 control signaling may refer to an L1 control signaling such as a DCI message or an uplink control information (“UCI”) message, an L2 control signaling such as a MAC message, or a combination thereof. A format and an interpretation of an L1 and/or L2 control signaling may be determined by a standard, a configuration, other control signaling, or a combination thereof.

It should be noted that any parameter discussed in this disclosure may appear, in practice, as a linear function of that parameter in signaling or specifications.

In certain embodiments, in any timing assignment for a slot that contains a signal, a timing assignment by a sign such as ‘=’ or ‘:=’ or a like may mean that the start time of the slot containing the signal is equal to a determined value such as a right hand side of the equation. In some embodiments, a start time of the slot containing the signal may be different from the determined value by an integer multiple of Tₛₗₒₜ, where Tₛₗₒₜ denotes a slot duration for a given numerology or subcarrier spacing (“SCS”). This may be applicable to all timing assignments found herein. In various embodiments, the values may be different by an integer multiple of T_{symbol} rather than an integer multiple of Tₛₗₒₜ, where T_{symbol} denotes a symbol duration for a given numerology or SCS.

In various embodiments, vendor manufacturing IAB systems and/or devices and an operator deploying the IAB systems and/or devices may be allowed to negotiate capabilities of the systems and/or devices. This may mean that some of the information assumed to need signaling between entities may readily be available to the devices, for example, by storing the information on a memory unit such as a read-only memory (“ROM”), exchanging the information by proprietary signaling methods, providing the information by a (pre)configuration, or otherwise taking the information into account when creating hardware and/or software of the IAB systems and/or devices or other entities in the network. In certain embodiments, embodiments described herein that include exchanging information may be extended to similar embodiments wherein the information is obtained by other embodiments.

Further, embodiments used for an IAB mobile terminal (“MT”) (“IAB-MT”) may be adopted by a UE as well. If an embodiment uses a capability that is not supported by a legacy UE, a UE enhanced to possess the capability may be used. In this case, the UE may be referred to as an enhanced UE or an IAB-enhanced UE and may convey its information of its enhanced capability to the network for proper configuration and operation.

As used herein, a node or a wireless node may refer to an IAB node, an IAB-DU, an IAB-MT, a UE, a base station (“BS”), a gNodeB (“gNB”), a transmit-receive point (“TRP”), an IAB donor, and so forth. The embodiments herein with an emphasis on a type of nodes are not meant to limit scope.

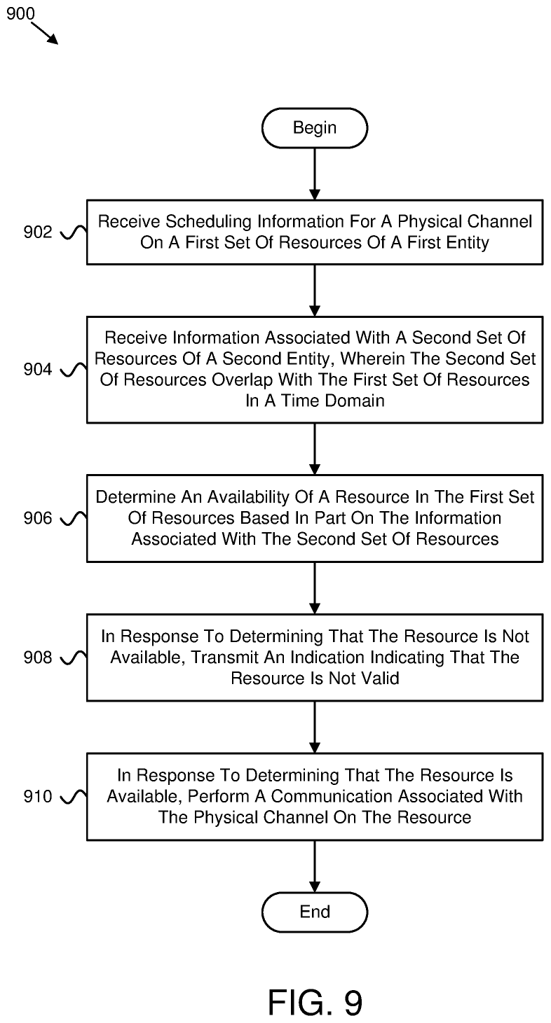

FIG. 9 is a flow chart diagram illustrating one embodiment of a method 900 for resource configuration for wireless communication. In some embodiments, the method 900 is performed by an apparatus, such as the network unit 104. In certain embodiments, the method 900 may be performed by a processor executing program code, for example, a microcontroller, a microprocessor, a CPU, a GPU, an auxiliary processing unit, a FPGA, or the like.

In various embodiments, the method 900 includes receiving 902, at a wireless node, scheduling information for a physical channel on a first set of resources of a first entity. In some embodiments, the method 900 includes receiving 904 information associated with a second set of resources of a second entity. The second set of resources overlap with the first set of resources in a time domain. In certain embodiments, the method 900 includes determining 906 an availability of a resource in the first set of resources based in part on the information associated with the second set of resources. In various embodiments, the method 900 includes, in response to determining that the resource is not available, transmitting 908 an indication indicating that the resource is not valid. In some embodiments, the method 900 includes, in response to determining that the resource is available, performing 910 a communication associated with the physical channel on the resource.

In certain embodiments: the physical channel is a physical uplink shared channel, a configured grant physical uplink shared channel, or a combination thereof; the first entity is an integrated access and backhaul distributed unit; the second entity is an integrated access and backhaul mobile terminal; and performing the communication comprises receiving an uplink signal. In some embodiments: the physical channel is a physical downlink shared channel, a semi-persistent scheduled channel, or a combination thereof; the first entity is an integrated access and backhaul distributed unit; the second entity is an integrated access and backhaul mobile terminal; and performing the communication comprises transmitting a downlink signal.

In various embodiments: the physical channel is a physical uplink shared channel, a configured grant physical uplink shared channel, or a combination thereof; the first entity is an integrated access and backhaul mobile terminal; the second entity is an integrated access and backhaul distributed unit; and performing the communication comprises transmitting an uplink signal. In one embodiment: the physical channel is a physical downlink shared channel, a semi-persistent scheduled channel, or a combination thereof; the first entity is an integrated access and backhaul mobile terminal; the second entity is an integrated access and backhaul distributed unit; and performing the communication comprises receiving a downlink signal.

In certain embodiments, the information associated with the second set of resources comprises a slot format indication, and the slot format indication comprises information indicating at least one communication direction associated with at least one resource in the second set of resources. In some embodiments: the information associated with the second set of resources comprises information of a first spatial filter associated with at least one resource in the second set of resources; and determining the availability of the resource comprises determining whether the first spatial filter is compatible with a second spatial filter associated with the physical channel.

In various embodiments: the information associated with the second set of resources comprises information of a first timing alignment associated with at least one resource in the second set of resources; and determining the availability of the resource comprises determining whether the first timing alignment is compatible with a second timing alignment associated with the physical channel. In one embodiment: the information associated with the second set of resources comprises information of a first transmission power associated with at least one resource in the second set of resources; and determining the availability of the resource comprises determining whether the first transmission power is compatible with a second transmission associated with the physical channel according to at least one of a total power constraint and a power imbalance constraint.

In certain embodiments: the information associated with the second set of resources comprises information of a first reception power associated with at least one resource in the second set of resources; and determining the availability of the resource comprises determining whether the first reception power is compatible with a second reception associated with the physical channel according to a power imbalance constraint. In some embodiments, the method 900 further comprises receiving a slot format indication corresponding to the resource, wherein the slot format indication comprises information indicating at least one symbol direction of the resource, and the availability of the resource is determined based on the slot formation indication.

In various embodiments, the resource is determined as being available if the slot format indication indicates that the resource comprises only downlink symbols. In one embodiment, the slot format indication further comprises information indicating whether the resource is used for simultaneous backhaul and access operations. In certain embodiments, the resource is determined as being available if the slot format indication indicates that the resource comprises only downlink symbols and that the resource is used for the simultaneous backhaul and access operations.

In some embodiments, the resource is determined as being available if downlink assignment information scheduling at least one symbol of the resource is not received earlier than a first duration before an earliest symbol of the resource. In various embodiments, the first duration is based on a preparation time associated with the physical channel. In one embodiment, the method 900 further comprises receiving scheduling information for a backhaul operation, wherein determining the availability of the resource comprises determining the availability of the resource based on spatial relation information of the physical channel and the scheduling information for the backhaul operation.

In certain embodiments, the method 900 further comprises receiving an indication indicating that the resource of the physical channel is set to be always available. In some embodiments, the method 900 further comprises cancelling the communication associated with the physical channel if a resource of the backhaul uplink transmission at least partially overlaps in time with the resource of the physical channel. In various embodiments, the method 900 further comprises determining that a resource of a backhaul downlink reception is not available if the resource of the backhaul downlink reception at least partially overlaps in time with the resource of the physical channel. In one embodiment, the wireless node comprises a base station, an integrated access and backhaul donor, an integrated access and backhaul node, a user equipment, or some combination thereof.

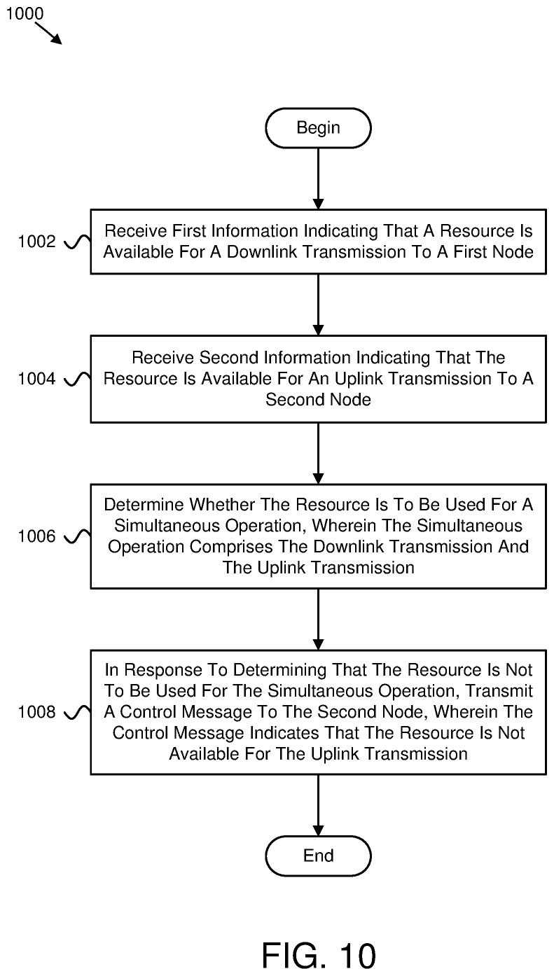

FIG. 10 is a flow chart diagram illustrating another embodiment of a method 1000 for resource configuration for wireless communication. In some embodiments, the method 1000 is performed by an apparatus, such as the network unit 104. In certain embodiments, the method 1000 may be performed by a processor executing program code, for example, a microcontroller, a microprocessor, a CPU, a GPU, an auxiliary processing unit, a FPGA, or the like.

In various embodiments, the method 1000 includes receiving 1002, at a wireless node, first information indicating that a resource is available for a downlink transmission to a first node. In some embodiments, the method 1000 includes receiving 1004 second information indicating that the resource is available for an uplink transmission to a second node. In certain embodiments, the method 1000 includes determining 1006 whether the resource is to be used for a simultaneous operation. The simultaneous operation includes the downlink transmission and the uplink transmission. In various embodiments, the method 1000 includes, in response to determining that the resource is not to be used for the simultaneous operation, transmitting 1008 a control message to the second node. The control message indicates that the resource is not available for the uplink transmission.

In certain embodiments, determining whether the resource is to be used for the simultaneous operation is based on: a capability of the wireless node to perform the simultaneous operation; a maximum value of a power imbalance, wherein the power imbalance is a difference between a power for the downlink transmission and a power for the uplink transmission; a maximum value of a total power, wherein the total power is a total of a power for the downlink transmission and a power for the uplink transmission; a value of interference from a previous uplink transmission on the first node; a constraint on a spatial parameter; whether a timing of the uplink transmission is to be aligned with a timing of the downlink transmission; or some combination thereof. In some embodiments, the wireless node comprises a base station, an integrated access and backhaul donor, an integrated access and backhaul node, a user equipment, or some combination thereof.

In one embodiment, a method of a wireless node comprises: receiving scheduling information for a physical channel on a first set of resources of a first entity; receiving information associated with a second set of resources of a second entity, wherein the second set of resources overlap with the first set of resources in a time domain; determining an availability of a resource in the first set of resources based in part on the information associated with the second set of resources; in response to determining that the resource is not available, transmitting an indication indicating that the resource is not valid; and, in response to determining that the resource is available, performing a communication associated with the physical channel on the resource.

In certain embodiments: the physical channel is a physical uplink shared channel, a configured grant physical uplink shared channel, or a combination thereof; the first entity is an integrated access and backhaul distributed unit; the second entity is an integrated access and backhaul mobile terminal; and performing the communication comprises receiving an uplink signal.

In some embodiments: the physical channel is a physical downlink shared channel, a semi-persistent scheduled channel, or a combination thereof; the first entity is an integrated access and backhaul distributed unit; the second entity is an integrated access and backhaul mobile terminal; and performing the communication comprises transmitting a downlink signal.

In various embodiments: the physical channel is a physical uplink shared channel, a configured grant physical uplink shared channel, or a combination thereof; the first entity is an integrated access and backhaul mobile terminal; the second entity is an integrated access and backhaul distributed unit; and performing the communication comprises transmitting an uplink signal.

In one embodiment: the physical channel is a physical downlink shared channel, a semi-persistent scheduled channel, or a combination thereof; the first entity is an integrated access and backhaul mobile terminal; the second entity is an integrated access and backhaul distributed unit; and performing the communication comprises receiving a downlink signal.

In certain embodiments, the information associated with the second set of resources comprises a slot format indication, and the slot format indication comprises information indicating at least one communication direction associated with at least one resource in the second set of resources.

In some embodiments: the information associated with the second set of resources comprises information of a first spatial filter associated with at least one resource in the second set of resources; and determining the availability of the resource comprises determining whether the first spatial filter is compatible with a second spatial filter associated with the physical channel.

In various embodiments: the information associated with the second set of resources comprises information of a first timing alignment associated with at least one resource in the second set of resources; and determining the availability of the resource comprises determining whether the first timing alignment is compatible with a second timing alignment associated with the physical channel.

In one embodiment: the information associated with the second set of resources comprises information of a first transmission power associated with at least one resource in the second set of resources; and determining the availability of the resource comprises determining whether the first transmission power is compatible with a second transmission associated with the physical channel according to at least one of a total power constraint and a power imbalance constraint.

In certain embodiments: the information associated with the second set of resources comprises information of a first reception power associated with at least one resource in the second set of resources; and determining the availability of the resource comprises determining whether the first reception power is compatible with a second reception associated with the physical channel according to a power imbalance constraint.

In some embodiments, the method further comprises receiving a slot format indication corresponding to the resource, wherein the slot format indication comprises information indicating at least one symbol direction of the resource, and the availability of the resource is determined based on the slot formation indication.

In various embodiments, the resource is determined as being available if the slot format indication indicates that the resource comprises only downlink symbols.

In one embodiment, the slot format indication further comprises information indicating whether the resource is used for simultaneous backhaul and access operations.

In certain embodiments, the resource is determined as being available if the slot format indication indicates that the resource comprises only downlink symbols and that the resource is used for the simultaneous backhaul and access operations.

In some embodiments, the resource is determined as being available if downlink assignment information scheduling at least one symbol of the resource is not received earlier than a first duration before an earliest symbol of the resource.

In various embodiments, the first duration is based on a preparation time associated with the physical channel.

In one embodiment, the method further comprises receiving scheduling information for a backhaul operation, wherein determining the availability of the resource comprises determining the availability of the resource based on spatial relation information of the physical channel and the scheduling information for the backhaul operation.

In certain embodiments, the method further comprises receiving an indication indicating that the resource of the physical channel is set to be always available.

In some embodiments, the method further comprises cancelling the communication associated with the physical channel if a resource of the backhaul uplink transmission at least partially overlaps in time with the resource of the physical channel.

In various embodiments, the method further comprises determining that a resource of a backhaul downlink reception is not available if the resource of the backhaul downlink reception at least partially overlaps in time with the resource of the physical channel.

In one embodiment, the wireless node comprises a base station, an integrated access and backhaul donor, an integrated access and backhaul node, a user equipment, or some combination thereof.

In one embodiment, an apparatus comprises a wireless node. The apparatus further comprises: a receiver that: receives scheduling information for a physical channel on a first set of resources of a first entity; and receives information associated with a second set of resources of a second entity, wherein the second set of resources overlap with the first set of resources in a time domain; a processor that determines an availability of a resource in the first set of resources based in part on the information associated with the second set of resources; and a transmitter that, in response to determining that the resource is not available, transmits an indication indicating that the resource is not valid, wherein the processor, in response to determining that the resource is available, performs a communication associated with the physical channel on the resource.

In certain embodiments: the physical channel is a physical uplink shared channel, a configured grant physical uplink shared channel, or a combination thereof; the first entity is an integrated access and backhaul distributed unit; the second entity is an integrated access and backhaul mobile terminal; and the processor performing the communication comprises the receiver receiving an uplink signal.

In some embodiments: the physical channel is a physical downlink shared channel, a semi-persistent scheduled channel, or a combination thereof; the first entity is an integrated access and backhaul distributed unit; the second entity is an integrated access and backhaul mobile terminal; and the processor performing the communication comprises the transmitter transmitting a downlink signal.

In various embodiments: the physical channel is a physical uplink shared channel, a configured grant physical uplink shared channel, or a combination thereof; the first entity is an integrated access and backhaul mobile terminal; the second entity is an integrated access and backhaul distributed unit; and the processor performing the communication comprises the transmitter transmitting an uplink signal.

In one embodiment: the physical channel is a physical downlink shared channel, a semi-persistent scheduled channel, or a combination thereof; the first entity is an integrated access and backhaul mobile terminal; the second entity is an integrated access and backhaul distributed unit; and the processor performing the communication comprises the receiver receiving a downlink signal.

In certain embodiments, the information associated with the second set of resources comprises a slot format indication, and the slot format indication comprises information indicating at least one communication direction associated with at least one resource in the second set of resources.

In some embodiments: the information associated with the second set of resources comprises information of a first spatial filter associated with at least one resource in the second set of resources; and the processor determining the availability of the resource comprises the processor determining whether the first spatial filter is compatible with a second spatial filter associated with the physical channel.

In various embodiments: the information associated with the second set of resources comprises information of a first timing alignment associated with at least one resource in the second set of resources; and the processor determining the availability of the resource comprises the processor determining whether the first timing alignment is compatible with a second timing alignment associated with the physical channel.

In one embodiment: the information associated with the second set of resources comprises information of a first transmission power associated with at least one resource in the second set of resources; and the processor determining the availability of the resource comprises the processor determining whether the first transmission power is compatible with a second transmission associated with the physical channel according to at least one of a total power constraint and a power imbalance constraint.

In certain embodiments: the information associated with the second set of resources comprises information of a first reception power associated with at least one resource in the second set of resources; and the processor determining the availability of the resource comprises the processor determining whether the first reception power is compatible with a second reception associated with the physical channel according to a power imbalance constraint.

In some embodiments, the receiver receives a slot format indication corresponding to the resource, the slot format indication comprises information indicating at least one symbol direction of the resource, and the availability of the resource is determined based on the slot formation indication.

In various embodiments, the resource is determined as being available if the slot format indication indicates that the resource comprises only downlink symbols.

In one embodiment, the slot format indication further comprises information indicating whether the resource is used for simultaneous backhaul and access operations.

In certain embodiments, the resource is determined as being available if the slot format indication indicates that the resource comprises only downlink symbols and that the resource is used for the simultaneous backhaul and access operations.

In some embodiments, the resource is determined as being available if downlink assignment information scheduling at least one symbol of the resource is not received earlier than a first duration before an earliest symbol of the resource.

In various embodiments, the first duration is based on a preparation time associated with the physical channel.

In one embodiment, the receiver receives scheduling information for a backhaul operation, and the processor determining the availability of the resource comprises the processor determining the availability of the resource based on spatial relation information of the physical channel and the scheduling information for the backhaul operation.

In certain embodiments, the receiver receives an indication indicating that the resource of the physical channel is set to be always available.

In some embodiments, the processor cancels the communication associated with the physical channel if a resource of the backhaul uplink transmission at least partially overlaps in time with the resource of the physical channel.

In various embodiments, the processor determines that a resource of a backhaul downlink reception is not available if the resource of the backhaul downlink reception at least partially overlaps in time with the resource of the physical channel.

In one embodiment, the wireless node comprises a base station, an integrated access and backhaul donor, an integrated access and backhaul node, a user equipment, or some combination thereof.

In one embodiment, a method for a wireless node comprises: receiving first information indicating that a resource is available for a downlink transmission to a first node; receiving second information indicating that the resource is available for an uplink transmission to a second node; determining whether the resource is to be used for a simultaneous operation, wherein the simultaneous operation comprises the downlink transmission and the uplink transmission; and, in response to determining that the resource is not to be used for the simultaneous operation, transmitting a control message to the second node, wherein the control message indicates that the resource is not available for the uplink transmission.

In certain embodiments, determining whether the resource is to be used for the simultaneous operation is based on: a capability of the wireless node to perform the simultaneous operation; a maximum value of a power imbalance, wherein the power imbalance is a difference between a power for the downlink transmission and a power for the uplink transmission; a maximum value of a total power, wherein the total power is a total of a power for the downlink transmission and a power for the uplink transmission; a value of interference from a previous uplink transmission on the first node; a constraint on a spatial parameter; whether a timing of the uplink transmission is to be aligned with a timing of the downlink transmission; or some combination thereof.

In some embodiments, the wireless node comprises a base station, an integrated access and backhaul donor, an integrated access and backhaul node, a user equipment, or some combination thereof.

In one embodiment, an apparatus comprises a wireless node. The apparatus further comprises: a receiver that: receives first information indicating that a resource is available for a downlink transmission to a first node; and receives second information indicating that the resource is available for an uplink transmission to a second node; a processor that determines whether the resource is to be used for a simultaneous operation, wherein the simultaneous operation comprises the downlink transmission and the uplink transmission; and a transmitter that, in response to determining that the resource is not to be used for the simultaneous operation, transmits a control message to the second node, wherein the control message indicates that the resource is not available for the uplink transmission.

In certain embodiments, the processor determining whether the resource is to be used for the simultaneous operation is based on: a capability of the wireless node to perform the simultaneous operation; a maximum value of a power imbalance, wherein the power imbalance is a difference between a power for the downlink transmission and a power for the uplink transmission; a maximum value of a total power, wherein the total power is a total of a power for the downlink transmission and a power for the uplink transmission; a value of interference from a previous uplink transmission on the first node; a constraint on a spatial parameter; whether a timing of the uplink transmission is to be aligned with a timing of the downlink transmission; or some combination thereof.

In some embodiments, the wireless node comprises a base station, an integrated access and backhaul donor, an integrated access and backhaul node, a user equipment, or some combination thereof.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. (canceled)

2. A wireless node, comprising:
at least one memory; and
at least one processor coupled with the at least one memory and configured to cause the wireless node to:
receive scheduling information for a physical channel on a first set of resources of a first entity;
receive information associated with a second set of resources of a second entity, wherein the second set of resources overlap with the first set of resources in a time domain;
determine an availability of a resource in the first set of resources based in part on the information associated with the second set of resources;
in response to determining that the resource is not available, transmit an indication indicating that the resource is not valid; and
in response to determining that the resource is available, perform a communication associated with the physical channel on the resource.

3. The wireless node of claim 2, wherein:
the physical channel is a physical uplink shared channel (PUSCH), a configured grant (CG) PUSCH, or a combination thereof;
the first entity is an integrated access and backhaul (IAB) distributed unit (DU);
the second entity is an IAB mobile terminal (MT); and
the at least one processor is configured to cause the wireless node to receive an uplink signal.

4. The wireless node of claim 2, wherein:
the physical channel is a physical downlink shared channel (PDSCH), a semi-persistent scheduled channel, or a combination thereof;
the first entity is an integrated access and backhaul (IAB) distributed unit (DU);
the second entity is an IAB mobile terminal (MT); and
the at least one processor is configured to cause the wireless node to transmit a downlink signal.

5. The wireless node of claim 2, wherein:
the physical channel is a physical uplink shared channel (PUSCH), a configured grant (CG) PUSCH, or a combination thereof;
the first entity is an integrated access and backhaul (IAB) mobile terminal (MT);
the second entity is an IAB distributed unit (DU); and
the at least one processor is configured to cause the wireless node to transmit an uplink signal.

6. The wireless node of claim 2, wherein:
the physical channel is a physical downlink shared channel (PDSCH), a semi-persistent scheduled channel, or a combination thereof;
the first entity is an integrated access and backhaul (IAB) mobile terminal (MT);
the second entity is an IAB distributed unit (DU); and
the at least one processor is configured to cause the wireless node to receive a downlink signal.

7. The wireless node of claim 2, wherein the information associated with the second set of resources comprises a slot format indication, and the slot format indication comprises information indicating at least one communication direction associated with at least one resource in the second set of resources.

8. The wireless node of claim 2, wherein:
the information associated with the second set of resources comprises information of a first spatial filter associated with at least one resource in the second set of resources; and
the at least one processor is configured to cause the wireless node to determine whether the first spatial filter is compatible with a second spatial filter associated with the physical channel.

9. The wireless node of claim 2, wherein:
the information associated with the second set of resources comprises information of a first timing alignment associated with at least one resource in the second set of resources; and
the at least one processor is configured to cause the wireless node to determine whether the first timing alignment is compatible with a second timing alignment associated with the physical channel.

10. The wireless node of claim 2, wherein:
the information associated with the second set of resources comprises information of a first transmission power associated with at least one resource in the second set of resources; and
the at least one processor is configured to cause the wireless node to determine whether the first transmission power is compatible with a second transmission associated with the physical channel according to at least one of a total power constraint and a power imbalance constraint.

11. The wireless node of claim 2, wherein:
the information associated with the second set of resources comprises information of a first reception power associated with at least one resource in the second set of resources; and
the at least one processor is configured to cause the wireless node to determine whether the first reception power is compatible with a second reception associated with the physical channel according to a power imbalance constraint.

12. The wireless node of claim 2, wherein the resource is determined as being available if downlink assignment information scheduling at least one symbol of the resource is not received earlier than a first duration before an earliest symbol of the resource, and the first duration is based on a preparation time associated with the physical channel.

13. The wireless node of claim 2, wherein the at least one processor is configured to cause the wireless node to receive an indication indicating that the resource of the physical channel is set to be always available.

14. A wireless node, comprising:
at least one memory; and
at least one processor coupled with the at least one memory and configured to cause the wireless node to:
receive first information indicating that a resource is available for a downlink transmission to a first node;
receive second information indicating that the resource is available for an uplink transmission to a second node;
determine whether the resource is to be used for a simultaneous operation, wherein the simultaneous operation comprises the downlink transmission and the uplink transmission; and
in response to determining that the resource is not to be used for the simultaneous operation, transmit a control message to the second node, wherein the control message indicates that the resource is not available for the uplink transmission.

15. The wireless node of claim 14, wherein determining whether the resource is to be used for the simultaneous operation is based on:
a capability of the wireless node to perform the simultaneous operation;
a maximum value of a power imbalance, wherein the power imbalance is a difference between a power for the downlink transmission and a power for the uplink transmission;
a maximum value of a total power, wherein the total power is a total of a power for the downlink transmission and a power for the uplink transmission;
a value of interference from a previous uplink transmission on the first node;
a constraint on a spatial parameter;
whether a timing of the uplink transmission is to be aligned with a timing of the downlink transmission;
or a combination thereof.

16. An integrated access and backhaul (IAB) node comprising an IAB mobile terminal (IAB-MT) and an IAB distributed unit (IAB-DU), comprising:
at least one memory; and
at least one processor coupled with the at least one memory and configured to cause the base station to:
determine a spatial constraint between a first transmission/reception by the IAB-MT and a second transmission by the IAB-DU, wherein:
the spatial constraint indicates whether a beam or a spatial filter applied for the first transmission/reception can be applied for the second transmission simultaneously; and
the beam or the spatial filter is associated with a reference signal, a synchronization signal block (SSB), a channel state information reference signal (CSI-RS), a sounding reference signal (SRS), a transmission configuration indication (TCI) state, a quasi-collocation (QCL) relationship, or a combination thereof;
determine whether the first transmission/reception and the second transmission are simultaneous; and
upon determining that the first transmission/reception and the second transmission are simultaneous:
apply the spatial constraint.

17. The wireless node of claim 2, wherein the second transmission is associated with a spatial division multiplexing (SDM) or a frequency division multiplexing (FDM).

18. A processor for wireless communication, comprising:
at least one controller coupled with at least one memory and configured to cause the processor to:
receive scheduling information for a physical channel on a first set of resources of a first entity;
receive information associated with a second set of resources of a second entity, wherein the second set of resources overlap with the first set of resources in a time domain;
determine an availability of a resource in the first set of resources based in part on the information associated with the second set of resources;
in response to determining that the resource is not available, transmit an indication indicating that the resource is not valid; and
in response to determining that the resource is available, perform a communication associated with the physical channel on the resource.

19. The processor of claim 18, wherein:
the physical channel is a physical uplink shared channel (PUSCH), a configured grant (CG) PUSCH, or a combination thereof;
the first entity is an integrated access and backhaul (IAB) distributed unit (DU);
the second entity is an IAB mobile terminal (MT); and
the at least one controller is configured to cause the processor to receive an uplink signal.

20. The processor of claim 18, wherein:
the physical channel is a physical downlink shared channel (PDSCH), a semi-persistent scheduled channel, or a combination thereof;
the first entity is an integrated access and backhaul (IAB) distributed unit (DU);
the second entity is an IAB mobile terminal (MT); and
the at least one controller is configured to cause the processor to transmit a downlink signal.

21. The processor of claim 18, wherein:
the physical channel is a physical uplink shared channel (PUSCH), a configured grant (CG) PUSCH, or a combination thereof;
the first entity is an integrated access and backhaul (IAB) mobile terminal (MT);
the second entity is an IAB distributed unit (DU); and
the at least one controller is configured to cause the processor to transmit an uplink signal.
